(19) United States
(12) Patent Application Publication
(10) Pub. No.: US 2004/0076404 A1
(43) Pub. Date: Apr. 22, 2004

(54) Region restrictive playback system

(76) Inventors: Toshihisa Nakano, Neyagawa-shi (JP); Hideshi Ishihara, Katano-shi (JP); Naoki Yamamoto, Neyagawa-shi (JP); Makoto Tatebayashi, Takarazuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/653,594

(22) Filed: Sep. 3, 2003

(30) Foreign Application Priority Data
Sep. 3, 2002 (JP) 2002-258017

(51) Int. Cl. H04N 5/76

(52) U.S. Cl. 386/94; 380/201

(57) ABSTRACT

DVD-Video discs and playback apparatuses are assigned a region code indicating one of six regions into which the world is divided, for the purpose of protecting copyrights of content such as movies and music. However, playback apparatuses exist that illegally circumvent the function of checking the region code of the disc with the region code of the playback apparatus.

The present invention provides a region restrictive viewing/listening system that enables regionally restricted viewing/listening, thereby preventing playback apparatuses which circumvent region code checking from playing back content correctly.

A content recording apparatus encrypts content, based on an internally-stored region code, and records the encrypted content to a recording medium. A content playback apparatus decrypts the content, based on an internally-stored region code, and plays back the content.

### BACKGROUND OF THE INVENTION

(1) Field of the Invention

The present invention relates to a technique for supplying and playing back digital works, and in particular to a technique for restricting playback of digital works by the region in which a digital work is supplied.

(2) Description of the Related Art

Numerous techniques exist for preventing illegal use and protecting copyrights and the like of digital works.

A technique that aims to protect copyrights and restrict selling rights of content such as movies and music clips is disclosed in Document 1. According to this technique, the world is divided into six regions, and DVD-Video discs and players are given region codes that each indicate one of the regions. Content is only able to be played back when the region code held by the player matches at least one of the region codes recorded on the disc. Here, the player has one region code, but the disc may have two or more region codes. A disc on which all the region codes recorded has, in effect, no regional restrictions.

### Document 1

U.S. Pat. No. 6,141,483 “Recording medium for recording data, reproducing apparatus for reproducing data recorded on a recording medium, and data reproducing system for reproducing data recorded on recording medium via network or the like”.

### Document 2

“Digital Content Hogo-you Kagi Kanri Houshiki (Key Management Method for Protecting Digital Content)”, Nakano, Omori and Tatebayashi, Symposium on Cryptography and Information Security 2001, SCIS2001, 5A-5, January 2001.

However, there are players that have been adapted to have the same region code as that recorded on the disc, or adapted to circumvent the function that checks the region codes of the disc and the player. Such players are problematic because they use digital works illegally.

### SUMMARY OF THE INVENTION

In order to solve the stated problem, the object of the present invention is to provide a region restrictive playback system, a provision apparatus, a playback apparatus, a recording medium and a computer program that achieve region restrictive playback by preventing content being played back correctly in a playback apparatus whose internal region information has been illegally modified or that has been illegally adapted to circumvent checking of region information checking.

In order to achieve the stated object, the present invention is a region restrictive viewing/listening system that is composed of a recording apparatus that encrypts digital content and records the encrypted digital content, the recording medium on which the encrypted digital content is recorded, and a playback apparatus that reads the encrypted digital content from the recording medium and decrypts the read encrypted digital content. The recording apparatus holds at least one region code for designating a region, selects a region code, from among the at lest on region code, of a region in which decryption of encrypted digital content to be recorded on the recording medium is permitted, encrypts the digital content based on the selected region code, and records the encrypted digital content to the recording medium. The playback apparatus, which holds one of the region codes, reads the encrypted digital content from the recording medium, and decrypts the encrypted digital content based on the held region code.

Furthermore, in the region restrictive viewing/listening system, the recording apparatus, which holds the device key of the playback apparatus, records (1) encrypted media key data that is media key data encrypted with the device key data, and (2) encrypted digital content, to the recording medium. Here, the encrypted digital content is generated by first generating encrypted key data from at least the media key data and the selected region code, and encrypting digital content based on the encrypted key data. The playback apparatus reads the two pieces of encrypted data from the recording medium, decrypts the encrypted media key data with the device key data, thereby obtaining the media key data, generates decryption key data from at least the media key data obtained by decryption and the region code, and decrypts the encrypted digital content based on the decryption key data.

Furthermore, in the region restrictive viewing/listening system, the recording apparatus and the playback apparatus hold secret information set for each region code, instead of holding a region code.

Furthermore, in the region restrictive viewing/listening system, the recording apparatus also records the selected region code to the recording medium, and the playback apparatus judges whether the region code held by the playback apparatus and the region code recorded on the recording medium match. The playback apparatus does not execute subsequent processing when the two region codes do not match, and executes subsequent processing only when the two region codes match.

Furthermore, in the region restrictive viewing/listening system, the processing of at least one of the recording apparatus and the playback apparatus is provided on an IC card, and only a recording apparatus or a playback apparatus in which the IC card is inserted can execute encryption or decryption of the digital content.

Furthermore, the present invention is a recording apparatus that encrypts digital content and records the encrypted digital content to a recording medium. The recording apparatus holds at least one region code for designating a region, selects a region code, from among the at least one region code, in which encrypted digital content to be recorded on the recording medium is permitted to be decrypted, encrypts the digital content based on the selected region code, and records the encrypted digital content to the recording medium.

Furthermore, the recording apparatus, which holds the device key of the playback apparatus, records (1) encrypted media key data that is media key data encrypted with the device key data, and (2) encrypted digital content, to the recording medium. Here, the encrypted digital content is generated by first generating encrypted key data from at least the media key data and the selected region code, and encrypting digital content based on the encrypted key data.

Furthermore, the present invention is a playback apparatus that reads encrypted digital content from a recording medium, and decrypts the read digital content. The playback apparatus, which holds one region code, reads encrypted digital content from the recording medium, and decrypts the read encrypted digital content based on the held region code.

Furthermore, the playback apparatus reads three pieces of encrypted data from the recording medium, decrypts the encrypted media key data with a device key to obtain media key data, generates decryption key data from at least the media key data obtained by decryption and the region code, and decrypts the encrypted digital content based on the decryption key data.

Furthermore, the present invention is a recording medium on which data is recorded. A recording apparatus records encrypted digital content, which is digital content that has been encrypted based on a region code for designating a region, to the recording medium.

Furthermore, the present invention is a recording medium on which data is recorded. A recording apparatus, which holds a device key of the playback apparatus, records (1) encrypted media key data that is media key data encrypted with the device key data, and (2) encrypted digital content, to the recording medium. Here, the encrypted digital content is generated by first generating encrypted key data from at least the media key data and the selected region code, and encrypting digital content based on the encrypted key data.

Furthermore, the present invention is a region restrictive viewing/listening system composed of a recording apparatus that encrypts digital content and records the encrypted digital content, a recording medium on which the encrypted digital content is recorded, and a playback apparatus that reads the encrypted digital content from the recording medium and decrypts the read encrypted digital content. The recording apparatus manages device keys held by the playback apparatus, using one tree structure that specifies the relationship between the device keys held by the playback apparatus that are partially shared with other playback apparatuses. The recording apparatus further manages the playback apparatus, which is in correspondence with the lowest layer in the tree structure, in correspondence with a part of the tree for a particular area. The recording apparatus selects a device key that is in correspondence with the highest position in the tree part for the region in which decryption of encrypted digital content to be recorded on the recording medium is permitted, encrypts digital content based on the selected device key, and records the encrypted digital content to the recording medium. The playback apparatus, which holds a plurality of device keys, reads the encrypted digital content from the recording medium, and decrypts the encrypted digital content based on the plurality of device keys.

Furthermore, the present invention is a region restrictive viewing/listening system composed of a recording apparatus that encrypts digital content and records the encrypted digital content, a recording medium on which the encrypted digital content is recorded, and a playback apparatus that reads the encrypted digital content from the recording medium and decrypts the encrypted digital content. The recording apparatus manages device keys held by the playback apparatus, with use of a tree structure that specifies the relationship between device keys held by the playback apparatus that are shared partially with other playback apparatuses, selects all device keys that correspond to a highest level in the tree structure of the region in which decryption of the encrypted digital content to be recorded on the recording medium is permitted, encrypts the digital content based on the selected device keys, and records the encrypted content to the recording medium. The playback apparatus, which holds a plurality of device keys, reads the encrypted digital content from the recording medium, and decrypts the encrypted digital content based on the plurality of held device keys.

Furthermore, the present invention is a recording apparatus that encrypts digital content and records the encrypted digital content to a recording medium. The recording apparatus manages device keys held by the playback apparatus, using one tree structure that specifies the relationship between the held device keys that are partially shared with other playback apparatuses. The recording apparatus further manages the playback apparatus, which is in correspondence with the lowest layer in the tree structure, in correspondence with a part of the tree for a particular area. The recording apparatus selects a device key that is in correspondence with the highest position in the tree part for the region in which decryption of encrypted digital content to be recorded on the recording medium is permitted, encrypts digital content based on the selected device key, and records the encrypted digital content to the recording medium.

Furthermore, the present invention is a recording apparatus that encrypts digital content and records the encrypted digital content to a recording medium. The recording medium manages device keys held by the playback apparatus, using, for each region, one tree structure that specifies the relationship between the held device keys that are partially shared with other playback apparatuses. The recording apparatus selects a device key that is in correspondence with the highest position in the tree for the region in which decryption of encrypted digital content to be recorded on the recording medium is permitted, encrypts digital content based on the selected device key, and records the encrypted digital content to the recording medium.

Furthermore, the present invention is a recording medium on which encrypted digital content is recorded. The encrypted digital content has been encrypted by a recording apparatus that manages device keys held by the playback apparatus, using one tree structure that specifies the relationship between the held device keys that are partially shared with other playback apparatuses. The recording apparatus further manages the playback apparatus, which is in correspondence with the lowest layer in the tree structure, in correspondence with a part of the tree for a particular area. The recording apparatus selects a device key that is in correspondence with the highest position in the tree part for the region in which decryption of encrypted digital content to be recorded on the recording medium is permitted, encrypts digital content based on the selected device key, and records the encrypted digital content to the recording medium.

Furthermore, the present invention is a recording medium on which encrypted digital content is recorded. A recording apparatus selects a device key that is in correspondence with the highest position in the tree for the region in which decryption of encrypted digital content to be recorded on the recording medium is permitted, encrypts digital content based on the selected device key, and records the encrypted digital content to the recording medium.

Furthermore, the present invention is a region restrictive viewing/listening system that is composed of a recording apparatus that encrypts digital content and records the encrypted digital content, a recording medium on which the encrypted digital content is recorded, and a playback apparatus that reads the encrypted digital content from the recording medium and decrypts the read encrypted digital content. The recording apparatus, which holds only one region code for specifying a region, encrypts digital content based on the region code, and records the encrypted digital content to the recording medium. The playback apparatus, which holds only one region code, reads the encrypted digital content from the recording medium, and decrypts the encrypted digital content, based on the region code.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is a block diagram of the structure of a digital work protection system 10;

FIG. 2 is a block diagram of the structure of a key management apparatus 100;

FIG. 3 is an example of the data structure of a tree structure table D100;

FIG. 4 is a conceptual diagram of a tree structure T100;

FIG. 5 is a conceptual diagram of a tree structure T200 that includes revoked nodes;

FIG. 6 is a data structure diagram showing an example of node revocation patterns;

FIG. 7 is a data structure diagram showing an example of key information that includes a plurality of encrypted media keys;

FIG. 8 is a block diagram showing the structure of a recording medium apparatus 300a;

FIG. 9 is a block diagram showing the structure of a reproduction apparatus 400a;

FIG. 10 is a flow chart showing operations for assigning a device key to a user apparatus, operations for generating key information and writing the key information to a recording apparatus, and operations for the user apparatus to encrypt or decrypt content; and in particular showing operations for each apparatus up to when a device key is exposed illegally by a third party;

FIG. 11 is a flowchart showing, after the device key has been exposed illegally by a third party, operations for revoking the nodes in the tree structure to which the exposed device key corresponds, operations for generating new key information and writing the generated key information to a recording medium, and operations for the user apparatus to encrypt or decrypt content;

FIG. 12 is a flowchart showing operations by a key structure construction unit 101 for generating a tree structure table and writing the generated tree structure table to a tree structure storage unit 102;

FIG. 13 is a flowchart showing operations by a device key assignment unit 103 for outputting device keys and ID information to each user apparatus;

FIG. 14 is a flowchart showing operations by a tree structure updating unit 105 for updating the tree structure;

FIG. 15 is a flowchart showing operations by a key information header generation unit 106 for generating header information;

FIG. 16 is a flowchart showing operations by a key information generation unit 107 for generating key information;

FIG. 17 is a flowchart showing operations by a specification unit 303 in the recording apparatus 300a for designating one encrypted media key from amongst key information stored in the recording medium 500b;

FIG. 18 shows an example of a tree structure in a first embodiment in an example of a case in which there is a possibility that revoked user apparatuses occur one-sidedly around a particular leaf in the tree structure;

FIG. 19 is a tree structure showing a special NRP in a case in which revoked user apparatuses occur one-sidedly around a specific leaf in the tree structure, in a second embodiment;

FIG. 20 shows an example of the data structure of a tree structure table D400;

FIG. 21 shows an example of the data structure of header information D500;

FIG. 22 shows an example of the data structure of key information D600;

FIG. 23 is a flowchart, which continues in FIG. 24, showing operations by the key information header generation unit 106 for generating header information;

FIG. 24 is a flowchart, which continues in FIG. 25, showing operations by the key information header generation unit 106 for generating header information;

FIG. 25 is a flowchart, which continues in FIG. 26, showing operations by the key information header generation unit 106 for generating header information;

FIG. 26 is a flowchart, which continues from FIG. 25, showing operations by the key information header generation unit 106 for generating header information;

FIG. 27 is a flowchart showing operations by the specification unit 303 in the recording apparatus 300a for designating one encrypted media key from amongst key information stored in the recording medium 500b;

FIG. 28 is a tree structure showing a special NRP, in a third embodiment;

FIG. 29 shows an example of the data structure of header information D700;

FIG. 30 shows an example of the data structure of key information D800;

FIG. 31 is a flowchart, which continues in FIG. 32, of operations for generating header information;

FIG. 32 is a flowchart, which continues in FIG. 33, of operations for generating header information;

FIG. 33 is a flowchart, which continues in FIG. 34, of operations for generating header information;

FIG. 34 is a flowchart, which continues from FIG. 33, of operations for generating header information;

FIG. 35 is a flowchart showing operations by the specification unit 303 in the recording apparatus 300a for designating one encrypted media key from amongst key information stored in the recording medium 500b;

FIG. 36 is a tree structure showing how a plurality of NRPs are arranged in a fourth embodiment;

FIG. 37 shows an example of the data structure of a tree structure table D1000;

FIG. 38 shows an example of the data structure of header information D900;

FIG. 39 is a flowchart showing operations by the tree structure construction unit 101 for generating a tree structure table, and writing the generated tree structure table to the tree structure storage unit 102;

FIG. 40 is a flowchart, which continues in FIG. 41, showing operations by the key information header generation unit 106 for generating header information;

FIG. 41 is a flowchart, which continues from FIG. 40, showing operations by the key information header generation unit 106 for generating header information;

FIG. 42 is a flowchart showing operation by the specification unit 303 in the recording apparatus 300a for designating one encrypted media key from amongst key information stored in the recording medium 500b;

FIG. 43 is a flowchart, which continues in FIG. 44, showing operations by the key information header generation unit 106 for generating header information;

FIG. 44 is a flowchart, which continues in FIG. 45, showing operations by the key information header generation unit 106 for generating header information;

FIG. 45 is a flowchart, which continues in FIG. 46, showing operations by the key information header generation unit 106 for generating header information;

FIG. 46 is a flowchart, which continues from FIG. 45, showing operations by the key information header generation unit 106 for generating header information;

FIG. 47 is a flowchart showing operations by the specification unit 303 in the recording medium 300a for designating one encrypted media key from amongst key information stored in the recording medium 500b;

FIG. 48 is a block diagram showing the structure of a digital work protection system 10f;

FIG. 49 is an conceptual diagram of a tree structure T700 that includes nodes to which revoked device KeyA, KeyB and KeyE are assigned;

FIG. 50 is a data structure diagram showing header information D1000 and key information D1010;

FIG. 51 is a flowchart showing operations by the specification unit 303 of the recording apparatus 300a for specifying an encrypted media key;

FIG. 52 is a block diagram showing the structure of a contents distribution system 2000;

FIG. 53 is a block diagram showing the structure of a content recording apparatus 2100;

FIG. 54 shows the data structure of a recording medium 2120;

FIG. 55 is a block diagram showing the structure of a content playback apparatus 2400;

FIG. 56 is a flowchart showing operations of the content recording apparatus 2100;

FIG. 57 is a flowchart showing operations of the content playback apparatus 2400;

FIG. 58 is a block diagram showing the structure of a content distribution system 3000;

FIG. 59 is a schematic diagram showing a tree structure T3000 used in the content distribution system 3000;

FIG. 60 is a block diagram showing the structure of a content recording apparatus 3100;

FIG. 61 shows the data structure of a recording medium 3120a;

FIG. 62 shows the data structure of a recording medium 3120b;

FIG. 63 shows the data structure of a recording medium 3120c;

FIG. 64 is a block diagram showing the structure of a content playback apparatus 3400;

FIG. 65 is a flowchart showing operations of a content recording apparatus 3100;

FIG. 66 is a flowchart showing operations of a content playback apparatus 3400;

FIG. 67 is a schematic diagram showing another tree structure used in the content distribution system 3000; and

FIG. 68 shows the data structure of a recording medium 3120d.

### DESCRIPTION OF THE PREFERRED EMBODIMENTS

### 1. First Embodiment

The following describes a digital work protection system 10 as a first embodiment of the present invention.

### 1.1 Structure of the Digital Work Protection System 10

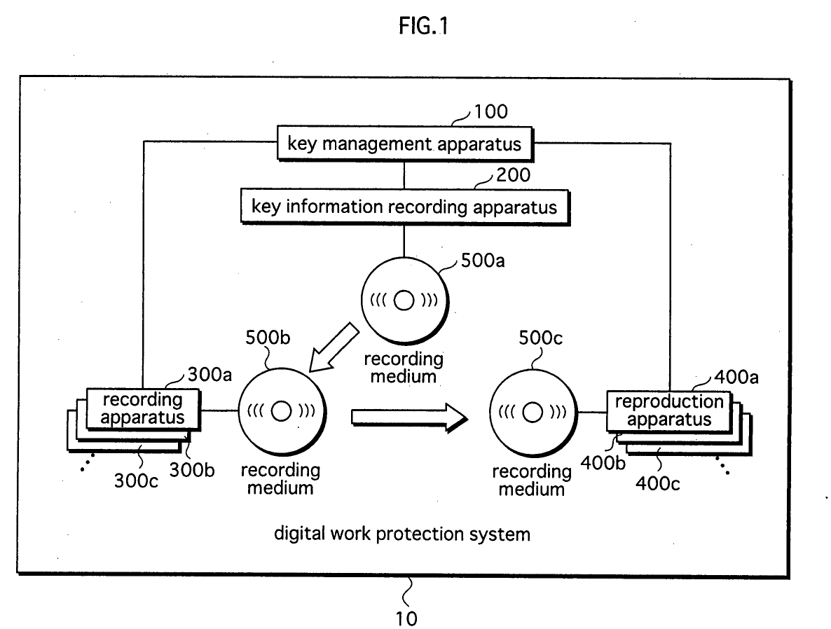

The digital work protection system 10, as shown in FIG. 1, is composed of a key management apparatus 100, a key information recording apparatus 200, recording apparatuses 300a, 300b, 300c, . . . (hereinafter referred to as “recording apparatuses 300a etc.”), and reproduction apparatuses 400a, 400b, 400c, . . . (hereinafter referred to as “reproduction apparatuses 400a etc.”).

The key management apparatus 100 has key information pre-recorded onto a recording medium 500a by the key information recording apparatus 200, resulting in a recording medium 500b on which the key information has been recorded being generated in advance. Note that the recording medium 500a is a recordable medium such as a DVD-RAM (Digital Versatile Disc Random Access Memory), onto which no information has been recorded. Furthermore, the key management apparatus 100 assigns device keys for decrypting key information respectively to each recording apparatus 300a etc. and each reproduction apparatus 400a etc., and distributes in advance the assigned device keys, device key identification information that identifies the device keys, and ID information that identifies the particular recording apparatus or reproduction apparatus, to each of the recording apparatuses 300a etc. and reproduction apparatuses 400a etc.

The recording apparatus 300a encrypts digitized content to generate encrypted content, and records the generated encrypted content on the recording medium 500b, resulting in a recording medium 500c being generated. The reproduction apparatus 400a reads the encrypted content from the recording medium 500c, and decrypts the read encrypted content to obtain the original content. The recording apparatuses 300b etc. operate in an identical manner to the recording apparatus 300a, and the reproduction apparatuses 400b etc. operate in an identical manner to the reproduction apparatus 400a.

Note that hereinafter, user apparatus” is used to refer to the recording apparatuses 300b etc. and the reproduction apparatuses 400b etc.

### 1.1.1 Key Management Apparatus 100

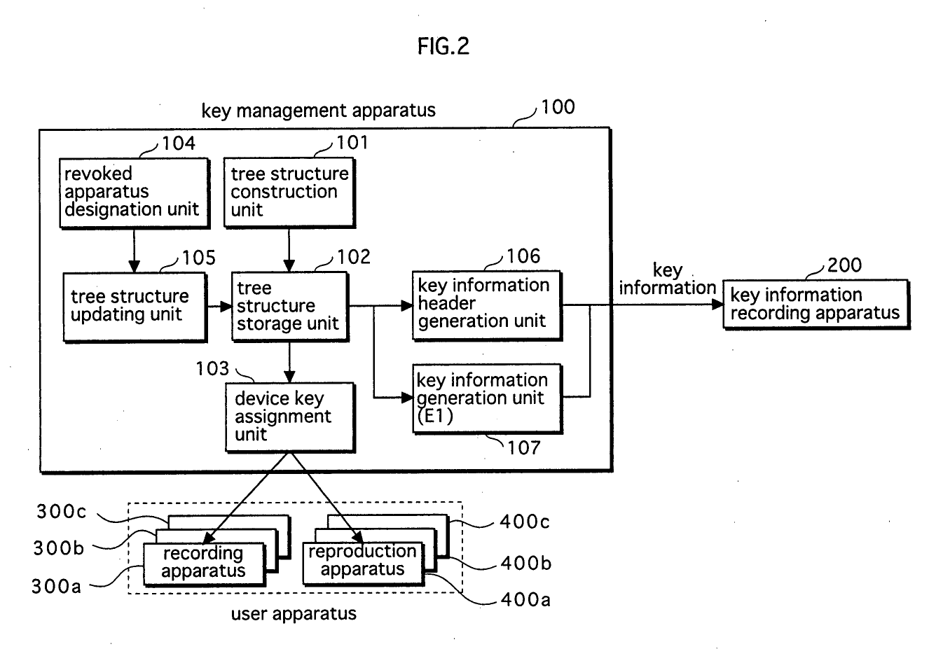

The key management apparatus 100, as shown in FIG. 2, is composed of a tree structure construction unit 101, a tree structure storage unit 102, a device key assignment unit 103, a revoked apparatus designation unit 104, a key structure updating unit 105, a key information header generation unit 106, and a key information generation unit 107.

Specifically, the key management apparatus 100 is a computer system that includes a microprocessor, a ROM (Read Only Memory), a RAM (Random Access Memory), a hard disk unit, a display unit, a keyboard, and a mouse. Computer programs are stored in the RAM or the hard disk unit. The key management apparatus 100 achieves its functions by the microprocessor operating in accordance with the computer programs.

### (1) Tree Structure Storage Unit 102

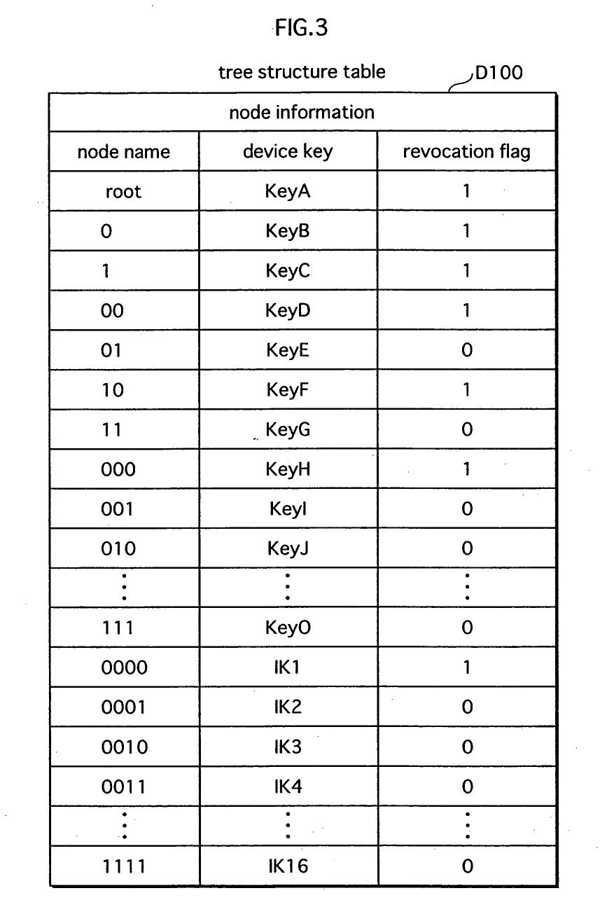

Specifically, the tree structure storage unit 102 is composed of a hard disk unit, and, as shown in FIG. 3, has a tree structure table D100.

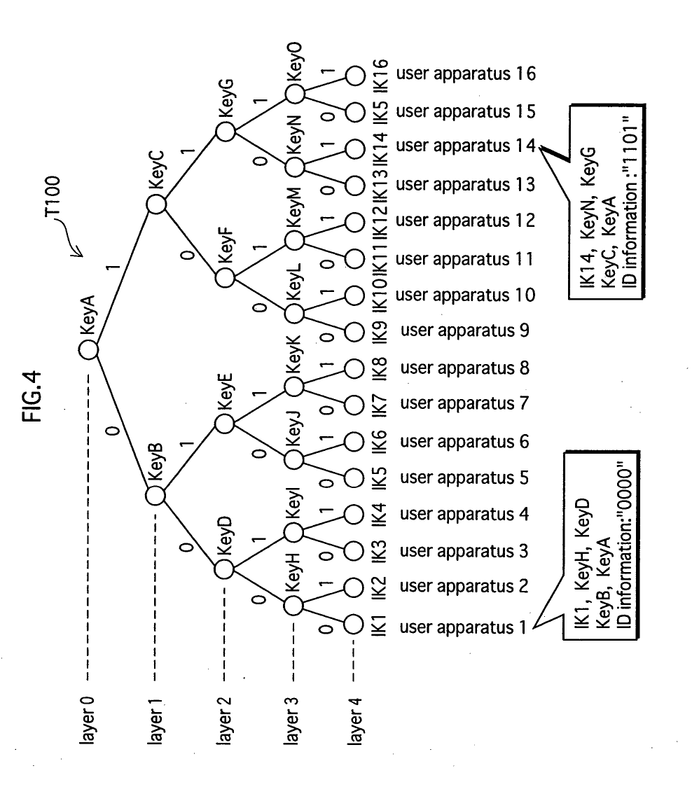

The tree structure table D100 corresponds to a tree structure T100 shown in FIG. 4 as one example of a tree structure, and shows a data structure for expressing the tree structure T100. As is described later, the data structure for expressing the tree structure T100 is generated by the tree structure construction unit 101 as the tree structure table D100, and stored in the tree structure storage unit 102.

### Tree Structure T100

The tree structure T100, as shown in FIG. 4, is a binary tree that has five layers: layer 0 through to layer 4. Since the tree structure T100 is a binary tree, each node (excluding leaves) in the tree structure T100 is connected to two nodes on the lower side of the node via two paths. One node, which is the root, is included in layer 0, two nodes are included in layer 1, four nodes are included in layer 2, eight nodes are included in layer 3, and 16 nodes, which are leaves, are included in layer 4. Note that “lower side” refers to the leaf side of the tree structure, while “upper side” refers to the root side of the tree structure.

Each of the two paths that connect a node (excluding leaves) in the tree structure T100 with its directly subordinate node is assigned a number, the left path being assigned “0” and the right path being assigned “1”. Here, in FIG. 4 a path that branches downwards to the left of a node to connect left nodes is called a left path. A path that branches downwards to the right of a node to connect right nodes is called a right path.

A node name is assigned to each node. The name of the root node is “root”. Each of the nodes in the layers from layer 1 downwards is given a character string as a node name. The number of characters in the character string is equal to the number of the layer, and is generated by arranging the numbers assigned to each node on the same path as the node from the root through to the node in this order. For example, the node names of the two nodes in layer 1 are “0” and “1” respectively. The node names of the four nodes in layer 2 are “00”, “01”, “10”, and “11” respectively. The node names of the eight nodes in layer 3 are “000”, “001”, “010”, “011”, . . . , “101”, “110” and “111” respectively. The node names of the eight nodes on layer 4 are “0000”, “0001”, “0010”, “0011”, . . . , “1100”, “1101”, “1110”, and “1111” respectively.

### Tree Structure Table D100

The tree structure table D100 includes pieces of node information equal in number to the nodes in the tree structure T100. Each piece of node information corresponds to one of the nodes in the tree structure T100.

Each piece of node information includes a device key and a revocation flag.

Each node name identifies the node to which a particular piece of node information corresponds.

Each device key is assigned to a node that corresponds to a piece of node information.

In addition, each revocation flag shows whether the device key corresponding to the piece of node information had been revoked or not. A revocation flag set to “0” shows that a device key is not revoked, while a revocation flag set to “1” shows that a device key is revoked.

Each piece of node information is stored in the tree structure table D100 in an order shown by the following Order Rule 1. The Order Rule 1 is also applied when the recording apparatuses 300a etc. and the reproduction apparatuses 400a etc. read node information sequentially from the tree structure table D100.

(a) Node information corresponding to the nodes in each layer is stored in the tree structure table D100 in ascending order of the layer numbers in the tree structure T100. Specifically, first one piece of node information corresponding to the one root in layer 0 is stored, then two pieces of node information corresponding to the two nodes in layer 1, followed by four pieces of node information corresponding to the four nodes in layer 2, and so on in the same manner.

(b) Within each layer, the pieces of node information corresponding to each node in the layer are stored in ascending order of node name.

Specifically, the pieces of node information are stored in the following order in the tree structure table D100 shown in FIG. 3:

“root”, “0”, “1”, “00”, “01”, “10”, “11”, “000”, “001”, “010”, “011”, . . . , “101”, “110”, “111”, “0000”, “0001”, “0010”, “0011”, . . . , “1100”, “1101”, “1110”, “1111”.

Here, the order in which the pieces of node information are stored is shown by the node name included in each piece of node information.

### (2) Tree Structure Construction Unit 101

The tree structure construction unit 101, as described below, constructs an n-ary data structure for managing device keys, and stores the constructed tree structure in the tree structure storage unit 102. Here, n is an integer equal to or greater than 2. As an example, n=2.

The tree structure construction unit 101 first generates a piece of node information with “root” as the node name, and writes the generated piece of node information to the tree structure table in the tree structure storage unit 102.

Next, tree structure construction unit 101 generates node names “0” and “1” that identify the two nodes in layer 1, generates two pieces of node information that respectively include the generated node names “0” and “1”, and writes the two generated pieces of node information in the stated order to the tree structure table in the tree structure storage unit 102.

Next, the tree structure construction unit 101 generates four node names “00”, “01”, “10” and “11” that identify the four nodes in layer 2, generates four pieces of node information that respectively include “00”, “01”, “10” and “11”, and adds the four generated pieces of node information to the tree structure table in the stated order.

After this, the tree structure construction unit 101 generates node information for layer 3 and layer 4 in the stated order, and writes the generated node information to the tree structure table, in the same manner as described above.

Next, the tree structure construction unit 101 generates a device key with use of a random number, for each node in the tree structure, and writes the generated device keys to the tree structure in correspondence with the respective nodes.

### (3) Device Key Assignment Unit 103

The device key assignment unit 103, as described below, selects a device key in correspondence with a leaf to which a user apparatus is not yet assigned and a user apparatus to which a device key is to be assigned, and outputs the selected device key to the user apparatus.

The device key assignment unit 103 has a variable ID that is four bits in length.

The device key assignment unit 103 performs below-described processing (a) to (f) sixteen times. Each time, the variable ID has one of the values “0000”, “0001”, “0010”, . . . , “1110”, and “1111”. By performing the processing sixteen times, the device key assignment unit 103 assigns ID information and five device keys to each of the 16 user apparatuses.

(a) The device key assignment unit 103 obtains the piece of node information that includes the node name “root”, from the tree structure table in the tree structure storage unit 102, and extracts the device key from the obtained node information. The extracted device key is the device key assigned to the root.

(b) The device key assignment unit 103 obtains the piece of node information that includes the node name that is the head bit of the variable ID, from the tree structure table in the tree structure storage unit 102, and extracts the device key from the obtained node information. Hereinafter, this device key is called device key A.

(c) The device key assignment unit 103 obtains the piece of node information that includes the node name that is the head two bits of the variable ID, from the tree structure table in the tree structure storage unit 102, and extracts the device key from the obtained node information. Hereinafter, this device key is called device key B.

(d) The device key assignment unit 103 obtains the piece of node information that includes the node name that is the head three bits of the variable ID, from the tree structure table in the tree structure storage unit 102, and extracts the device key from the obtained node information. Hereinafter, this device key is called device key C.

(e) The device key assignment unit 103 obtains the piece of node information that includes the node name that is the four bits of the variable ID, from the tree structure table in the tree structure storage unit 102, and extracts the device key from the obtained node information. Hereinafter, this device key is called device key D.

(f) The device key assignment unit 103 writes ID information, the device key assigned to the root, the device keys A, B, C, and D assigned to each node, and five pieces of device key identification information, to a key information storage unit in the user apparatus. Note that the ID information is the variable ID, and that the five pieces of device key of identification information respectively identify the five device keys.

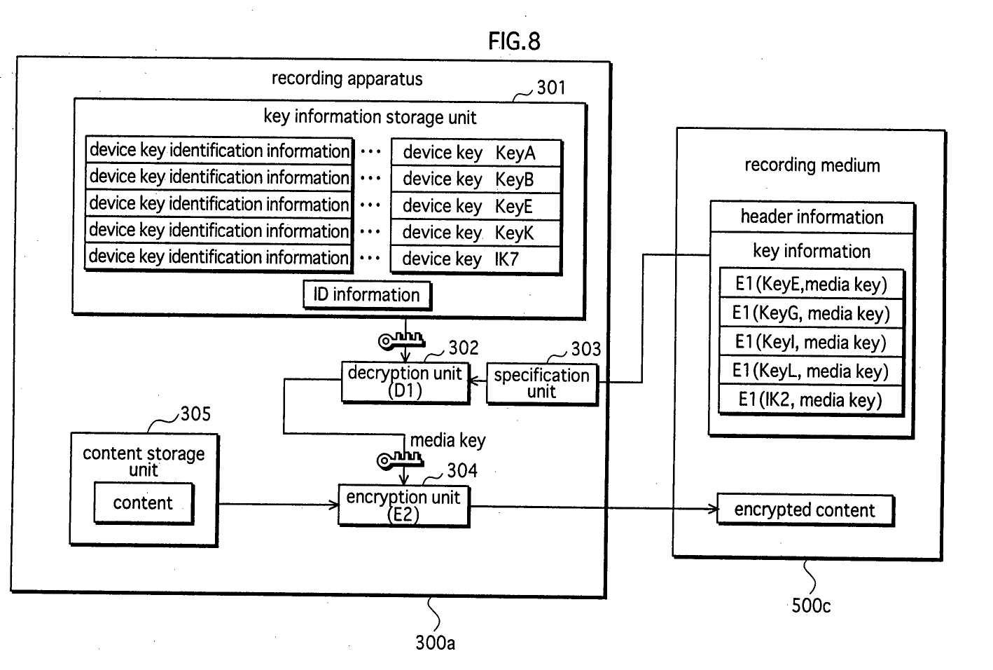

In this way, the key information storage unit in each user apparatus stores ID information, five pieces of device key identification information and five device keys, as shown in one example in FIG. 8. Here, the five pieces of device key identification information and the five device keys are stored in correspondence. Each piece of device key identification information is the number of the layer (layer number) to which the corresponding device key is assigned.

In this way, ID information and five device keys are assigned to each of the sixteen user apparatuses.

As one example, the tree structure T100 shown in FIG. 4 is, as described above, a binary tree with five layers, and includes sixteen leaves. Here, it is assumed that there are sixteen user apparatuses, each of which corresponds to one of the leaves. Each user apparatus is provided with the device keys assigned to the nodes on the path from the corresponding leaf through to the root. For example, a user apparatus 1 is provided with five device keys IK1, KeyH, KeyD, KeyB, and KeyA. The user apparatus 1 is further provided, for example, with ID information “0000”, and the user apparatus 14 provided with ID information “1101”.

### (4) Revoked Apparatus Designation Unit 104

The revoked apparatus designation unit 104 receives at least one piece of ID information that identifies at least one user apparatus that is to be revoked, from the manager of the key management apparatus 100, and outputs the received ID information to the key structure updating unit 105.

### (5) Key Structure Updating Unit 105

The key structure updating unit 105 receives the at least one piece of ID information from the revoked apparatus designation unit 104, and on receiving the ID information, performs the following processing (a) to (d) for each of the at least one pieces of ID information.

(a) The key structure updating unit 105 obtains the piece of node information that includes the received ID information as the node name, from the tree structure table in the tree structure storage unit 102, attaches a revocation flag “1” to the obtained node information, and writes the node information to which the revocation flag “1” has been attached to the position in the tree structure table where the obtained node information is stored, thus overwriting the original piece of node information with the node information to which the revocation flag has been attached.

(b) The key structure updating unit 105 obtains the piece of node information that includes as the node name the head three bits of the received ID information, from the tree structure table in the tree structure storage unit 102, attaches a revocation flag “1” to the obtained piece of node information, and overwrites the original piece of node information in the tree structure table, in the same manner as described above.

(c) The key structure updating unit 105 obtains the piece of node information that includes as the node name the head two bits of the received ID information, from the tree structure table in the tree structure storage unit 102, attaches a revocation flag “1” to the obtained piece of node information, and overwrites the original piece of node information in the tree structure table, in the same manner as described above.

(d) The key structure updating unit 105 obtains the piece of node information that includes “root” as the node name, from the tree structure table in the tree structure storage unit 102, attaches a revocation flag “1” to the obtained piece of node information, and overwrites the original piece of node information in the tree structure table, in the same manner as described above.

As has been described, the key structure updating unit 105 revokes, based on the ID information received from the revoked apparatus designation unit 104, all nodes on the path from the leaf shown by the received information through to the root in the tree structure.

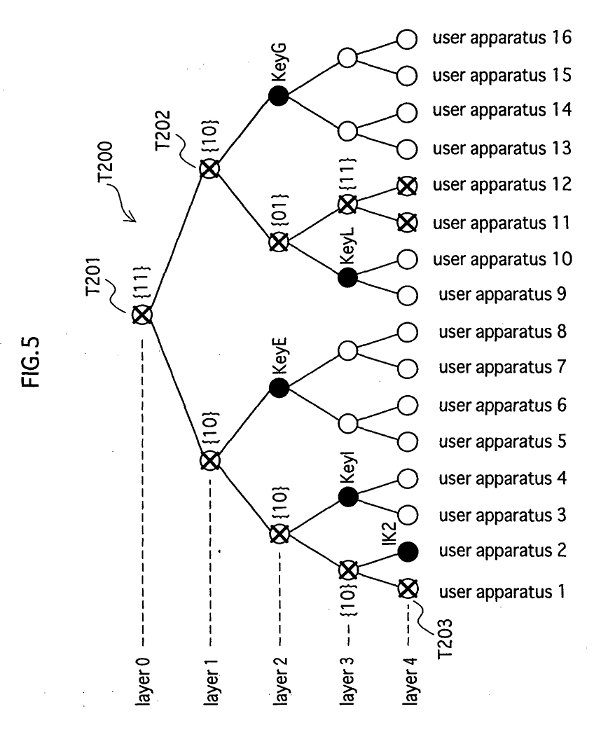

Assuming that user apparatuses shown by ID information “0000”, “1010”, and “1011” in the tree structure T100 showing FIG. 4 are to be revoked, the resulting tree structure T200 in which nodes have been revoked in the above-described manner is that shown in FIG. 5.

Furthermore, the tree structure table D100 has revocation flags that correspond to the tree structure T200.

In the tree structure T200, all nodes on the path to the root from the leaf corresponding to the user apparatus 1 shown by the ID information “0000”, all nodes on the path to the root from the leaf corresponding to the user apparatus 11 shown by the ID information “1010”, and all nodes on the path to the root from the leaf corresponding to the user apparatus 12 shown by the ID information “1011” are marked with a cross (X). Each cross shows a revoked node.

Each piece of node information in the tree structure table D100 that corresponds to one of the revoked nodes has a revocation flag attached.

### (6) Key Information Header Generation Unit 106

The key information header generation unit 106 has a variable i that shows a number of a layer, and a variable j that shows the node name in the layer.

The key information header generation unit 106 performs processing (a) described below, for each layer in the tree structure. Each time the key information header generation unit 106 performs the processing, the variable i that shows the layer number has a value “0”, “1”, “2”, or “3”.

(a) The key information header generation unit 106 performs processing (a-1) to (a-3) for each node in the layer whose layer number is shown by the variable i. Here, the name of the node that is the target of processing (a-1) to (a-3) is shown by the variable j.

(a-1) The key information header generation unit 106 obtains from the tree structure table in the tree structure storage unit 102 the piece of node information that includes a node name that is obtained by joining the variable j and “0”, and the piece of node information that includes a node name that is obtained by joining the variable j and “1”.

The two pieces of node information obtained in this way correspond to the two nodes that are directly subordinate to (i.e., connected to and are directly below) the target node shown by the variable j.

(a-2) The key information header generation unit 106 checks whether the revocation flag included in each of the two obtained pieces of node information is “0”. If both are not “0”, the key information header generation unit 106 generate s anode revocation pattern (hereinafter “NRP”) by arranging the two revocation flags respectively included in the two obtained pieces of node information, in the order that the two pieces of node information are stored in the tree structure table.

Specifically, when the revocation flags in the two obtained pieces of node information are “0” and “0” respectively, the key information header generation unit 106 does not generate an NRP.

Furthermore, when the revocation flags in the two obtained pieces of node information are “1” and “0” respectively, the key information header generation unit 106 generates an NRP {10}.

When the when the revocation flags in the two obtained pieces of node information are “0” and “1” respectively, the key information header generation unit 106 generates an NRP {01}.

When the when the revocation flags in the two obtained pieces of node information are “1” and “1” respectively, the key information header generation unit 106 generates an NRP {11}.

(a-3) The key information header generation unit 106 outputs the generated NRP to the key information recording apparatus 200.

In the manner described, the key information header generation unit 106 checks for each node in the layer whether the two directly subordinate nodes of the target node are revoked or not, and when either or both of the two lower nodes is revoked, generates a revocation pattern as described above. In the tree structure T200 shown in FIG. 5, each generated NRP is shown near the corresponding node that is marked with a cross.

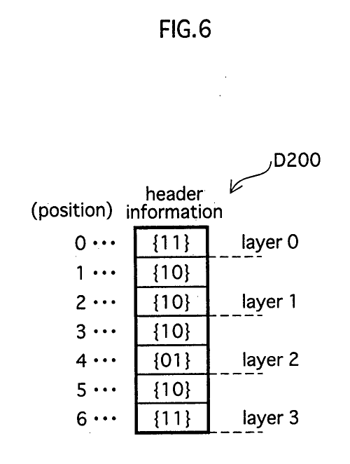

Furthermore, since the key information header generation unit 106 outputs NRPs in the above-described processing, in the case shown in FIG. 5, a plurality of NRPs shown as one example in FIG. 6 are generated and output. The key information header generation unit 106 outputs these NRPs as header information.

In the tree structure T200 shown in FIG. 5, the user apparatus 1, the user apparatus 11 and the user apparatus 12 are revoked. Here, nodes that are on a path from the leaf corresponding to each user apparatus to be revoked through to the root (in other words, the nodes marked with a cross in FIG. 5) are called revoked nodes. Furthermore, an NRP is made by combining in order from left to right the state of the two child nodes of a node. Here, “1” is used to express a revoked child node, while “0” is used to express a child node that is not revoked. For an n-ary tree, each revocation pattern is information that is n bits in length. Both the child nodes of a root T201 in the tree structure T200 are revoked, therefore the revocation pattern of the root T201 is expressed {11}. The revocation pattern of a node T202 is expressed {10}. A node T203 is a revoked node, but since it is a leaf and therefore does not have any child nodes, it does not have a revocation pattern.

As shown in FIG. 6 as one example, header information D200 is composed of NRPs {11}, {10}, {10}, {10}, {01}, {10}, and {11}, which are included in the header information D200 the stated order.

Note that the positions in the header information D200 in which the node information patterns are arranged are set. The positions are set according to the above-described repeated processing. As shown in FIG. 6, the NRPs {11}, {10}, {10}, {10}, {01}, {10}, and {11} are arranged respectively in positions defined by “0”, “1”, “2”, “3”, “4”, “5”, and “6”.

As has been described, the key information header generation unit 106 extracts the NRP of at least one revoked node, and outputs the extracted at least one NRP as header information of the key information, to the key information recording apparatus 200. Here, the key information header generation unit 106 arranges in level order. In other words, the key information header generation unit 106 arranges the plurality of NRPs in order from the top layer through to the bottom layer, and arranges NRPs of the same layer in order from left to right. Note it is sufficient for the NRPs to be arranged based on some kind of rule. For example, NRPs in the same layer may be arranged from right to left.

### (7) Key Information Generation Unit 107

The key information generation unit 107 has a variable i that shows the layer number, and a variable j that shows the node name in the layer, the same as the key information header generation unit 106.

The key information generation unit 107 performs the following processing (a) for each layer excluding the layer 0. In performing the processing (a) for each layer, the variable i showing the layer number holds a value “1”, “2”, or “3”.

(a) The key information generation unit 107 performs processing (a-1) to (a-3) for each node in the layer whose layer number is shown by the variable i. Here, the name of the node that is the target of processing (a-1) to (a-3) is shown by the variable j.

(a-1) The key information generation unit 107 obtains the piece of node information that includes the variable j as the node name, from the tree structure table in the tree structure storage unit 102, and judges whether the revocation flag in the obtained node information is “1” or “0”.

(a-2) When the revocation flag is “0”, the key information generation unit 107 further judges whether encryption has been performed using the device key that corresponds to the node connected directly above the target node.

(a-3) When the encryption has not been performed using the device key that corresponds to the node connected directly above the target node, the key information generation unit 107 extracts the device key from the obtained piece of node information, and encrypts the generated media key with use of the extracted device key, by applying an encryption algorithm E1, to generate an encrypted media key.

Encrypted media key=E1 (device key, media key)

Here, E (A, B) shows that data B is encrypted with use of a key A by applying the encryption algorithm E.

One example of the encryption algorithm E1 is DES (Data Encryption Standard).

Next, the key information generation unit 107 outputs the generated encrypted media key to the key information recording apparatus 200.

Note that when the revocation flag is “1”, or when encryption has been performed, the key information generation unit 107 does not perform the processing (a-3).

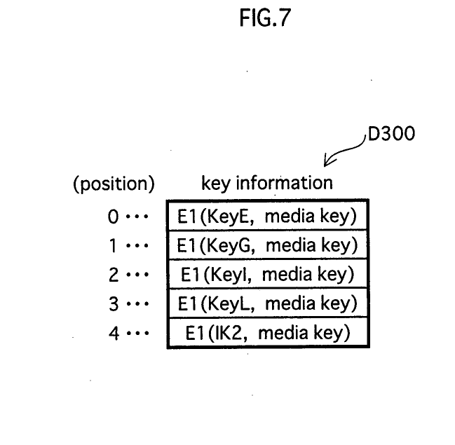

Since the key information generation unit 107 performs the above-described processing repeatedly as described, in the case shown in FIG. 5, a plurality of encrypted media keys such as those shown in an example in FIG. 7 are generated and output. The key information generation unit 107 outputs the plurality of encrypted media keys as key information D300.

Note that the positions in which the media keys are stored in the key information D300 are set. These positions are set according to the above-described processing. As shown in FIG. 7, encrypted media keys E1 (keyE, media key), E1 (keyG, media key), E1 (keyI, media key), E1 (keyL, media key) and E1 (IK2, media key) are stored respectively in positions defined by “0”, “1”, “2”, “3” and “4”.

### 1.1.2 Key Information Recording Apparatus 200

The key information recording apparatus 200 receives header information from the key information header generation unit 106, receives key information from the key information generation unit 107, and writes the received header information and key information to the recording medium 500a.

### 1.1.3 Recording Mediums 500a, b, and c

The recording medium 500a is a recordable medium such as a DVD-RAM, and stores no information of any kind.

The recording medium 500b is the recording medium 500a to which key information that has header information attached thereto has been written by the key management apparatus 100 and the key information recording apparatus 200 in the manner described earlier.

The recording medium 500c is the recording medium 500b to which encrypted content has been written by any of the recording apparatuses 300a etc. in the manner described earlier.

As shown in FIG. 8, key information that has header information attached thereto and encrypted content are recorded on the recording medium 500c.

### 1.1.4 Recording Apparatuses 300a etc.

The recording apparatus 300a, shown in FIG. 8, is composed of a key information storage unit 301, a decryption unit 302, specification unit 303, an encryption unit 304, and a content storage unit 305. Note that the recording apparatuses 300b etc. have an identical structure to the recording apparatuses 300a, and therefore descriptions thereof are omitted.

The recording apparatus 300a includes a microprocessor, a ROM, and a RAM. Computer programs are stored in the RAM. The recording apparatus 300a achieves its functions by the microprocessor operating in accordance with the computer programs.

The recording medium 500b is loaded into the recording apparatus 300a. The recording apparatus 300a analyzes header information stored on the recording medium 500b, based on the ID information stored by the recording apparatus 300a itself, to specify the positions of the encrypted media key that is to be decrypted and the device key that is to be used, and uses the specified device key to decrypt the encrypted media key and consequently obtain the media key. Next, the recording apparatus 300a encrypts digitized content with use of the obtained media key, and records the encrypted content on the recording medium 500b.

### (1) Key Information Storage Unit 301

The key information storage unit 301 has an area for storing ID information, five device keys, and five pieces of device key identification for respectively identifying the five device keys.

### (2) Specification Unit 303

The specification unit 303 operates under the assumption that the key information header generation unit 106 in the key management apparatus 100 has generated the header information of the key information following the Order Rule 1 described earlier.

The specification unit 303 reads the ID information from the key information storage unit 301. The specification unit 303 also reads the header information and the key information from the recording medium 500b. Next, the specification unit 303 specifies a position X of one encrypted media key in the key information, with use of the read ID information and the read header information, by checking the pieces of header information sequentially from the top, and specifies the piece of device key identification information that identifies the device key that is to be used in decrypting the encrypted media key. Note that details of the operations for specifying the position X of the encrypted media key and specifying the piece of device key identification information are described later.

Next, the specification unit 303 outputs the specified encrypted media key and the specified device identification information to the decryption unit 302.

### (3) Decryption Unit 302

The decryption unit 302 receives the encrypted media key and the piece of device key identification information from the specification unit 303. On receiving the encrypted media key and the piece of device key identification information, the decryption unit 302 reads the device key identified by the received piece of device key identification information from the key information storage unit 301, and decrypts the received encrypted media key with use of the read device key by applying a decryption algorithm D1, to generate a media key.

media key=D1 (device key, encrypted media key)

Here, D(A, B) denotes decrypting encrypted data B with use of a key A by applying a decryption algorithm D, to generate the original data.

Furthermore, the decryption algorithm D1 corresponds to the encryption algorithm E1, and is an algorithm for decrypting data that has been encrypted by applying the encryption algorithm E1.

Next, the decryption unit 302 outputs the generated media key to the key information updating unit 304.

Note that each block shown in FIG. 8 is connected to the block by connection lines, but some of the connection lines are omitted. Here, each connection line represents a path via which signals and information are transferred. Furthermore, of the connection lines that connect to the block representing the decryption unit 302, the line on which a key mark is depicted represents the path via which information is transferred to the decryption unit 302 as a key. This is the same for the key information updating unit 304, and also for other blocks in other drawings.

### (4) Content Storage Unit 305

The content storage unit 305 stores content that is a digital work, such as digitized music.

### (5) Encryption Unit 304

The encryption unit 304 receives the media key from the decryption unit 302, and reads the content from the content storage unit 305. Next, the encryption unit 304 encrypts the read content with use of the received media key by applying an encryption algorithm E2, to generate encrypted content.

Encrypted content=E2 (media key, content)

Here, the encryption algorithm E2 is, for example, a DES encryption algorithm.

Next, the encryption unit 304 writes the generated encrypted content to the recording medium 500b. This results in the recording medium 500c to which the encrypted content has been written being generated.

### 1.1.5 Reproduction apparatuses 400a, 440b, 400c

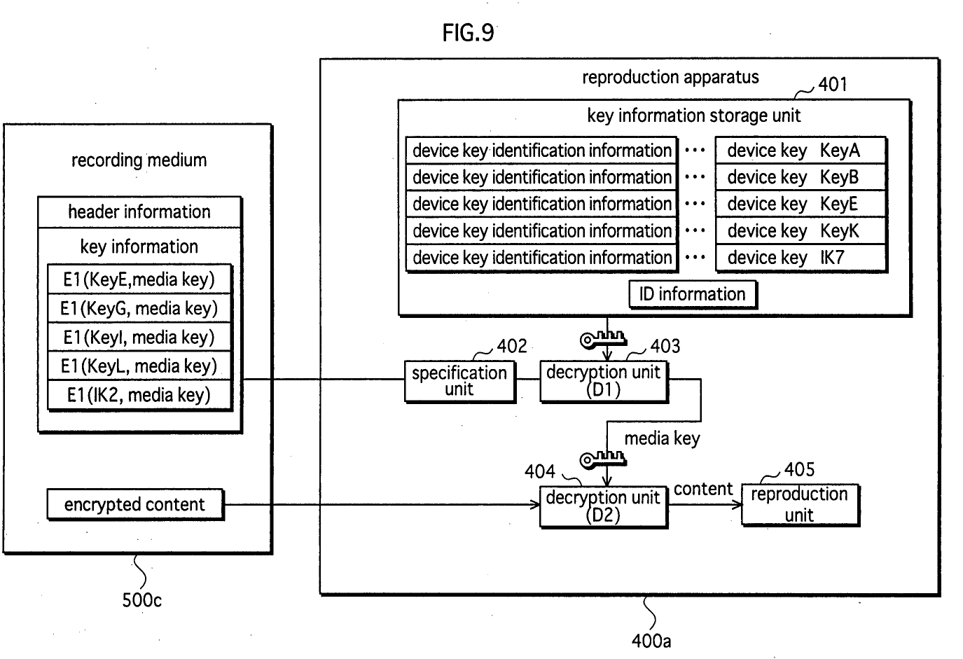

The reproduction apparatus 400a, as shown in FIG. 9, is composed of a key information storage unit 401, a specification unit 402, a decryption unit 403, a decryption unit 404 and a reproduction unit 405. Note that the reproduction apparatuses 400b etc. have the same structure as the reproduction apparatus 400a, and therefore a description thereof is omitted.

The reproduction apparatus 400a specifically includes a microprocessor, a ROM and a RAM. Computer programs are stored in the RAM. The reproduction apparatus 400a achieves its functions by the microprocessor operation according to the computer programs.

Here, the key information storage unit 401, the specification unit 402, and the decryption unit 403 have the same structures as the key information storage unit 301, specification unit 303, and the decryption unit 302 respectively, and therefore a description thereof is omitted.

The recording medium 500c is loaded into the reproduction apparatus 400a. The reproduction apparatus 400a, based on the ID information that the reproduction apparatus 400a itself stores, analyzes the header information stored in the recording medium 500c to specify the position of the encrypted media key to be decrypted and the device key to be used, and decrypts the specified encrypted media key with use of the specified device key, to obtain the media key. Next, the reproduction apparatus 400a decrypts the encrypted content stored on the recording medium 500c, with use of the obtained media key, to reproduce the content.

### (1) Decryption Unit 404

The decryption unit 404 receives the media key from the decryption unit 403, reads the encrypted content from the recording medium 500c, decrypts the read encrypted content with use of the received media key, by applying a decryption algorithm D2, to generate content, and outputs the generated content to the reproduction unit 405.

Content=D2 (media key, encrypted content)

Here, the decryption algorithm D2 corresponds to the encryption algorithm E2, and is an algorithm for decrypting data that has been encrypted by applying the encryption algorithm E2.

### (2) Reproduction Unit 405

The reproduction unit 405 receives the content from the decryption unit 404, and reproduces the received content. For example, when the content is music, the reproduction unit 405 converts the content to audio, and outputs the audio.

### 1.2 Operations of the Digital Work Protection System 10

The following describes operations of the digital work protection system 10

### 1.2.1 Operations for Assigning Device Keys, Generating a Recording/Medium, and Encrypting or Decrypting Content

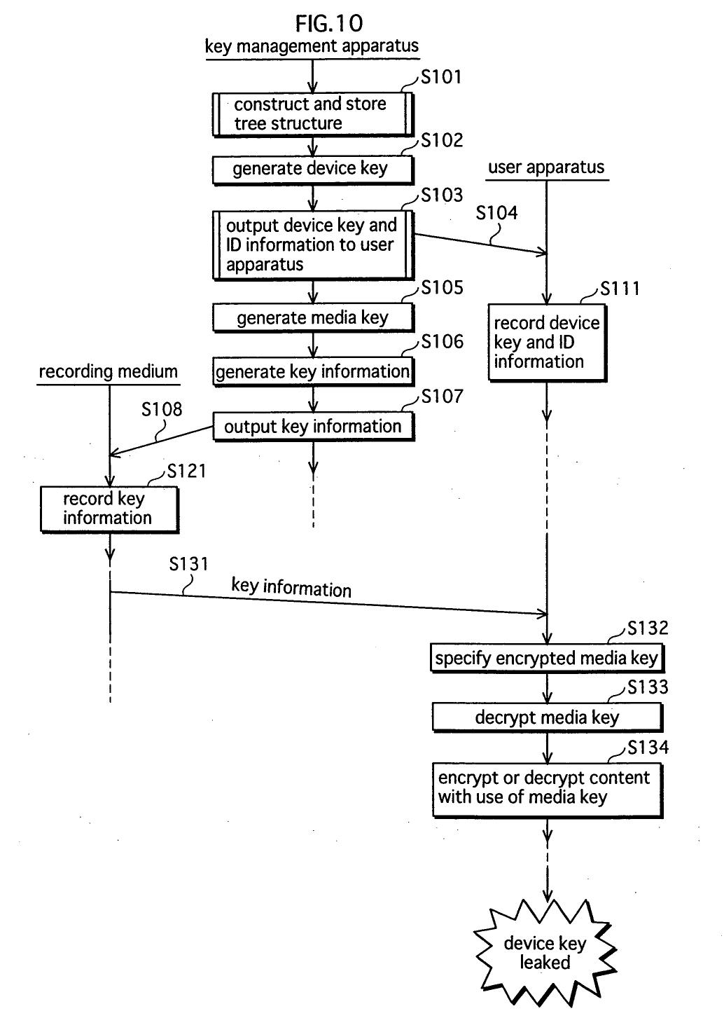

Here, the flowchart in FIG. 10 is used to describe operations for assigning device keys to each user apparatus, operations for generating key information and writing the key information to a recording medium, and operations by the user apparatus for encrypting or decrypting content. In particular, the operations are described for up until the device key is exposed illegally by a third party.

The tree structure construction unit 101 in the key management apparatus 100 generates a tree structure table that expresses a tree structure, and writes the generated tree structure table to the tree structure storage unit 102 (step S101). Next, the tree structure construction unit 101 generates a device key for each node of the tree structure, and writes each generated device key in correspondence with the respective node to the tree structure table (step S102). Next, the device key assignment unit 103 outputs device keys, device key information and ID information to the corresponding user apparatus (steps S103 to S104). The key information storage unit of the user apparatus receives the device keys, the device key identification information and the ID information (step S104), and records the received device keys, device key identification information and ID information (step S111).

In this way, user apparatuses in which device keys, device key identification information, and ID information are recorded are produced, and the produced user apparatuses are sold to users.

Next, the key information generation unit 107 generates a media key (step S105), generates key information (step S106), and outputs the generated key information to the recording medium 500a via the key information recording apparatus 200 (steps S107 to S108). The recording medium 500a stores the key information (step S121).

In this way, the recording medium 500b on which the key information is recorded is generated, and then distributed to the user by, for instance, being sold.

Next, the recording medium on which the key information is recorded is loaded into the user apparatus, and the user apparatus reads the key information from the recording medium (step S131), uses the read key information to specify the encrypted media key that is assigned to the user apparatus itself (step S132), and decrypts the media key (step S133). Then, the user apparatus either encrypts the content, using the decrypted media key, and writes the encrypted content to the recording medium 500b, or reads encrypted content recorded from the recording medium 500c, and decrypts the read encrypted content, using the media key, to generate content (step S134).

In this way, encrypted content is written to the recording medium 500b by the user apparatus, and encrypted content recorded on the recording medium 500c is read and decrypted by the user apparatus, and then reproduced.

Next, the third party illegally obtains the device key by some kind of means. The third party circulates the content illegally, and produces and sells illegitimate apparatuses that are imitations of a legitimate user apparatus.

The manager of the key management apparatus 100 or the copyright holder of the content discovers that the content is being circulated illegally, or that illegitimate apparatuses are circulating, and therefore knows that a device key has been leaked.

### 1.2.2 Operations After the Device Key has been Exposed

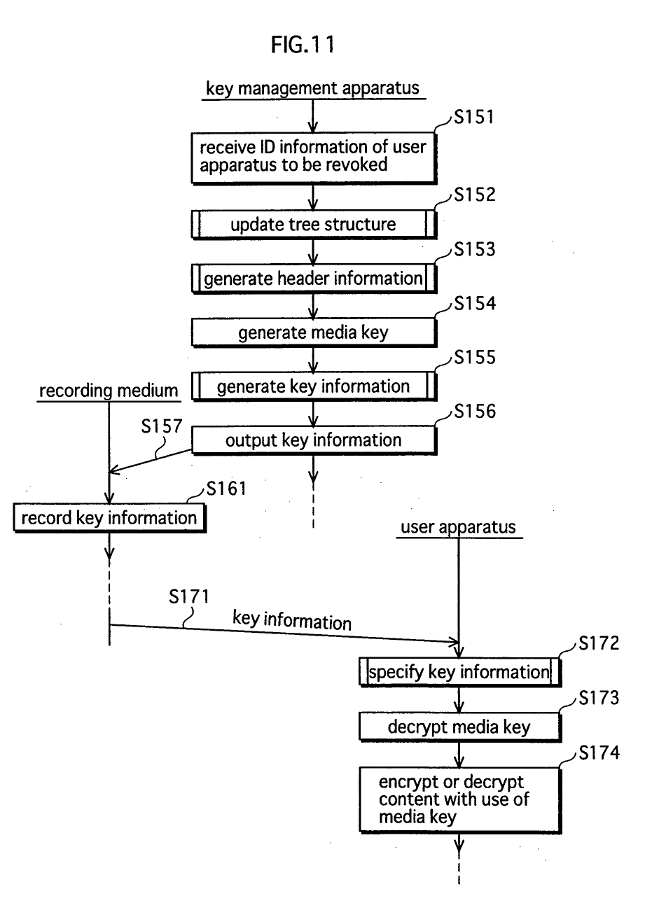

Here, the flowchart in FIG. 11 is used to describe operations for revoking nodes in the tree structure that correspond to the exposed device key, operations for generating new key information and writing the generated key information to a recording medium, and operations by the user apparatus for encrypting or decrypting content, after a device key has been exposed illegally by a third party.

The revoked apparatus designation unit 104 of the key management apparatus 100 receives at least one piece of ID information about at least one user apparatus to the revoked, and outputs the received ID information to the key structure updating unit 105 (step S151). Next, the key structure updating unit 105 receives the ID information, and updates the tree structure using the received ID information (step S152). The key information header generation unit 106 generates header information, and outputs the generated header information to the key information recording apparatus 200 (step S153). The key information generation unit 107 generates a media key (step S154), generates key information (step S155), and outputs the generated key information via the key information recording apparatus 200 (steps S156 to S157), which records the key information on to the recording medium 500a (step S161).

In this way, a recording medium 500b on which the key information is recorded is generated, and then distributed to the user by, for instance, being sold.

Next, the recording medium on which the key information is recorded is loaded in the user apparatus, and the user apparatus reads the key information from the recording medium (step S171), uses the read key information to specify the encrypted media key assigned to the user apparatus itself (step S172), and decrypts the media key (step S173). Then, the user apparatus either encrypts the content with use of the decrypted media key and writes the encrypted content to the recording medium 500b, or reads encrypted content recorded on the recording medium 500c and decrypts the read encrypted content with use of the media key, to generate content (step S174).

In this way, encrypted content is written to the recording medium 500b by the user apparatus, and encrypted content recorded on the recording medium 500c is read and decrypted by the user apparatus and then reproduced.

### 1.2.3 Operations for Constructing and Storing the Tree Structure

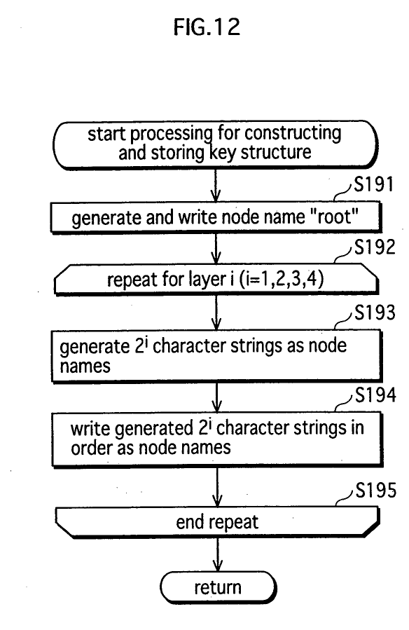

Here, the flowchart in FIG. 12 is used to describe operations by the tree structure construction unit 101 for generating a tree structure table and writing the tree structure table to the tree structure storage unit 102. Note that the operations described here are details of step S101 in the flowchart in the FIG. 10.

The tree structure construction unit 101 generates node information that includes “root” as the node name, and writes the generated node information to the tree structure table in the tree structure storage unit 102 (step S191).

Next, the tree structure construction unit 101 repeats the, following steps S193 to S194 for layer i (i=1,2,3,4).

The tree structure construction unit 101 generates a string of 2ⁱ characters as the node name (step S193), and writes node information that includes the string of 2ⁱ characters as the node name in order to the tree structure table (step S194).

### 1.2.4 Operations for Outputting Device Keys and ID Information to the User Apparatuses

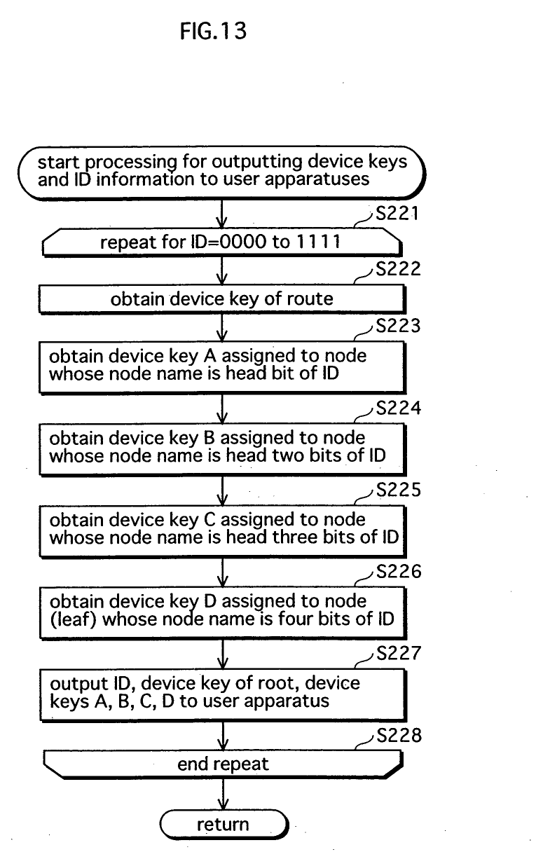

Here, the flowchart in FIG. 13 is used to describe operations by the device key assignment unit 103 for outputting device keys and ID information to the user apparatuses. Note that the operations described here are details of step S103 in the flowchart in FIG. 10.

The device key assignment unit 103 varies the variable ID to be “0000”, “0001”, “0010”, . . . , “1110”, and “1111”, and repeats the following steps S222 to S227 for each variable ID.

The device key assignment unit 103 obtains the device key assigned to the root (step S222), obtains the device key A assigned to the node whose node name is the head bit of the variable ID (step S223), obtains a device key B assigned to the node whose node name is the head two bits of the variable ID (step S224), obtains a device key C assigned to the node whose node name is the head three bits of the variable ID (step S225), obtains a device key D assigned to the node whose node name is the head four bits of the variable ID (step S226), and outputs the device keys A, B, C, and D assigned to each node to the user apparatus (step S227).

### 1.2.5 Operations for Updating the Tree Structure

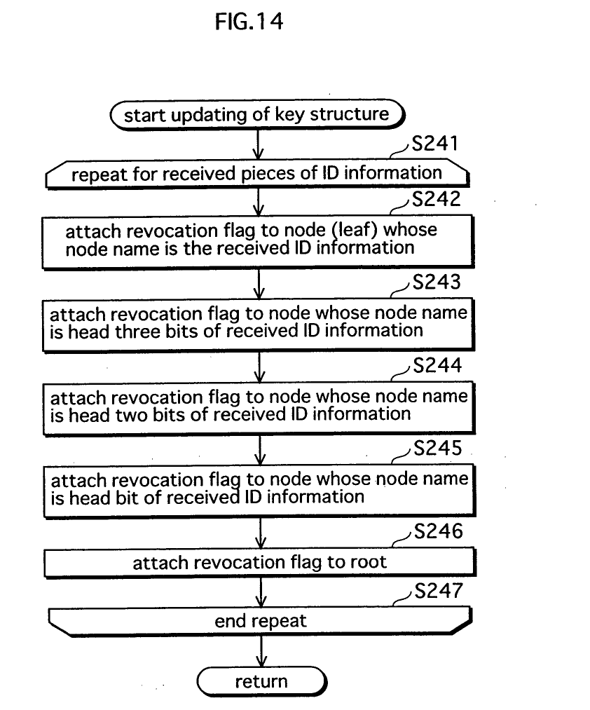

Here, the flowchart in FIG. 14 is used to describe operations by the key structure updating unit 105 for updating the tree structure. Note that the operations described here are details of step S152 in the flowchart in the FIG. 11.

The key structure updating unit 105 performs the following steps S242 to S246 for each of the at least one pieces of ID information received from the revoked apparatus designation unit 104.

The key structure updating unit 105 obtains the piece of node information that includes the received piece of ID information as the node name, and attaches a revocation flag “1” to the obtained node information (step S242).

Next, the key structure updating unit 105 obtains the piece of node information that includes the head three bits of the received piece of ID information as the node name, and attaches a revocation flag “1” to the obtained node information (step S243).

Next, the key structure updating unit 105 obtains the pieces of node information that includes the head two bits of the received piece of ID information as the node name, and attaches a revocation flag “1” to the obtained node information (step S244).

Next, the key structure updating unit 105 obtains the piece of node information that includes the head bit of the received ID information as the node name, and attaches a revocation flag “1” to the obtained piece of node information (step S245).

Next, the key structure updating unit 105 obtains the piece of node information that includes “root” as the node name, and attaches a revocation flag “1” to the obtained piece of node information (step S246).

### 1.2.6 Operations for Generating Header Information

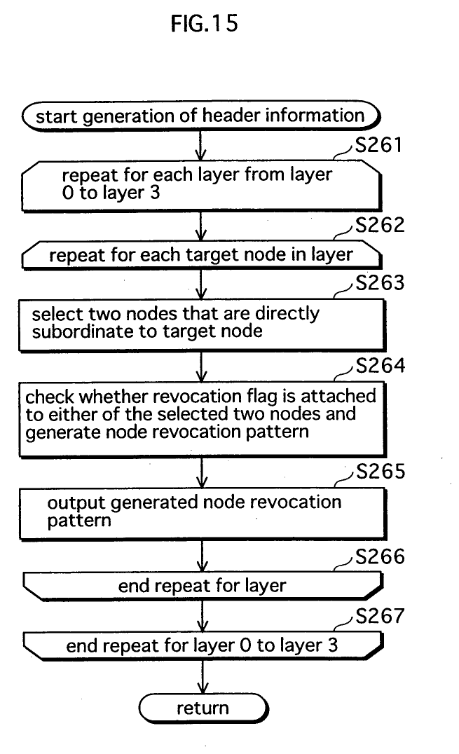

Here, the flowchart in FIG. 15 is used to describe operations by the key information header generation unit 106 for generating header information. Note that the operations described here are the details of step S153 in the flowchart in FIG. 11.

The key information header generation unit 106 performs steps S262 to S266 for each layer from layer 0 to layer 3, and further performs steps S263 to S265 for each target node in each layer.

The key information header generation unit 106 selects the two directly subordinate nodes of the target node (step S263), checks whether each of the two selected nodes have a revocation flag attached thereto or not, to generate an NRP (step S264), and outputs the generated revocation pattern (step S265).

### 1.2.7 Operations for Generating Key Information

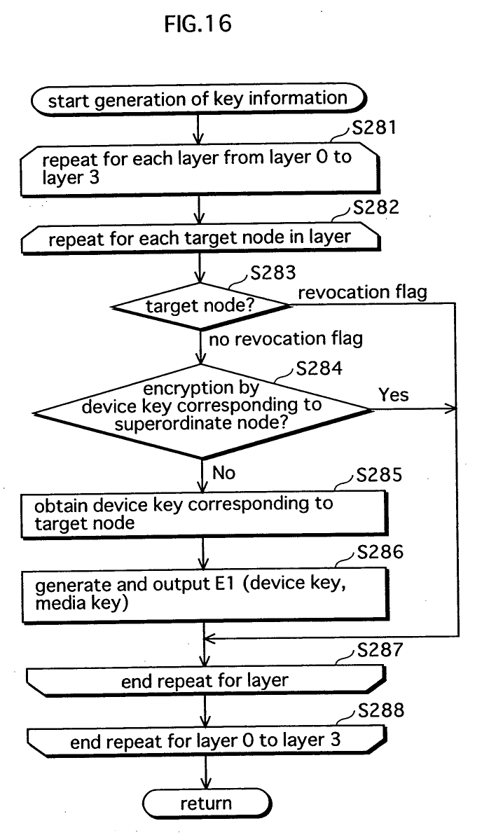

Here, the flowchart in FIG. 16 is used to described operations by the key information generation unit 107 for generating key information. Note that the operations described here are the details of step S155 in the flowchart in FIG. 11.

The key information generation unit 107 performs steps S282 to S287 for each layer from layer 1 to layer 3, and further performs steps S283 to S286 for each target node in each layer.

The key information generation unit 107 judges whether a revocation flag “1” is attached to the target node. When a revocation flag “1” is not attached (step S283), the key information generation unit 107 further judges whether encryption has been performed using the device key corresponding to the superordinate node of the target node. When encryption has not been performed (step S284), the key information generation unit 107 obtains the device key corresponding to the target node from the tree structure table (step S285), encrypts the generated media key using the obtained device key, to generate an encrypted media key, and outputs the encrypted media key (step S286).

When a revocation flag “1” is attached to the target node (step S283), or when encryption has been performed (step S284), the key information generation unit 107 does not perform steps S285 to S286.

### 1.2.8 Operations for Specifying Key Information

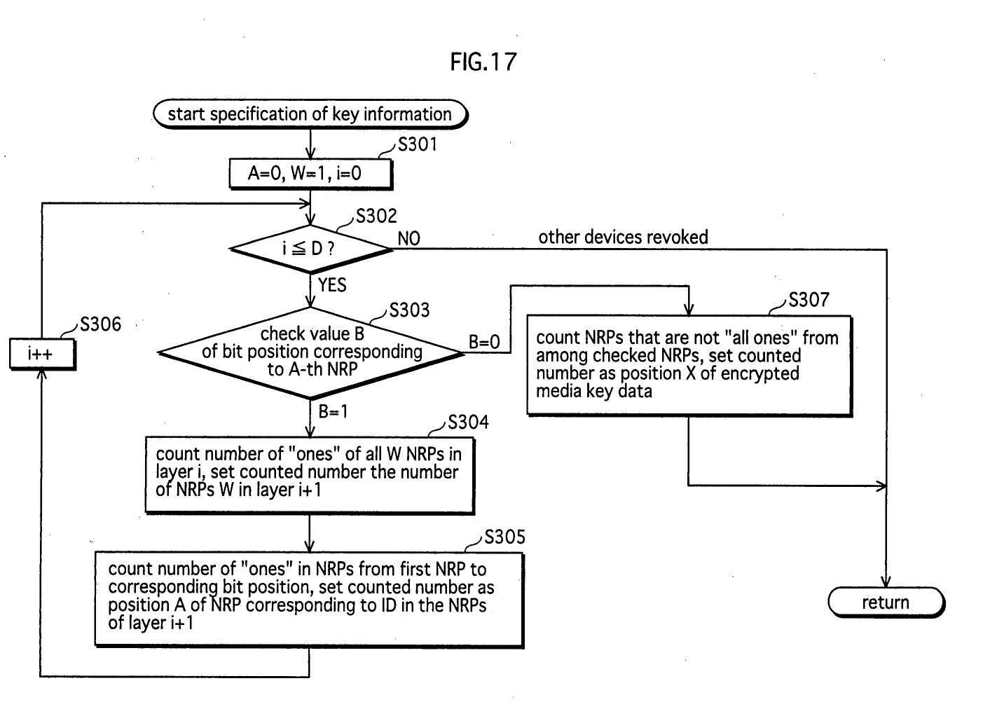

Here, the flowchart in FIG. 17 is used to describe operations by the specification unit 303 of the recording apparatus 300a for specifying an encrypted media key from key information stored on the recording medium 500b. Note that the operations described here are the details of step S172 in the flowchart in FIG. 11.

Note also that operations performed by the specification unit 402 of the reproduction apparatus 400a are the same as those by the specification unit 303, and therefore a description thereof is omitted.

The specification unit 303 has a variable X that shows the position of the encrypted media key, a variable A that shows the position of the NRP relating to the user apparatus itself, a variable W that shows the number of NRPs in a layer, and a value D that shows the number of layers in the tree structure. Here, an NRP relating to the user apparatus itself denotes an NRP of a node in the tree structure that is on the path from the leaf assigned to the user apparatus through to the root.

The specification unit 303 analyzes the layer i=0 through to the layer i=D−1 according to the following procedure.

The specification unit 303 sets variable A=0, variable W=1, and variable i=0 as initial values (step S301).

The specification unit 303 compares the variable i and the value D, and when the variable i is greater than the value D (step S302) the user apparatus is a revoked apparatus, therefore the specification unit 303 ends the processing.

When the variable i is less than or equal to the value D (step S302), the specification unit 303 checks whether a value B that is in the bit position corresponding to the value of the highest i-th bit of the ID information is “0” or “1”, to determine which of the left bit and the right bit of the NRP the value B corresponds to (step S303). Here, since, as shown in FIG. 4, “0” is assigned to the left path in the tree structure and “1” is assigned to the right path, and the ID information is composed based on this rule, a value “0” of the highest i-th bit of the ID information corresponds to the left bit of the A-th NRP, while a value “1” of the right bit corresponds to the A-th NRP.

When value B=0 (step S303), the specification unit 303 counts the number of NRPS, from amongst the NRPs checked so far, whose bits do not all have the value “1”, and sets the counted value as the variable X. The variable X obtained in this way shows the position of the encrypted media key. Furthermore, the variable i at this point is the device key identification information for identifying the device key (step S307). The specification unit 303 then ends the processing.

When value B=1 (step S303), the specification unit 303 counts the number of “ones” in all W NRPs in layer i, and sets the counted value in the variable W. The variable W obtained in this way shows the number of NRPs in the next layer i+1 (step S304).

Next, the specification unit 303 counts the number of “ones” starting from the first NRP in layer i through to the NRP of the corresponding bit position, and sets the counted value in the variable A. Here, the value of the corresponding bit position is not counted. The variable A obtained in this way shows the position of the NRP, from amongst the NRPs in the next layer i+1, relating to the user apparatus itself (step S305).

Next, the specification unit 303 calculates the variable i=i+1 (step S306), moves the control to step S302, and repeats the above-described processing.

### 1.2.9 Specific Example of Operations for Specifying Key Information

The following describes one specific example of operations by the non-revoked user apparatus 14 shown in FIG. 5 until specifying an encrypted media key with use of the header information and the key information shown in FIGS. 6 and 7. Here it is supposed that the user apparatus 14 has been assigned ID information “1101”, and device keys “KeyA”, “KeyC”, “KeyG”, “KeyN” and “IK14”.

<Step 1> Since the value of the top bit of the ID information “1101” assigned to the user apparatus 14 is “1”, the specification unit 303 checks the right bit of the first NRP {11} (step S303).

<Step 2> Since the value of right bit of the first NRP {11} is “1”, the specification unit 303 continues analyzing (step S303, B=1).

<Step 3> The specification unit 303 counts the number of “ones” in the NRP {11} in layer 0. Since the counted value is “2”, the specification unit 303 knows that there are two NRPs in the next layer 1 (step S304).

<Step 4> The specification unit 303 counts the number of “ones” in the NRPs up to the corresponding bit position. Note that the value of the corresponding bit position is not counted. Since the counted value is “1”, the NRP corresponding to the next layer 1 is in position 1 in layer 1 (step S305).

<Step 5> Next, since the value of the second bit from the top of the ID information “1101” is “1”, the specification unit 303 checks the right bit of the first NRP {10} in layer 1 (step S303).

<Step 6> Here, since the value of the right bit of the first NRP {10} in layer 1 is “0”, the specification unit 303 ends analyzing (step S303, B=0).

<Step 7> The specification unit 303 counts the number of NRPs whose bits do not all have the value “1”, from amongst the NRPs analyzed so far. Note that the NRP that was checked last is not counted. Since the counted value is “1”, the encrypted media key is in position 1 in the key information (step S307).

<Step 8> As shown in FIG. 7, the encrypted media key stored in position 1 in the key information is E1 (KeyG, media key).

The user apparatus 14 has the KeyG. Accordingly, the user apparatus 14 is able to obtain the media key by decrypting the encrypted media key using the KeyG.

### 1.3 Conclusion

As has been described, according to the first embodiment, the plurality of NRPs are arranged in level order in the header information of the key information stored in advance on the recording medium, resulting in key information that is compact in size. Furthermore, the player is able to specify efficiently the encrypted media key to be decrypted.

### 2. Second Embodiment

Here, a second embodiment is described as a modification of the first embodiment.

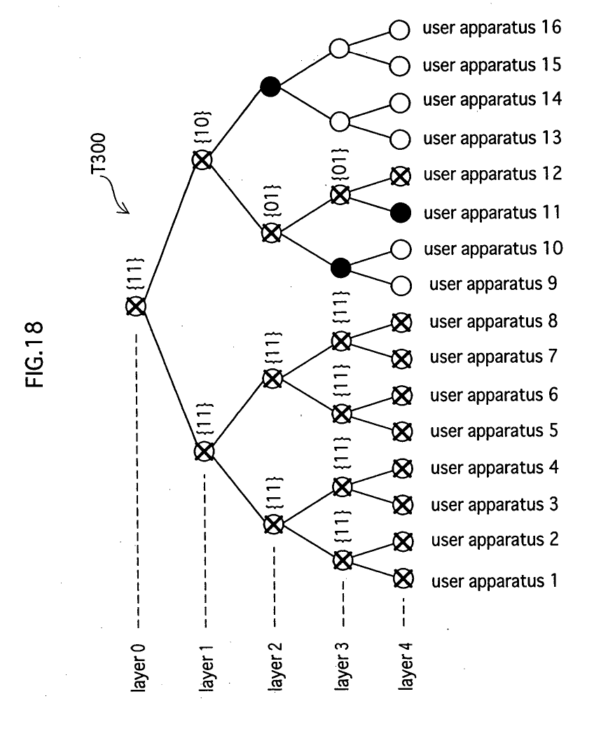

In the first embodiment, as shown as one example in FIG. 18, it is possible that revoked user apparatuses occur around a particular leaf in the tree structure. In this case, there are numerous NRPs that are {11} in the header information of the key information that the key management apparatus 100 writes to the recording medium. In the example shown in FIG. 18, the leaves on the left half of a tree structure T300 all correspond to revoked apparatuses, therefore eight of the eleven NRPs included in the header information in the key information are {11}.

In the example shown in FIG. 18, since all the apparatuses on the left side of the tree structure T300 are revoked, it is not necessary to record NRPs that correspond to each of the nodes in the left half as header information if it is expressed that the left node of layer 1 and all its subordinate nodes are revoked nodes.

For this purpose, in the second embodiment a digital work protection system 10b (not illustrated) is able to reduce the data size of the header information in cases in which revoked apparatuses occur one-sidedly around a particular leaf.

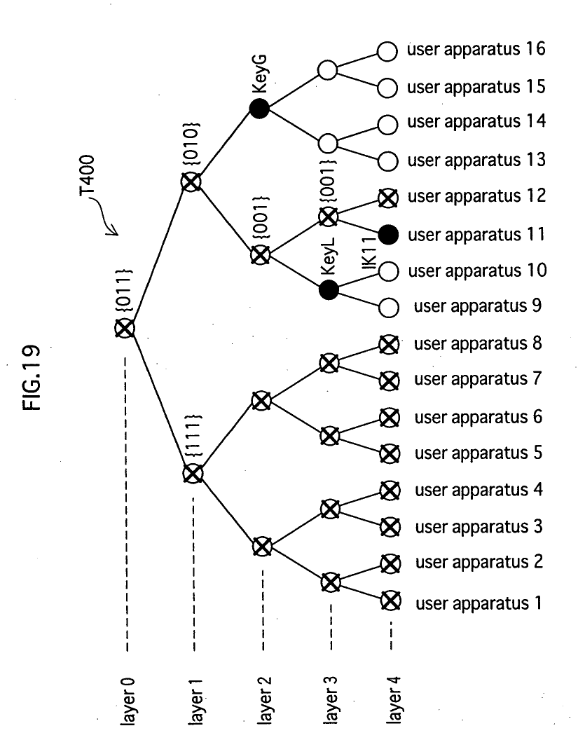

The key management apparatus 100 generates NRPs as header information of the key information, as described in the first embodiment. Here, one bit is added to the head of NRPS. An added bit “1” means that all the user apparatuses assigned to the descendant nodes of the particular node are revoked apparatuses. In FIG. 19, not all the apparatuses assigned to the descendant nodes of a node T401 and a node T402 are revoked, therefore the head bit is “0”, and the NRPs of the nodes T401 and T402 are expressed as {011} and {010} respectively. Since all the apparatuses assigned to the descendant nodes of a node T403 are revoked, the NRP for the node T403 is expressed as {111}. The key management apparatus 100 does not write any NRPs about the descendant nodes of the node T403 to the recording medium.

### 2.1 Structure of the Digital Work Protection System

The digital work protection system 10b has a similar structure to the digital work protection system 10. Here the features of the digital work protection system 10b that differ from the digital work protection system 10 are described.

In the second embodiment, as shown in FIG. 19, user apparatuses 1 to 8 and user apparatus 12 are revoked.

### 2.1.1 Key Management Apparatus 100

The key management apparatus 100 of the digital work protection system 10b has a similar structure to that described in the first embodiment. Here the features of the key management apparatus 100 in the second embodiment that differ from the key management apparatus 100 in the first embodiment are described.

### (1) Tree Structure Storage Unit 102

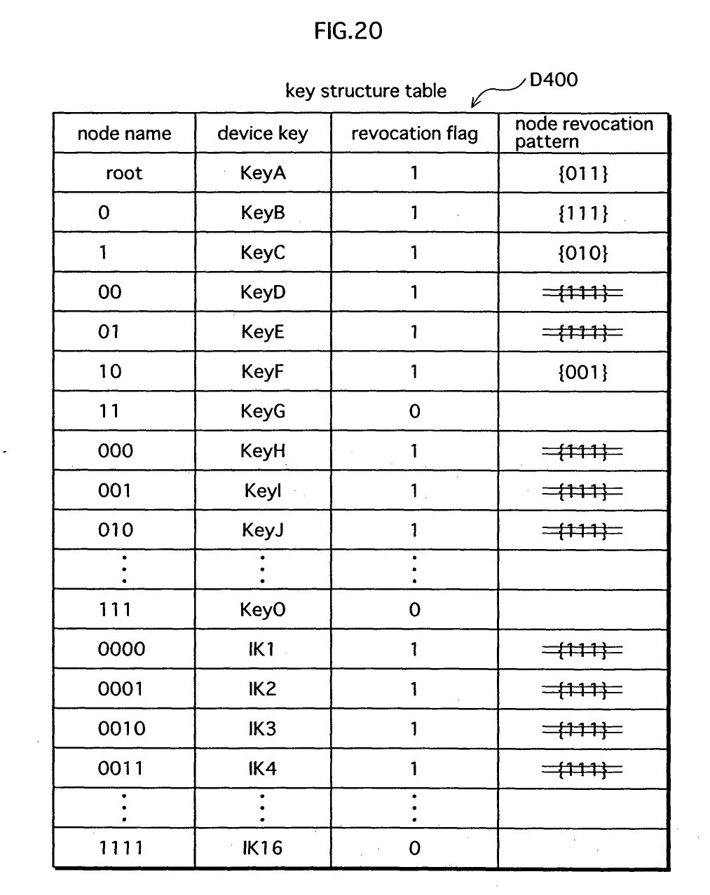

The tree structure storage unit 102 has, as one example, a tree structure table D400 shown in FIG. 20 instead of the tree structure table D100.

The tree structure table D400 corresponds to a tree structure T400 shown in FIG. 19 as one example, and is a data structure for expressing the tree structure T400.

The tree structure table D400 includes a number of pieces of node information that is equal to the number of nodes in the tree structure T400. The pieces of node information correspond respectively to the nodes in the tree structure T400.

Each piece of node information includes a node name, a device key, a revocation flag and an NRP.

The node names, device keys and revocation flags are as described in the first embodiment, therefore descriptions thereof are omitted here.

The NRP is composed of three bits. The highest bit shows, as described above, that all the user apparatuses assigned to the descendant nodes shown by the corresponding node name are revoked apparatuses. The content of the lower two bits is the same as the NRPs described in the first embodiment.

### (2) Key Information Header Generation Unit 106

When the head bit of the NRP is “1”, the key information header generation unit 106 generates an NRP that shows that all the user apparatuses assigned to the descendant nodes of the node are revoked apparatuses, and outputs the generated NRP to the key information recording apparatus 200. Note that generation of the NRP is described in detail later.

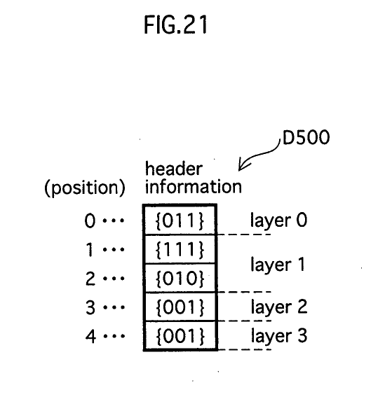

The key information header generation unit 106 generates, as one example, header information D500 shown in FIG. 21. The header information D500 is composed of NRPs {011}, {111}, {010}, {001{ and {001}, which are included in the header information D500 in the stated order. Furthermore, as shown in FIG. 21, the NRPs [011}, [111}, {010}, {001} and {001} are arranged respectively in positions defined by “0”, “1”, “2”, “3” and “4”.

### (3) Key Information Generation Unit 107

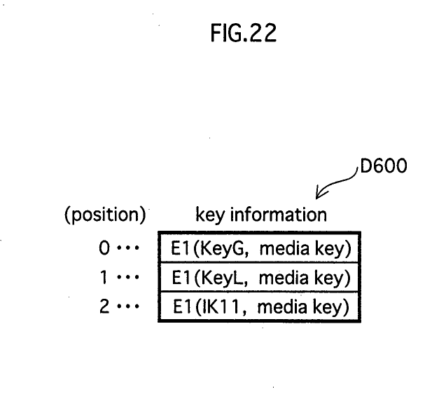

The key information generation unit 107 generates, as one example, key information D600 shown in FIG. 22. The key information D600 includes three encrypted media keys. The encrypted media keys are generated by encrypting the media key with use of device keys KeyG, KeyL, and IK11 respectively.

The position in which each of the plurality of encrypted media keys is stored in the key information D600 is set. As shown in FIG. 22, the encrypted media keys E1 (Key G, media key), E1 (Key L, media key) and E1 (IK11, media key) are arranged respectively in positions defined by “0”, “1” and “2” in the key information D600.

### 2.1.2 Recording Apparatus 300a

The recording apparatus 300a has a similar structure to the recording apparatus 300 described in the first embodiment. Here, the features of the recording apparatus 300a that differ from the recording apparatus 300 are described.

### (1) Specification Unit 303

The specification unit 303 specifies the position X of one encrypted media key in the key information by checking the pieces of header information sequentially from the top, with use of the read ID information and the read header information. Note that details of the operations for specifying the position X of the encrypted media key are described later.

### 2.2 Operations of the Digital Work Protection System 10b

The following description focuses on the features of the operations of the digital work protection system 10b that differ from the digital work protection system 10.

### 2.1.1 Operations for Generating Header Information

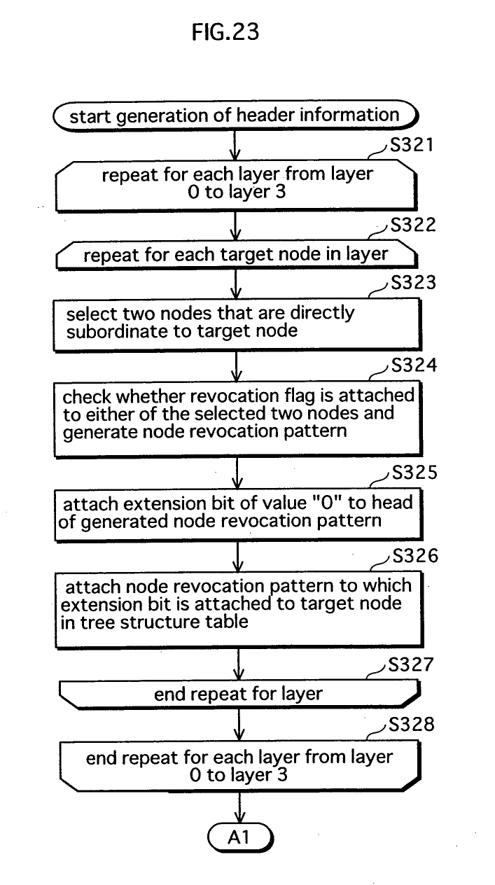

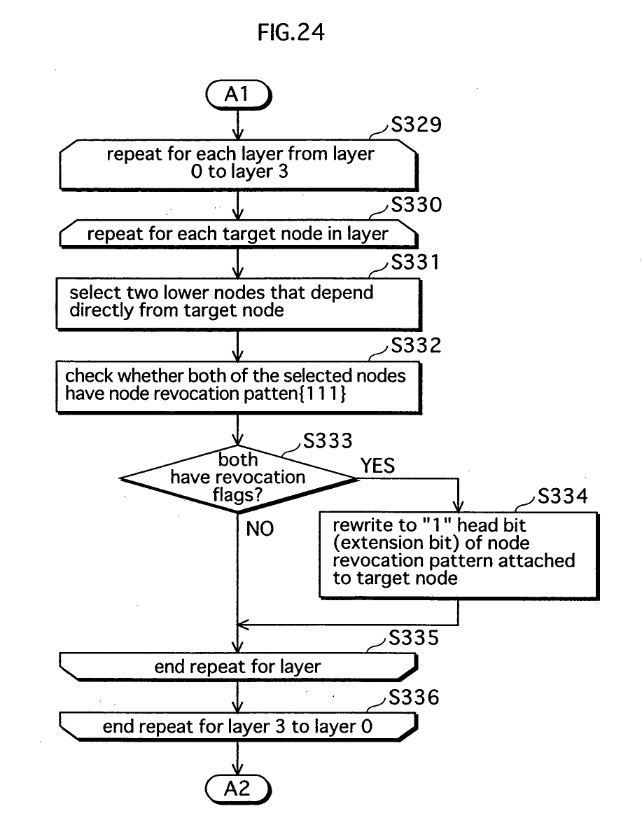

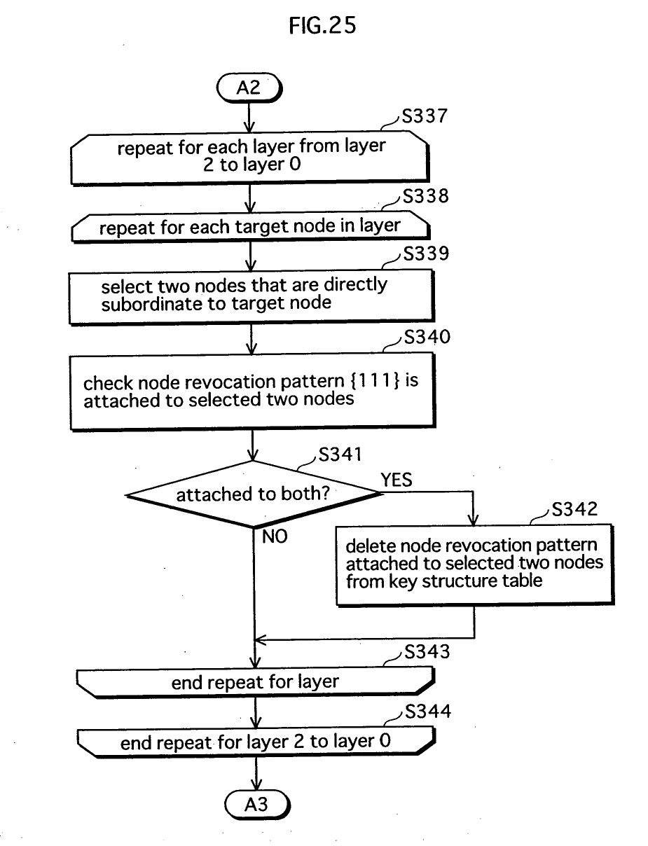

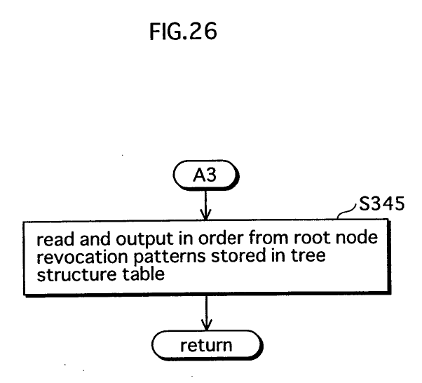

Here, the flowcharts shown in FIG. 23 to FIG. 26 are used to describe operations by the key information header generation unit 106 for generating header information. Note that the operations described here are details of step S153 in the flowchart in FIG. 11.

The key information header generation unit 106 performs steps S322 to S327 for each layer from layer 0 to layer 3, and further performs steps S323 to S326 for each target node in each layer.

The key information header generation unit 106 selects the two directly subordinate nodes of the target node (step S323), checks whether each of the two selected nodes had a revocation flag attached thereto or not, to generate an NRP (step S324), attaches an extension bit having a value “0” to the head of the generated NRP (step S325), and attaches the NRP to which the extension bit has been attached to the node information that corresponds to the target node in the tree structure table (step S326).

In this way, after repetition of steps S321 to S328 has ended, an NRP in attached to each piece of node information in the same way as described in the first embodiment. Here, a value “0” (one bit) is attached to the head of each NRP.

Next, the key information header generation unit 106 performs steps S330 to S335 for each layer from layer 3 to layer 0, and further performs steps S331 to S334 for each target node in each layer.

The key information header generation unit 106 selects the two nodes that are directly below and connected to the target node (step S331), and checks whether each of the two selected nodes has a revocation flag {111} attached thereto or not. When the two selected nodes are leaves, the key information header generation unit 106 checks whether a revocation flag is attached to both the selected nodes (step S332).

Only when both the selected subordinate nodes have NRPs {111} attached thereto, or in the case of the two selected nodes being leaves only when the both of the two selected subordinate nodes have a revocation flag attached thereto (step S333), the key information header generation unit 106 rewrites the head bit of the NRP attached to the target node to “1” (step S334).

In this way, after the key information header generation unit 106 has finished repeating the steps S329 to S336, {111} is attached to the superordinate node of the two subordinate nodes having the NRP {111}.

Next, the key information header generation unit 106 performs steps S338 to S343 for each layer from layer 2 to layer 0, and further performs steps S339 to S342 for each target node in each layer.

The key information header generation unit 106 selects the two directly subordinate nodes of the target node (step S339), and checks whether each of the two selected nodes have a revocation pattern {111} attached thereto or not (step S340).

Only when both the selected lower nodes have revocation patterns {111} attached thereto (step S341), the key information header generation unit 106 deletes the respective NRPs attached to the selected two lower nodes from the tree structure table (step S342).

Next, the key information header generation unit 106 reads and outputs the NRPs stored in the tree structure table in order (step S345).

In this way, when the head bit of an NRP is “1”, an NRP is generated that shows that all the user apparatuses assigned to the descendant nodes of the node are revoked apparatuses.

### 2.2.2 Operations for Specifying Key Information

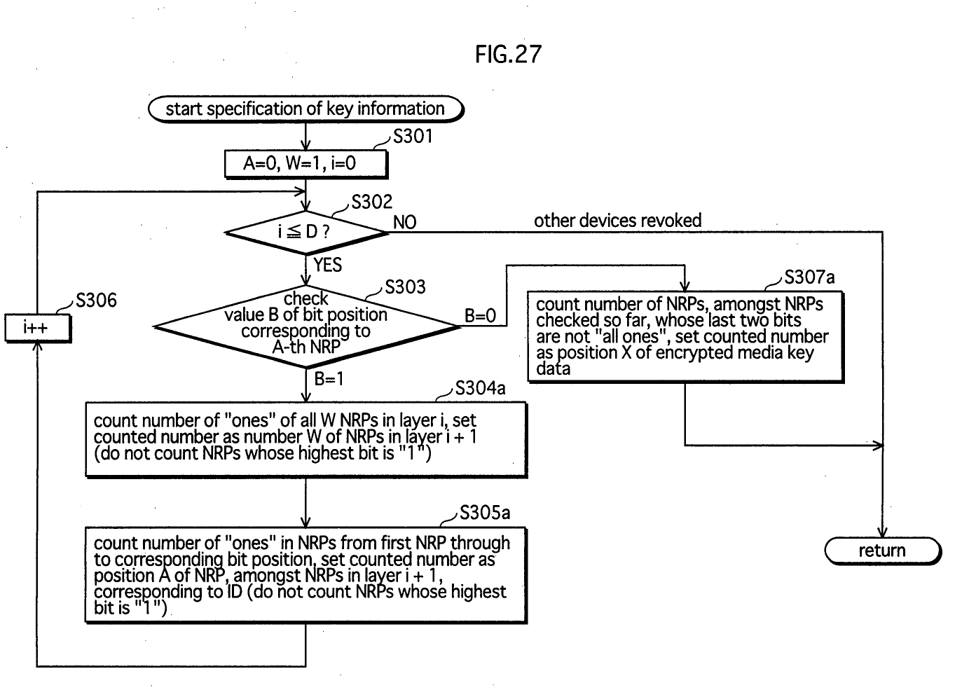

Here, the flowchart shown in FIG. 27 is used to describe operations by the specification unit 303 in the recording apparatus 300a for specifying one encrypted media key from the key information stored on the recording medium 500b. Note that the operations described here are the details of step S172 in the flowchart shown in FIG. 11.

Note that the operations by the specification unit 303 for specifying an encrypted media key are similar to those described in the first embodiment, therefore following description centers on the features of the specification unit 303 that differ to that of the first embodiment.

When value B=0 (step S303), the specification unit 303 counts the number of NRPs, amongst the NRPs checked so far, whose lower two bits do not all have the value “1”, and sets the counted value in the variable X. The variable X obtained in this way shows the position of the encrypted media key (step S307a). The specification unit 303 then ends the processing.

When value B=1 (step S303), the specification unit 303 counts all the “ones” in the W NRPs in the layer i. However, NRPs whose highest bit is “1” are not counted. The counted value is set in the variable W. The variable W obtained in this manner shows the number of NRPs in the next layer i+1 (step S304a).

Next, the specification unit 303 counts the number of “ones” starting from the first NRP through to the NRP of the corresponding bit position, and sets the counted value in the variable A. Here, the value of the corresponding bit position is not counted. The variable A obtained in this way shows the position of the NRP, from amongst the NRPs in the next layer i+1, relating to the user apparatus itself (step S305a).

### 2.2.3 Specific Example of Operations for Specifying Key Information

The following describes one specific example of operations by the non-revoked user apparatus 10 shown in FIG. 19 up to specifying an encrypted media key with use of the header information and the key information shown in FIGS. 21 and 22. Here it is supposed that the user apparatus 10 has been assigned ID information “1001”, and device keys “KeyA”, “KeyC”, “KeyF”, “KeyL” and “IK10”.

<Step 1> Since the value of the top bit of the ID information “1001” assigned to the user apparatus 10 is “1”, the specification unit 303 checks the right bit of the two lower bits of the first NRP {011} (step S303).

<Step 2> Since the value of right bit of the two lower bits of the first NRP {011} is “1”, the specification unit 303 continues analyzing (step S303, B=1).

<Step 3> The specification unit 303 counts the number of “ones” in the two lower bits of the NRP {011} in layer 0. Since the counted value is “2”, the specification unit 303 knows that there are two NRPs in the next layer 1 (step S304a).

<Step 4> The specification unit 303 counts the number of “ones” in two lower bits of the NRP {011} up to the corresponding bit position. Note that the value of the corresponding bit position is not counted. Since the counted value is “1”, the NRP corresponding to the next layer 1 is in position 1 in layer 1 (step S305).

<Step 5> Next, since the value of the second bit from the top of the ID information “1001” is “0”, the specification unit 303 checks the left bit of the two lower bits of the first NRP {010} in layer 1 (step S303).

<Step 6> Here, since the value of the left bit of the two lower bits of the first NRP {010} in layer 1 is “1”, the specification unit 303 continues analyzing (step S303, B=1).

<Step 7> The specification unit 303 counts the number of “ones” in the two lower bits of the two NRPs {111} and {010} in layer 1. Note that NRPs whose highest bit is “1” are not counted. Since the counted value is “1”, the specification unit 303 knows that there is one NRP in the next layer 2 (step S304a).

<Step 8> The specification unit 303 counts the number of “ones” in the NRP up to the corresponding bit position. Note that the value of the corresponding bit position is not counted. Since the counted value is “0”, the position of the corresponding NRP in the next layer 2 is position 0 in layer 2 (step S305a).

<Step 9> Since the value of third bit of the ID information “1001” is “0”, the specification unit 303 checks the left bit of the two lower bits of the 0-th NRP [001} in layer 2 (step S303).

<Step 10> Here, since the value of the left bit of the lower two bits of the 0-th NRP in layer 2 is “0”, the specification unit 303 ends analyzing (step S303, B=0).

<Step 11> The specification unit 303 counts the number of NRPs whose bits are not all “1”, from amongst the NRPs analyzed so far. Note that the NRP that was last checked is not counted. Since the counted value is “1”, the position of the encrypted media key is position 1 in the key information (step S307a).

<Step 12> As shown in FIG. 22, the encrypted media key stored in position 1 in the key information is E1 (KeyL, media key).

The user apparatus 10 has the KeyL. Accordingly, the user apparatus 10 is able to obtain the media key by decrypting the encrypted media key using the KeyL.

Note that in the above-described second embodiment, when all the user apparatuses of descendant nodes of a particular node are revoked, the bit that is added is “1”. However, in the case of a tree structure in which the layer number of the leaves vary, the added bit “1” may also be used as a flag to show the terminal.

### 3. Third Embodiment

In the second embodiment a method was shown that further reduces the size of the header information when revoked terminals occur one-sidedly around a particular leaf, by adding a bit to the head of the NRP of a node to show that the descendants are all revoked terminals.

In the third embodiment, instead of adding a bit to the NRP, an NRP having a specific pattern {00} is used to judge whether all the descendants of a node are revoked terminals. {00} is used here because it is not otherwise used in any of the layers except for the layer 0. The following describes a digital work protection system 10c (not illustrated) that is accordingly able to further reduce the size of header information compared to the second embodiment.

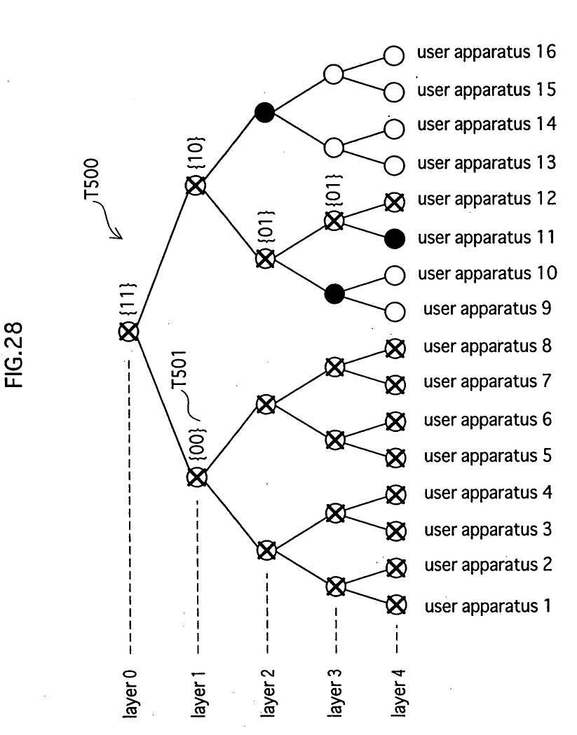

Here, as shown in FIG. 28, user apparatus 1 to user apparatus 8, and user apparatus 12 are revoked. In the third embodiment the NRPs are as shown in the first embodiment, but when all the user apparatuses of descendants of a particular node are revoked apparatuses, the NRP of the node is expressed as {00}. Since the descendants of a node T501 in FIG. 28 are all revoked apparatuses, the NRP of the node T501 is expressed as {00}.

### 3.1 Structure of Digital Work Protection System 10c

The digital work protection system 10c has a similar structure to the digital work protection system 10. Here, the features of the digital work protection system 10c that differ to the digital work protection system 10 are described.

### 3.1.1 Key Management Apparatus 100

The key management apparatus 100 of the digital work protection system 10c has a similar structure to the key management apparatus 100 described in the first embodiment. Here the features of the key management apparatus 100 in the third embodiment that differ from the key management apparatus 100 in the first embodiment are described.

### (1) Key Information Header Generation Unit 106

When the NRP is {00}, the key information header generation unit 106 generates an NRP that shows that all the user apparatuses assigned to the descendant nodes of the node are revoked apparatuses, and outputs the generated NRP to the key information recording apparatus 200. Note that the generated NRP is described in detail later.

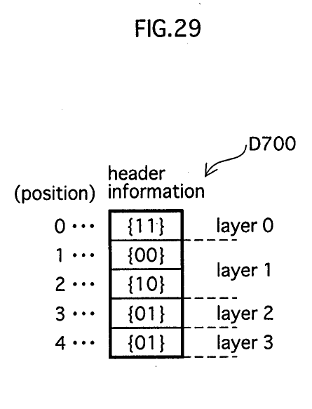

The key information header generation unit 106 generates, as one example, header information D700 shown in FIG. 29. The header information D700 is composed of NRPs {11}, {00}, {10}, {01}, and {01}, which are included in the header information D700 in the stated order. Furthermore, as shown in FIG. 29, the NRP {11}, {00}, {10}, {01} and {01} are positioned respectively in positions defined by “0”, “1”, “2”, “3” and “4”.

### (2) Key Information Generation Unit 107

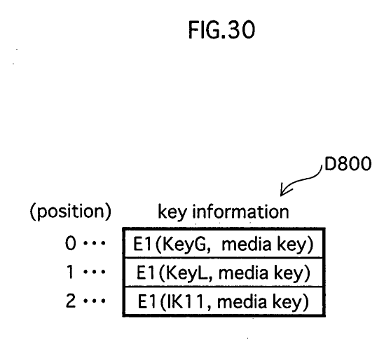

The key information generation unit 107 generates, as one example, key information D800 shown in FIG. 30. The key information D800 includes three encrypted media keys. The encrypted media keys are generated by encrypting the media key with use of device keys KeyG, KeyL, and IK11 respectively.

The position in which each of the plurality of encrypted media keys is stored in the key information D800 is set. As shown in FIG. 30, the encrypted media keys E1 (Key G, media key), E1 (Key L, media key) and E1 (IK11, media key) are arranged respectively in positions defined by “0”, “1” and “2” in the key information D800.

### 3.1.2 Recording Apparatus 300a

The recording apparatus 300a in the digital work protection system 10c has a similar structure to the recording apparatus 300 described in the first embodiment. Here, the features of the recording apparatus 300a that differ from the recording apparatus 300 are described.

### (1) Specification Unit 303

The specification unit 303 specifies the position X of one encrypted media key in the key information, by checking the pieces of header information sequentially from the top, with use of the ID information and the header information. Note that details of the operations for specifying the position X of the encrypted media key are described later.

### 3.2 Operations of the Digital Work Protection System 10c

The following description focuses on the features of the operations of the digital work protection system 10c that differ from the digital work protection system 10.

### 3.2.1 Operations for Generating Header Information

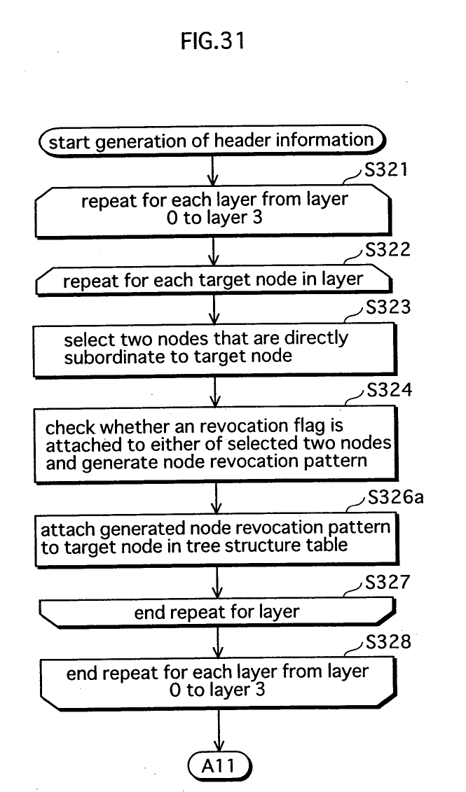

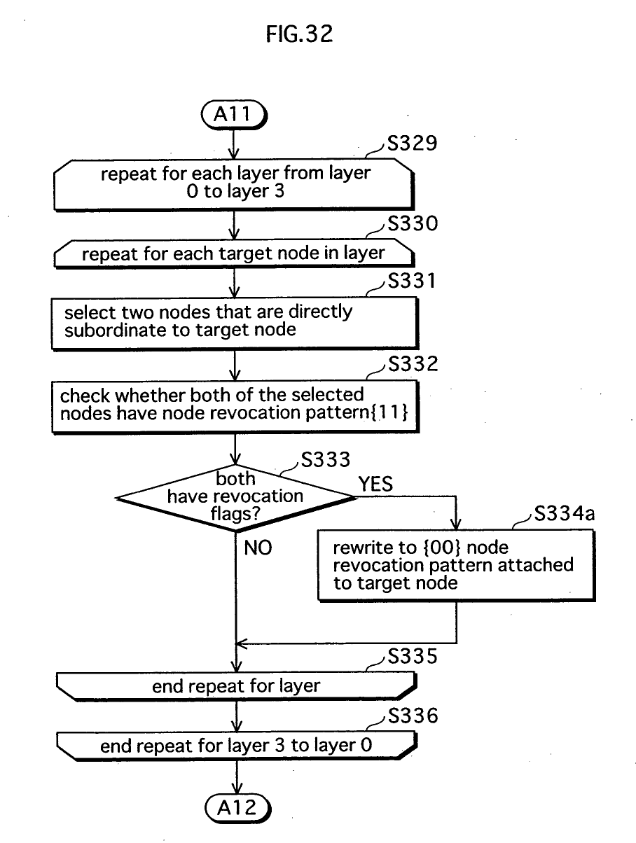

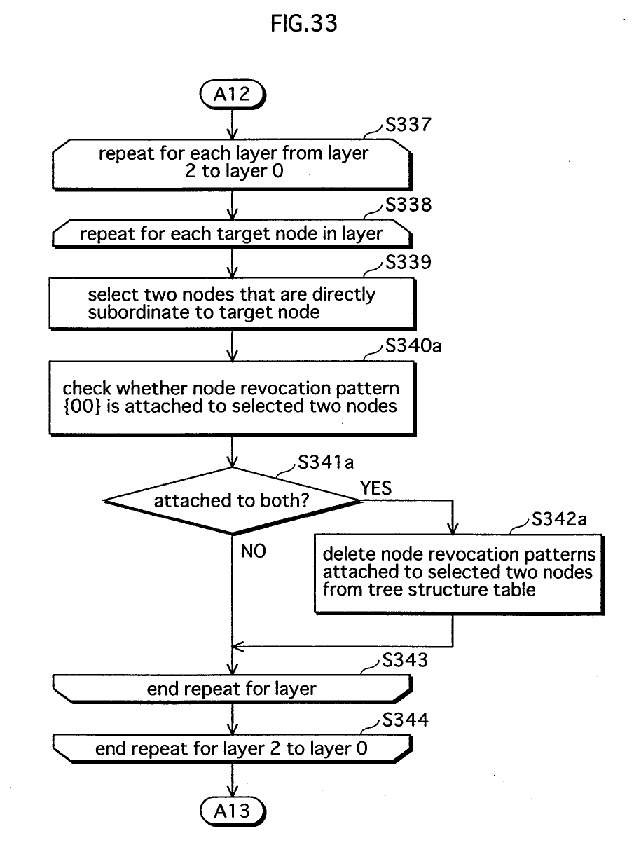

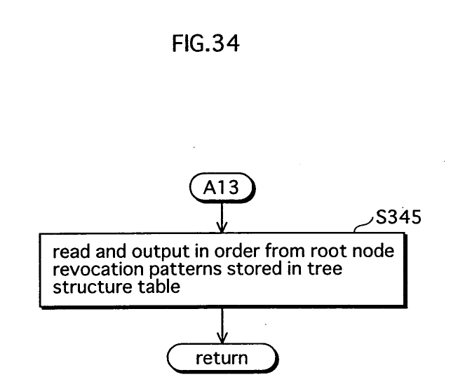

Here, the flowcharts shown in FIG. 31 to FIG. 34 are used to describe operations by the key information header generation unit 106 for generating header information. Note that the operations described here are details of step S153 in the flowchart in FIG. 11.

The key information header generation unit 106 performs steps S322 to S327 for each layer from layer 0 to layer 3, and further performs steps S323 to S326a for each target node in each layer.

The key information header generation unit 106 selects the two directly subordinate nodes of the target node (step S323), checks whether each of the two selected nodes has a revocation flag attached thereto or not, to generate an NRP (step S324), and attaches the NRP to which the extension bit has been attached to the node information in the tree structure table that corresponds to the target node (step S326a).

In this way, after repetition of steps S321 to S328 has ended, an NRP has been attached to each piece of node information in the same way as described in the first embodiment.

Next, the key information header generation unit 106 performs steps S330 to S335 for each layer from layer 3 to layer 0, and further performs steps S331 to S334a for each target node in each layer.

The key information header generation unit 106 selects the two subordinate nodes of the target node (step S331), and checks whether each of the two selected nodes has an NRP {11} attached thereto or not. Note that when the selected two nodes are leaves, the key information header generation unit 106 checks whether both the selected nodes have revocation flags attached thereto (step S332).

Only when both the selected subordinate nodes have NRPs {11} attached thereto, or in the case of the two selected subordinate nodes being leaves, only when both the selected subordinate nodes have revocation flags attached thereto (step S333), the key information header generation unit 106 rewrites the NRP attached to the target node to {00} (step S334a).

When the key information header generation unit 106 has finished repeating the steps S329 to S336 in this way, {00} is attached to the superordinate node of the two subordinate nodes having NRPs {11}.

Next, the key information header generation unit 106 performs steps S338 to S343 for each layer from layer 2 to layer 0, and further performs steps S339 to S342a for each target node in each layer.

The key information header generation unit 106 selects the two subordinate nodes of the target node (step S339), and checks whether each of the two selected nodes have a revocation pattern {00} attached thereto or not (step S340a).

Only when both the selected subordinate nodes have revocation patterns {00} attached thereto (step S341a) the key information header generation unit 106 deletes the respective NRPs attached to the selected two subordinate nodes from the tree structure table (step S342a).

Next, the key information header generation unit 106 reads and outputs the NRPs stored in the tree structure table in order (step S345).

In this way, when an NRP is {00}, an NRP is generated that shows that all the user apparatuses assigned to the descendant nodes of the node are revoked apparatuses.

### 3.2.2 Operations for Specifying Key Information

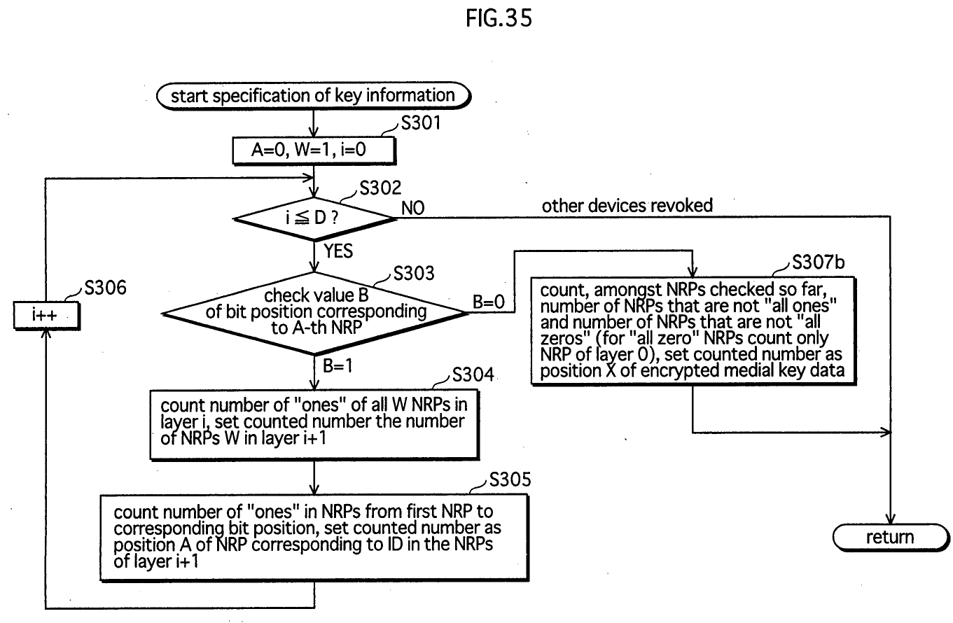

Here, the flowchart shown in FIG. 35 is used to describe operations by the specification unit 303 in the recording apparatus 300a for specifying one encrypted media key from the key information stored on the recording medium 500b. Note that the operations described here are the details of step S172 in the flowchart shown in FIG. 11.

Note that the operations by the specification unit 303 for specifying an encrypted media key are similar to those described in the first embodiment, therefore following description centers on the features of the operations that differ to the first embodiment.

When value B=0 (step S303), the specification unit 303 counts the number of NRPs, amongst the NRP checked so far, whose bits so not all have the value “1” and do not all have the value “0”. Note that the number of NRPs whose bits are all “0” are counted for layer 0 only. The specification unit 303 sets the counted value in the variable X. The variable X obtained in this way shows the position of the encrypted media key. Furthermore, the variable i at this point is the piece of device key identification information that identifies the device key (step S307b). The specification unit 303 then ends the processing.

### 3.2.3 Specific Example of Operations for Specifying Key Information

The following describes one specific example of operations by the non-revoked user apparatus 10 shown in FIG. 28 up to specifying an encrypted media key with use of the header information and the key information shown in FIGS. 29 and 30. Here it is supposed that the user apparatus 10 has been assigned ID information “1001”, and device keys “KeyA”, “KeyC”, “KeyF”, “KeyL” and “IK10”.

<Step 1> Since the value of the top bit of the ID information “1001” assigned to the user apparatus 10 is “1”, the specification unit 303 checks the right bit of the first NRP {11} (step S303).

<Step 2> Since the value of right bit of the first NRP {11} is “1”, the specification unit 303 continues analyzing (step S303, B=1).

<Step 3> The specification unit 303 counts the number of “ones” in the NRP {11} in layer 0. Since the counted value is “2”, the specification unit 303 knows that there are two NRPs in the next layer 1 (step S304).

<Step 4> The specification unit 303 counts the number of “ones” in the NRPs up to the corresponding bit position. Note that the value of the corresponding bit position is not counted. Since the counted value is “1”, the corresponding NRP in the next layer 1 is in position 1 in layer 1 (step S305).

<Step 5> Next, since the value of the second highest bit of the ID information “1001” is “1”, the specification unit 303 checks the right bit of the first NRP {10} in layer 1 (step S303).

<Step 6> Here, since the value of the right bit of the first NRP {10} in layer 1 is “0”, the specification unit 303 ends analyzing (step S303, B=1).

<Step 7> The specification unit 303 counts the number of “ones” in the two NRPs in layer 1. Note that the NRP {00} is not counted. Since the counted value is “1”, the specification unit 303 knows that there is one NRP in the next layer 2 (step S304).

<Step 8> The specification unit 303 counts the number of “ones” in the NRP up to the corresponding bit position. Note that the value of the corresponding bit position is not counted. Since the counted value is “0”, the position of the corresponding NRP in the next layer 2 is position 0 in layer 2 (step S305).

<Step 9> Since the value of third bit of the ID information “1001” is “0”, the specification unit 303 checks the left bit of the two lower bits of the NRP {001} in the position 0 in layer 2 (step S303).

<Step 10> Here, since the value of the left bit of the lower two bits of the 0-th NRP {01} in layer 2 is “0”, the specification unit 303 ends analyzing (step S303, B=0).

<Step 11> The specification unit 303 counts the number of NRPs whose bits do not all have the value “1”, from amongst the NRPs analyzed so far. Note that the NRP that was checked last is not counted. Since the counted value is “1”, the position of the encrypted media key is position 1 in the key information.

<Step 12> As shown in FIG. 30, the encrypted media key stored in position 1 in the key information is E1(KeyL, media key).

The user apparatus 10 has the KeyL. Accordingly, the user apparatus 10 is able to obtain the media key by decrypting the encrypted media key using the KeyL.

### 4. Fourth Embodiment

In the first embodiment NRPs are arranged in order from the top layer to the bottom layer, and NRPs of the same layer are arranged in order from left to right.

In the fourth embodiment a description is given of a digital work protection system 10d (not illustrated) that outputs NRPs in another order.

### 4.1 Structure of Digital Work Protection System 10d

The digital work protection system 10d has a similar structure to the digital work protection system 10. Here the features of the digital work protection system 10d that differ from the digital work protection system 10 are described.

### 4.1.1 Key management Apparatus 100

The key management apparatus 100 of the digital work protection system 10d has a similar structure to that described in the first embodiment. Here the features of the key management apparatus 100 in the second embodiment that differ from the key management apparatus 100 in the first embodiment are described.

### (1) Tree Structure Storage Unit 102

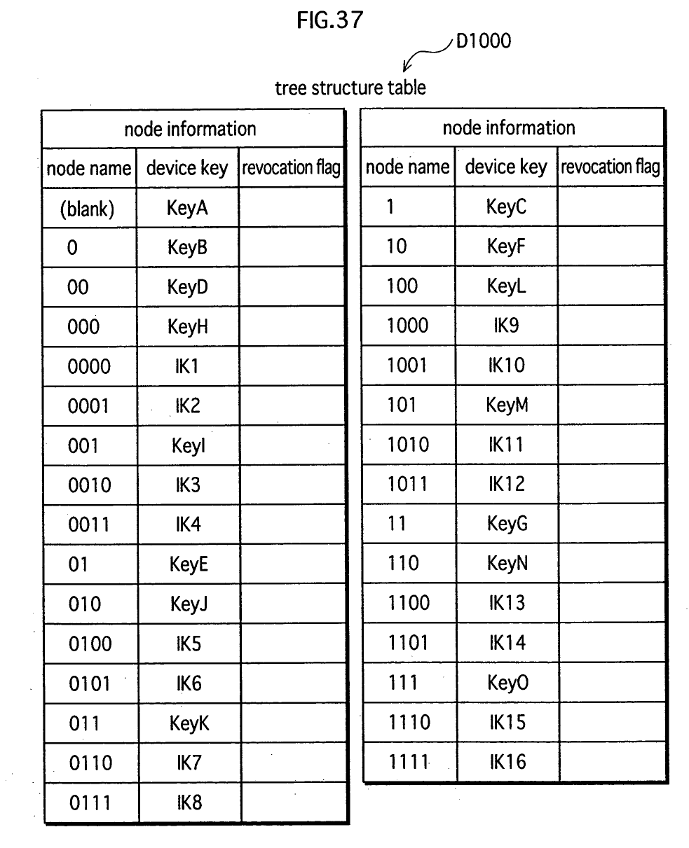

Specifically, the tree structure storage unit 102 is composed of a hard disk unit, and, as shown in FIG. 37, has a tree structure table D1000 shown in FIG. 37 as one example.

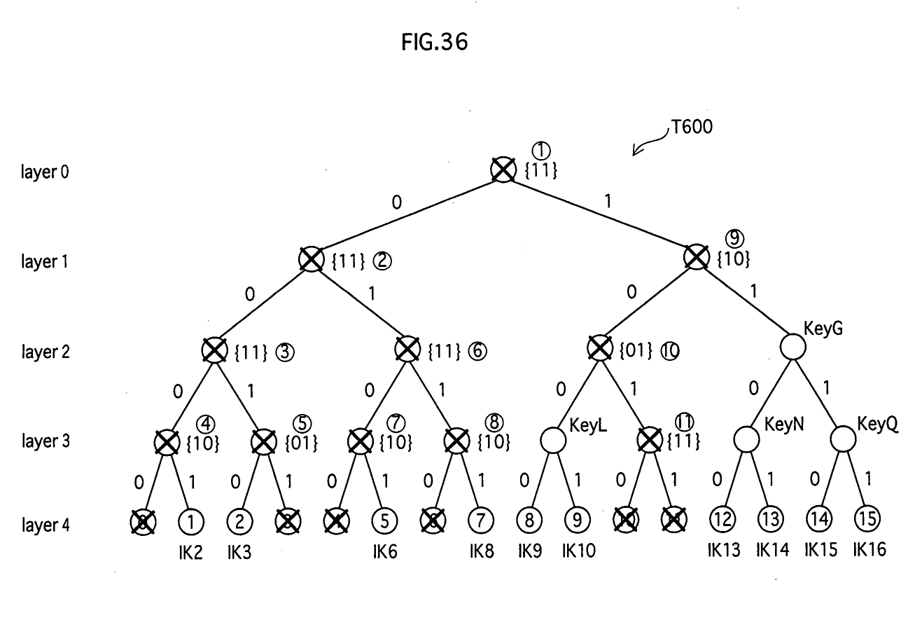

The tree structure table D1000 corresponds to a tree structure T600 shown in FIG. 36 as one example, and is a data structure for expressing the tree structure T600. As is described later, the data structure for expressing the tree structure T600 is generated by the tree structure construction unit 101 as the tree structure table D1000, and written to the tree structure storage unit 102.

### Tree Structure T600

The tree structure T600, as shown in FIG. 36, is a binary tree that has five layers: layer 0 through to layer 4.

The number of nodes included in each layer is the same as the tree structure T100. Furthermore, the numbers assigned to the paths from the node on the upper side through to the nodes on the lower side are the same as in the tree structure T100. Nodes marked with a cross (X) are revoked nodes.

The node name of the node that is the root of the tree structure T600 is blank. The node names of the other nodes are the same as in the tree structure T100.

Each node name is a four-digit expression. The node name of the node that is the root is four blanks. A node name “0” is specifically the character “0” +one blank+one blank+one blank. A node name “00” is the character “0” +the character “0” +one blank+one blank. A node name “101” is the character “1”+the character “0”+the character “1”+one blank. The node name “1111” is the character “1”+the character “1”+the character “1”+the character “1”. The other node names are formed similarly.

In the tree structure T600, “{10}” and the like near each node show NRPs. Furthermore, numbers in circles near each node show the order in which the NRPs are output.

### Tree Structure Table D1000

The tree structure table D1000 includes a number of pieces of node information equal to the number of nodes in the tree structure T1000. Each piece of node information corresponds to one of the nodes in the tree structure T1000.

Each piece of node information includes a device key and a revocation flag. Node names, device keys and revocation flags are the same as in the tree structure table D100, therefore a description thereof is omitted here.

Each piece of node information is stored in the tree structure table D1000 in an order shown by the following Order Rule 2. This Order Rule 2 is applied when node information is read sequentially from the tree structure table D1000 by the recording apparatuses 300a etc. and the reproduction apparatuses 400a etc.

(a) The piece of node information corresponding to the node that is the root is stored at the top of the tree structure table D1000.

(b) After a piece of node information corresponding to a particular node is stored in the tree structure table D1000, when the node has two subordinate nodes, the node information is arranged in the following manner. Pieces of node information that respectively correspond to each of the left node of the two subordinate nodes and all the further subordinate left nodes on the same path are stored. Then, pieces of node information that respectively correspond to the right node of the two subordinate nodes and all the further right nodes subordinate to the right node are stored.

(c) Within (b), (b) is re-applied.

Specifically, the pieces of node information in the tree structure table D1000 shown in FIG. 37 are stored in the following order:

blank (showing the root), “0”, “00”, “000”, “0000”, “0001”, “001”, “0010”, “0011”, “01”, “010”, . . . , “11”, “110”, “1100”, “1101”, “111”, “1110”, and “1111”.

### (2) Tree Structure Construction Unit 101

The tree structure construction unit 101, as described below, constructs an n-ary data structure for managing device keys, and stores the constructed tree structure in the tree structure storage unit 102. Here, n is an integer equal to or greater than 2. As an example, n=2.

Details of operations by the tree structure construction unit 101 for constructing the tree structure and storing the constructed tree structure to the tree structure storage unit 102 are described later.

The tree structure construction unit 101 generates a device key for each node in the tree structure with use of a random number, and writes each generated device key in correspondence with the respective node to the tree structure table.

### (3) Key Information Header Generation Unit 106

The key information header generation unit 106 generates a plurality of NRPs, and outputs the generated NRPs to the key information recording apparatus 200 as header information. Details of operations for generating the NRPs are described later.

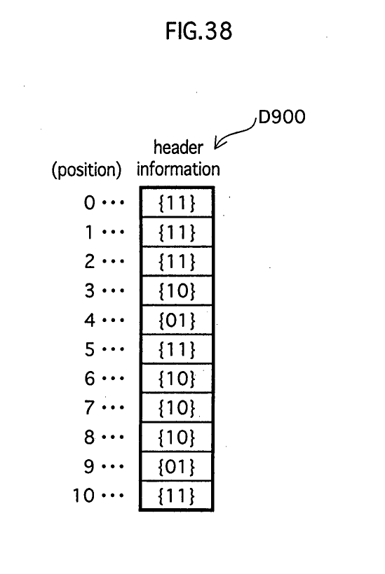

One example of the header information generated by the key information header generation unit 106 is shown in FIG. 38. Header information D900 shown in FIG. 38 is composed of NRPs {11}, {11}, {11}, {10}, {01}, {11}, {10}, {10}, {10}, {01}, {11}, which are included in the header information D900 is the stated order.

Note that the position in the header information D900 in which each of the node information patterns is positioned is set. As shown in FIG. 38, the NRPs {11}, {11}, {11}, {10}, {01}, {11}, {10}, {10}, {10}, {01}, {11} are arranged in positions defined by “0”, “1”, “2”, “3”, “4”, “5”, “6”, “7”, “8”, “9” and “10” respectively intheheader information D900.

### (4) Key Information Generation Unit 107

The key information generation unit 107 generates encrypted media keys by encrypting the media key using each device key that corresponds to a non-revoked node, in the same order that the pieces of node information are stored in the above-described tree structure table, and outputs the generated encrypted media keys as key information.

The following shows one example of the key information generated and then output by the key information generation unit 107.

The key information is composed of encrypted media keys E1(IK2, media key), E1(IK3, media key), E1(IK6, media key), E1(IK8, media key), E1(KeyL, media key) and E1(KeyG, media key), which are generated by encrypting the media key with use of device keys “IK2”, “IK3”, “IK6”, “IK8”, “KeyL” and “KeyG” respectively. The encrypted media keys E1(IK2, media key), E1(IK3, media key), E1(IK6, media key), E1(IK8, media key), E1(KeyL, media key) and E1(KeyG, media key) are arranged in the key information in positions defined by “0”, “1”, “2”, “3”, “4”, “5” and “6” respectively.

### 4.1.2 Recording Apparatus 300a

The recording apparatus 300a of the digital work protection system 10d has a similar structure to that described in the first embodiment. Here the features of the recording apparatus 300a in the second embodiment that differ from the first embodiment are described.

### (1) Specification Unit 303

The specification unit 303 specifies the position X in the key information of one encrypted media key by checking the pieces of header information sequentially from the top, with use of the read ID information and the read header information. Note that details of the operations for specifying the position X of the encrypted media key are described later.

### 4.2 Operations of the Digital Work Protection System 10d

The following description focuses on the features of the operations of the digital work protection system 10d that differ from the digital work protection system 10.

### 4.2.1 Operations for Constructing and Storing the Tree Structure

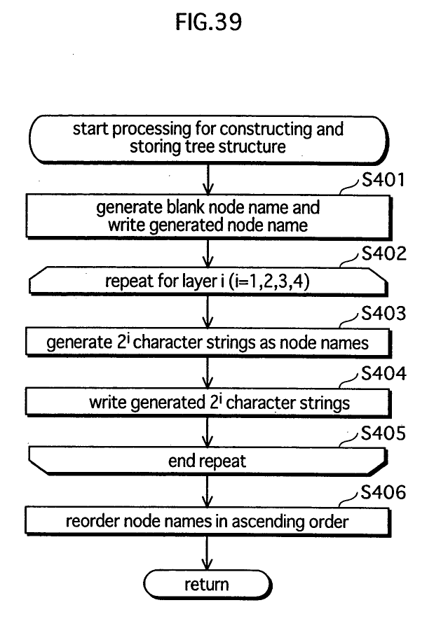

Here, the flowchart in FIG. 39 is used to describe operations by the tree structure construction unit 101 for generating the tree structure table and writing the tree structure table to the tree structure storage unit 102. Note that the operations described here are details of step S101 in the flowchart in the FIG. 10.

The tree structure construction unit 101 generates a piece of node information that includes a blank node name, and writes the generated piece of node information to the tree structure data table (step S401).

Next, the tree structure construction unit 101 repeats the following steps S403 to S404 for layer i (i=1, 2, 3, 4).

The tree structure construction unit 101 generates 2ⁱ character strings as a node names. Specifically, when i=1, the tree structure construction unit 101 generates 2¹=2 character strings “0” and “1”. When i=2, the tree structure construction unit 101 generates 2²=4 character strings “00”, “01”, “10” and “11”. When i=3, the tree structure construction unit 101 generates 2³=8 character strings “000”, “001”, “010”, . . . and “111”. When i=4, the tree structure construction unit 101 generates 2⁴=16 character strings “0000”, “0001”, “0010”, “0011” and “1111” (step S403). Next, the tree structure construction unit 101 writes pieces of node information, each of which includes one of the generated node names, to the tree structure table (step S404).

Next, the tree structure construction unit 101 rearranges the pieces of node information in the tree structure table in ascending order of node name, and overwrites pieces of node information in the tree structure table with the newly arranged pieces of node information (step S406).

In this way, a tree structure table is generated such as the example shown in FIG. 37. The generated tree structure table D1000 includes the pieces of node information in the above described Order Rule 2. Note that at this stage device keys have not yet been recorded in the tree structure table D1000.

### 4.2.2 Operations for Generating Header Information

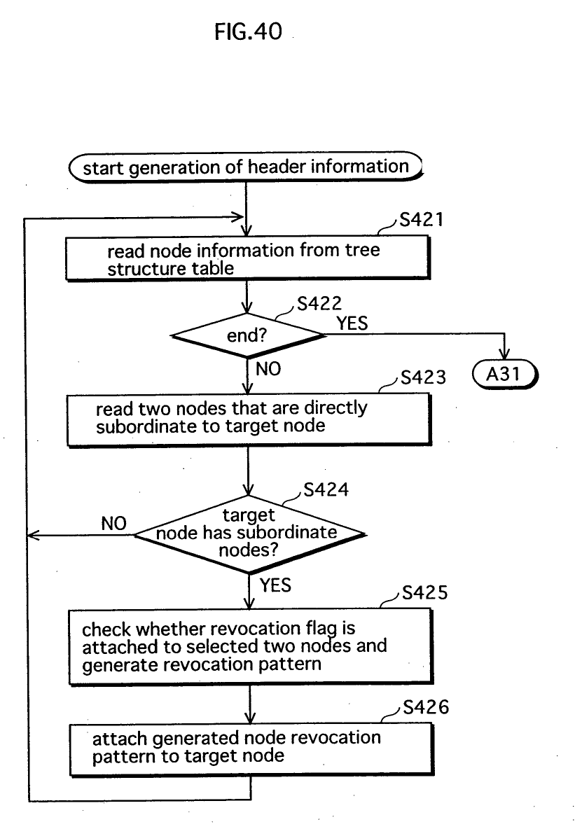

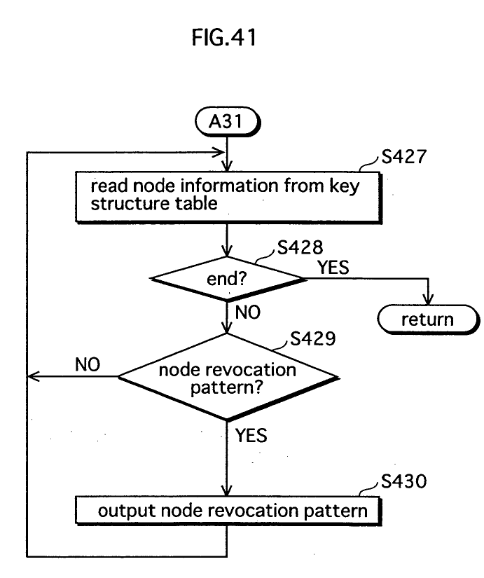

Here, the flowcharts in FIG. 40 and FIG. 41 are used to describe operations by the key information header generation unit 106 for generating header information. Note that the operations described here are the details of step S153 in the flowchart in FIG. 11.

The key information header generation unit 106 tries to read one piece of node information at a time from the tree structure table according to Order Rule 2 (step S421).

On detecting that it has finished reading all the pieces of node information (step S422), the key information header generation unit 106 proceeds to step S427.

When the key information header generation unit 106 does not detect that it has finished reading all the pieces of node information, but instead is able to read a piece of node information (step S422), the key information header generation unit 106 reads the two pieces of node information that correspond to the two subordinate nodes of the target node that corresponds to the read node information (step S423).

When the target node has subordinate nodes (step S424), the key information header generation unit 106 checks whether the read two pieces of node information corresponding to the two subordinate nodes have revocation flags attached thereto, and generates an NRP (step S425). Then, the key information header generation unit 106 adds the generated NRP to the read piece of node information corresponding to the target node (step S426), and returns to step S421 to repeat the processing.

When the target node does not have lower nodes (step S424), the key information header generation unit 106 returns to steps S421 to repeat the processing.

Next, the key information header generation unit 106 tries to read the pieces of node information from the tree structure table in order according to the Order Rule 2 (step S427).

On detecting that it has finished reading all the pieces of node information (step S422), the key information header generation unit 106 ends the processing.

When the key information header generation unit 106 does not detect that it has finished reading all the pieces of node information, but instead is able to read a piece of node information (step S428), the key information header generation unit 106 checks whether the read piece of node information has an NRP attached thereto, and if so (step S429), outputs the attached NRP (step S430). The key information header generation unit 106 then returns to step S427 to repeat the processing.

When the read piece of node information does not have an NRP attached thereto (step S429), the key information header generation unit 106 returns to step S427 to repeat the processing.

### 4.2.3 Operations for Specifying Key Information

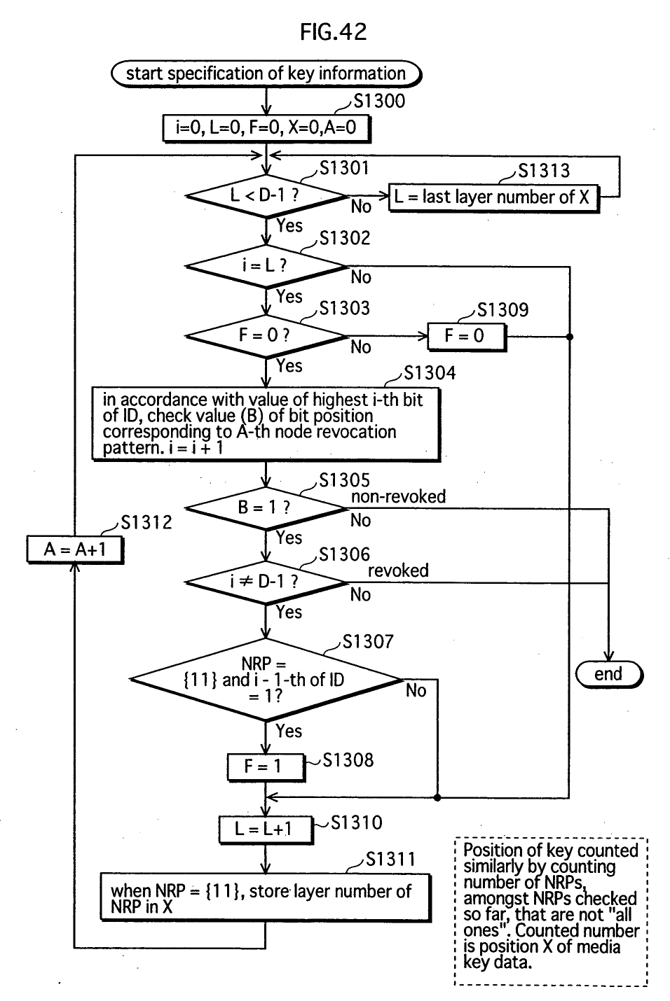

Here, the flowchart in FIG. 42 is used to describe operations by the specification unit 303 of the recording apparatus 300a for specifying an encrypted media key from the key information stored in the recording medium 500b. Note that the operations described here are the details of step S172 in the flowchart in FIG. 11.

Note also that operations performed by the specification unit 402 of the reproduction apparatus 400a are the same as those of the specification unit 303, and therefore a description thereof is omitted.

The specification unit 303 has a variable i, a variable L, a variable X, a flag F, a value D, and a pointer A. The variable i shows the bit position of ID information to be checked. The variable L shows the layer in which NRP currently being checked is included. The variable X stores the layer of the node at the point where paths diverge. The flag F (initial value F=0) is for judging whether to check an NRP. The value D shows the number of layers in the tree structure. The pointer A shows the position of the NRP to be checked.

The specification unit 303 sets variable i=0, variable L=0, flag F=0, variable X=0 and pointer A=0 (step S1300).

Next, the specification unit 303 judges whether the variable L is less than the number of layers D−1. When the variable L is greater than or equal to the number of layers D−1 (step S1301), the specification unit 303 inputs the last layer number of the variable X to the variable L. The variable X is a last-in first-out variable, and a value output therefrom is deleted. In other words, if layer 0, layer 2 and layer 3 are input to the variable X in order, layer 3 is output first and then deleted, and then layer 2 is output (step S1313). The specification unit 303 then returns to step S1301 to repeat the processing.

When the variable L is less than the number of layers D−1 (step S1301), the specification unit 303 judges whether variable i=variable L. When the variable i is not equal to the variable L (step S1302), the specification unit 303 proceeds to step S1310.

When variable i=variable L (step S1302), the specification unit 303 judges whether flag F=0. When the flag F is not equal to 0 (step S1303), the specification unit 303 sets the flag F to 0 (step S1309), and proceeds to step S1310.

When flag F=0 (step S1303), the specification unit 303 checks the value B of the bit position corresponding to the A-th NRP, according to the value of the top i-th bit of the ID information, and sets variable i=i+1 (step S1304).

Next, the specification unit 303 checks whether value B=1, and if not (step S1305), judges that the apparatus to which the ID information is assigned is not revoked, and ends the processing.

When value B=1 (step S1305), the specification unit 303 judges whether variable i≠D−1, and if the variable i is equal to 1 (step S1306), judges that the apparatus to which the ID information is assigned is revoked, and ends the processing.

Next, when variable i≠D−1 (step S1306), the specification unit 303 judges whether the NRP is {11} and the i−1-th value of the ID information is “1”. When the judgment is negative (step S1307), the specification unit 303 proceeds to step S1310.

When the judgment is positive (step S1307), the specification unit 303 sets flag F=1 (step S1308), sets L=L+1 (step S1310), and if the NRP is {11}, the specification unit 303 stores the layer number of the NRP in the variable X (step S1311). Then the specification unit 303 sets A=A+1 (step S1312), and returns to step S1310.

### 5. Fifth Embodiment

In the fourth embodiment, NRPs are arranged according to Order Rule 2.

In the fifth embodiment described hereinafter a digital work protection system 10e (not illustrated) arranges and outputs NRPs according to the Order Rule 2 in the same manner as in the digital work protection system 10d in the fourth embodiment, while reducing the amount of data of the header information in the same manner as in the digital work protection system 10b described in the second embodiment when revoked apparatuses occur one-sidedly around a particular leaf.

### 5.1 Structure of the Digital Work Protection System

The digital work protection system 10e has a similar structure to the digital work protection system 10d. Here, the features of the digital work protection system 10e that differ from the digital work protection system 10d are described.

### 5.1.1 Key Management Apparatus 100

The key management apparatus 100 of the digital work protection system 10e has a similar structure to the key management apparatus 100d described in the fourth embodiment. Here the features of the key management apparatus 100 that differ from the key management apparatus 100d are described.

### (1) Tree Structure Storage Unit 102

The tree structure storage unit 102 has a tree structure table. The tree structure table in the tree structure storage unit 102 has the same structure as the tree structure table D1000 described in the fourth embodiment, with each piece of node information included in the tree structure table additionally including an NRP.

### (2) Key Information Header Generation Unit 106

The key information header generation unit 106 generates a plurality of NRPS, and outputs the generated NRPs to the key information recording apparatus 200 as header information. Each NRP is composed of three bits as described in the second embodiment.

Details of operations for generating NRPs are described later.

### 5.1.2 Recording Apparatus 300a

The recording apparatus 300a of the digital work protection system 10e has a similar structure to the recording apparatus 300a described in the fourth embodiment. Here the features of recording apparatus 300a that differ from the recording apparatus 300a described in the fourth embodiment are described.

### (1) Specification Unit 303

The specification unit 303 specifies the position X of one encrypted media key by checking the pieces of header information sequentially from the top, with use of ID information and header information. Note that details of the operations for specifying the position X of the encrypted media key are described later.

### 5.2 Operations of the Digital Work Protection System 10e

The following description focuses on the features of the operations of the digital work protection system 10e that differ from the digital work protection system 10d.

### 5.2.1 Operations for Generating Header Information

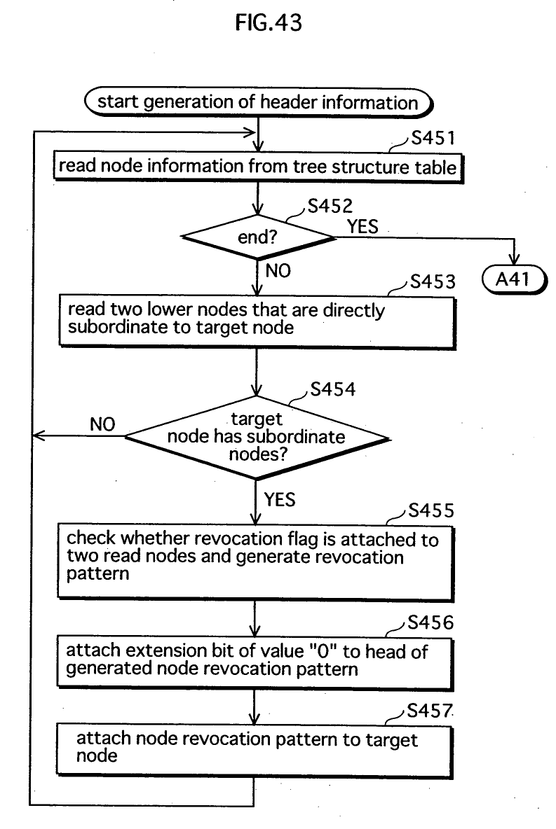

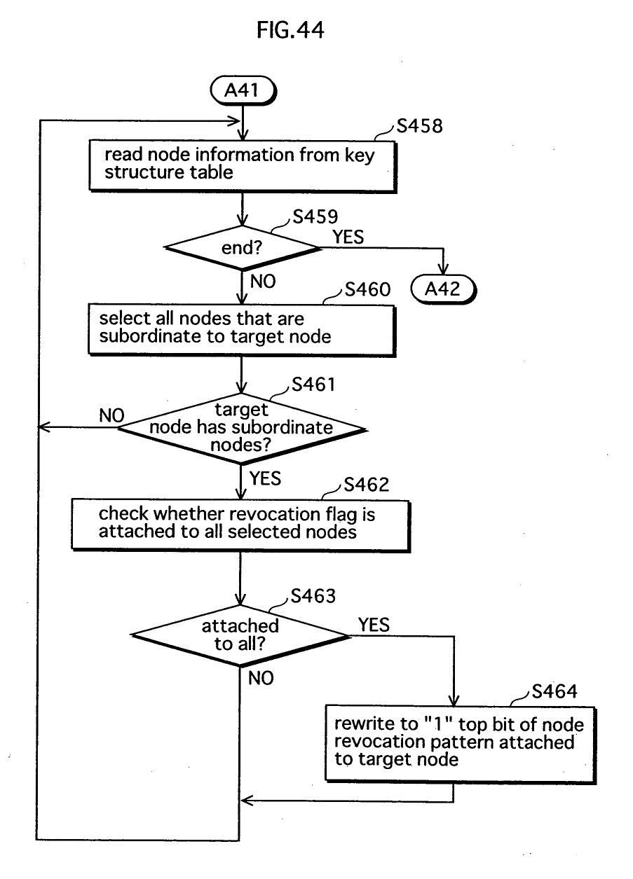

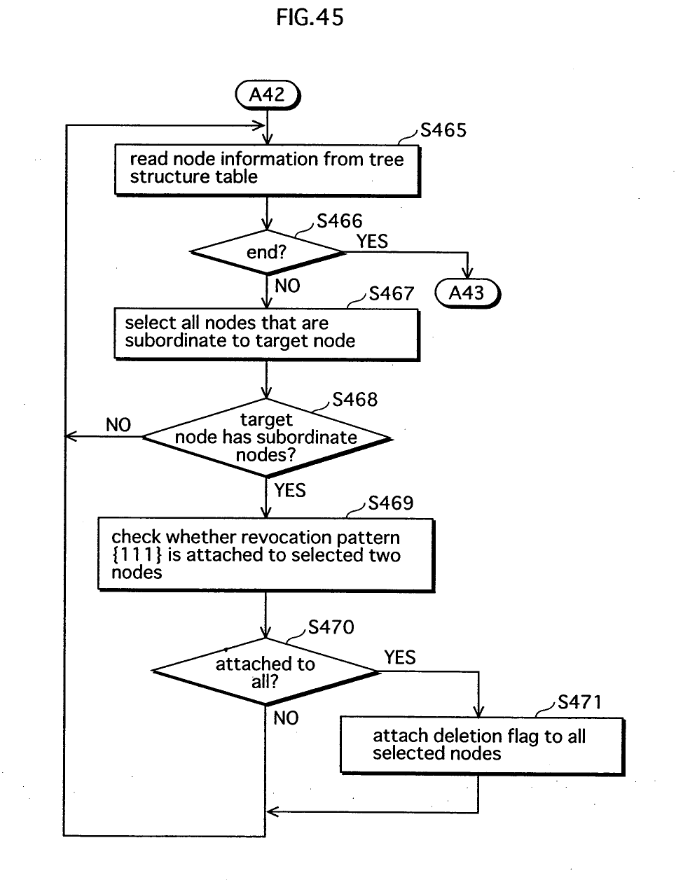

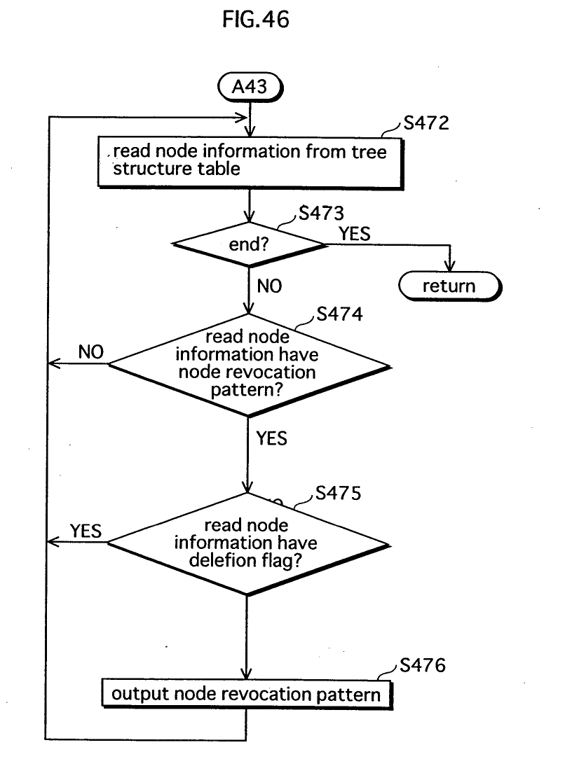

Here, the flowcharts in FIG. 43 to FIG. 46 are used to describe operations by the key information header generation unit 106 for generating header information. Note that the operations described here are the details of step S153 in the flowchart in FIG. 11.

The key information header generation unit 106 tries to read one piece of node information at a time from the tree structure table according to Order Rule 2 (step S451).

On detecting that it has finished reading all the pieces of node information (step S452), the key information header generation unit 106 proceeds to step S458.

When the key information header generation unit 106 does not detect that it has finished reading all the pieces of node information, but instead is able to read a piece of node information (step S452), the key information header generation unit 106 reads the two pieces of node information that correspond to the two directly subordinate nodes of the target node that corresponds to the read node information (step S453).

When the target node has subordinate nodes (step S454), the key information header generation unit 106 checks whether the read two pieces of node information corresponding to the two subordinate nodes have revocation flags attached thereto, generates an NRP (step S455), and attaches an extension bit of the value “0” to the head of the generated NRP (step S456). Then, the key information header generation unit 106 adds the NRP that has the extension bit attached thereto to the piece of node information corresponding to the target node (step S457), and returns to step S451 to repeat the processing.

When the target node does not have subordinate nodes (step S454), the key information header generation unit 106 returns to steps S451 to repeat the processing.

Next, the key information header generation unit 106 tries to read the pieces of node information from the tree structure table in order according to Order Rule 2 (step S458).

On detecting that it has finished reading the pieces of node information (step S459), the key information header generation unit 106 proceeds to step S465.

When the key information header generation unit 106 does not detect that it has finished reading the pieces of node information, but instead is able to read a piece of node information (step S459), the key information header generation unit 106 reads all the pieces of node information corresponding to all directly subordinate nodes of the read piece of node information (step S460).

When the target node has subordinate nodes (step S461), the key information header generation unit 106 checks whether all the read pieces of node information corresponding to all the subordinate nodes have revocation flags attached thereto (step S462), and only when all the subordinate nodes have revocation flags attached thereto (step S463), the key information header generation unit 106 rewrites the top bit of the NRP attached to the piece of node information corresponding to the target node with “1” (step S464).

Next, the key information header generation unit 106 returns to step S458 to repeat the processing.

When the target node does not have subordinate nodes (step S461), the key information header generation unit 106 returns to step S458 to repeat the processing.

Next, the key information header generation unit 106 tries to read one piece of node information at a time from the tree structure table according to Order Rule 2 (step S465).

On detecting that it has finished reading all the pieces of node information (step S466), the key information header generation unit 106 proceeds to step S472.

When the key information header generation unit 106 does not detect that it has finished reading all the pieces of node information, but instead is able to read a piece of node information (step S466), the key information header generation unit 106 reads all the pieces of node information that correspond to all the subordinate nodes of the target node that corresponds to the read piece of node information (step S467).

When the target node has subordinate nodes (step S468), the key information header generation unit 106 checks whether all the read pieces of node information corresponding to all the subordinate nodes have NRPs {111} attached thereto (step S469), and only when all the read pieces of node information have NRPs {111} attached thereto (step S470), the key information header generation unit 106 attaches a deletion flag to each of the pieces of node information (step S471).

Next, the key information header generation unit 106 returns to step S465 to repeat the processing.

When the target node does not have subordinate nodes (step S468), the key information header generation unit 106 returns to step S465 to repeat the processing.

Next, the key information header generation unit 106 tries to read the pieces of node information one at a time from the tree structure table according to Order Rule 2 (step S472).

On detecting that it has finished reading the pieces of node information (step S473), the key information header generation unit 106 ends the processing.

When the key information header generation unit 106 does not detect that it has finished reading the pieces of node information, but instead is able to read a piece of node information (step S473), the key information header generation unit 106 checks whether the read piece of node information has an NRP attached thereto, and if so (step S474), checks whether a deletion flag is attached to the read piece of node information. When a deletion flag is not attached thereto (step S475), the key information header generation unit 106 outputs the attached NRP (step S476). The key information header generation unit 106 then returns to step S472 to repeat the processing.

When the read piece of node information does not have an NRP attached thereto (step S474), or when the read piece of node information has a deletion flag attached thereto (step S475), the key information header generation unit 106 returns to step S472 to repeat the processing.

### 5.2.2 Operations for Specifying Key Information

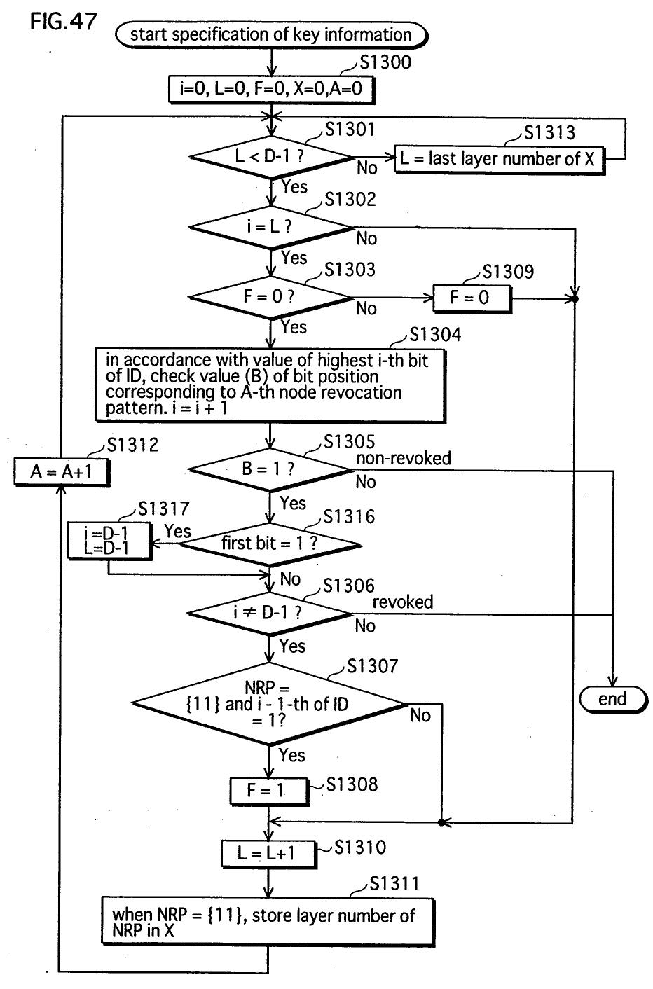

Here, the flowchart in FIG. 47 is used to describe operations by the specification unit 303 of the recording apparatus 300a for specifying an encrypted media key from key information stored in the recording medium 500b. Note that the operations described here are the details of step S172 in the flowchart in FIG. 11.

Note also that operations performed by the specification unit 402 of the reproduction apparatus 400a are the same as those by the specification unit 303, and therefore a description thereof is omitted.

Here, the features that differ from the flowchart shown in FIG. 42 are described.

Similar to the fourth embodiment, the specification unit 303 has a variable i, a variable L, a variable X, a flag F, a value D, and a pointer A. The variable i shows the bit position of ID information to be checked. The variable L shows the layer in which NRP currently being checked is included. The variable X stores the layer of the node where the paths branch out. The flag F (initial value F=0) is for judging whether to check an NRP. The value D shows the number of layers in the tree structure. The pointer A shows the position of the NRP to be checked.

When value B=1 (step S1305), only when the highest bit of the NRP is “1” (step S1316), the specification unit 303 sets variable i=D−1 and sets variable L=D−1 (step S1317).

Furthermore, when both the NRP is {11} and the highest bit of the NRP is not “1”, the specification unit 303 stores the layer number of the NRP in the variable X (step S1311).

### 6. Other Modifications

Note that although the present embodiment has been described based on the above embodiments, the present invention is not limited thereto. Cases such as the following are also included in the present invention.

(1) The present invention is not limited to using the conventional method of revocation described in the embodiments. Any method of assigning device keys to the nodes and assigning the device keys to recording apparatuses and/or reproduction apparatuses is possible providing the following conditions are fulfilled: the key management apparatus maintains a tree structure, recording apparatuses and/or reproduction apparatuses are assigned to the leaves of the tree structure, device keys associated with the nodes are assigned to the recording apparatuses and/or reproduction apparatuses, and the key management apparatus performs revocation of device keys with use of the tree structure, and generates key information.

(2) The tree structure is not limited to being the binary tree described in the embodiments. Generally, the present invention may be realized by an n-ary tree. In this case the ID information is set by assigning 0 to n−1 to the n paths derived from and below a node, and, as described in the embodiments, joining values assigned to the paths from the leaves through to the root in order from the top.

(3) An example of recordable media such as a DVD-RAM is used in the above-described embodiments, however the present invention can be realized in a similar manner for pre-recorded media such as a DVD-Video.

The following describes a digital work protection system 10f for pre-recorded media.

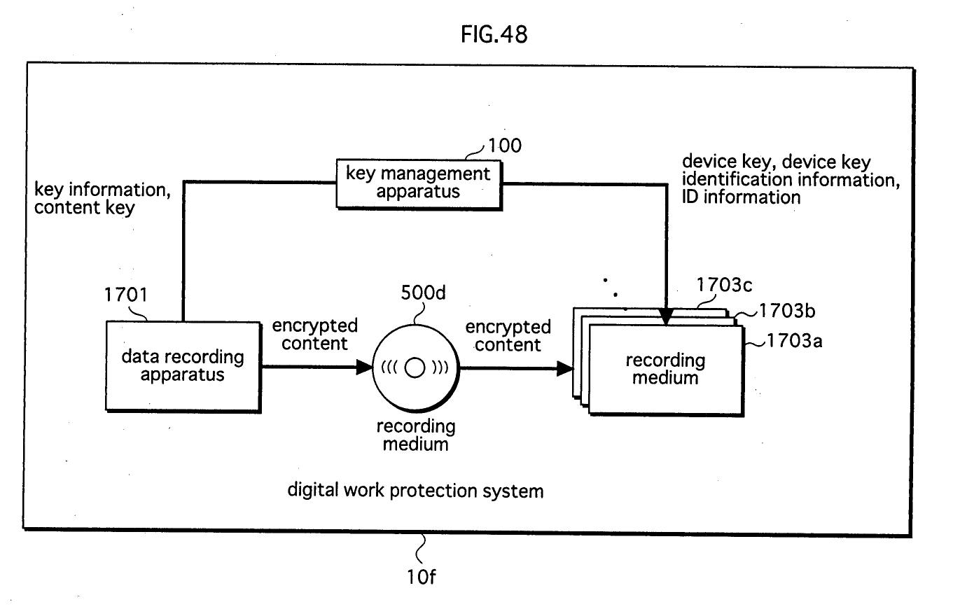

The digital work protection system 10f, as shown in FIG. 48, is composed of a key management apparatus 100, a data recording apparatus 1701, and data reproduction apparatuses 1703a, 1703b, 1703c, etc (hereinafter referred to as “recording apparatuses 1703a, etc.”).

As described is the embodiments, the key management apparatus 100 outputs key information to which header information is attached, and a content key to the data recording apparatus 1701, and outputs a plurality of device keys, identification information about each device key, and ID information to the data reproduction apparatuses 1703a, etc.

A recording medium 500a, which is a pre-recorded medium, is loaded into the data recording apparatus 1701. The data recording apparatus 1701 receives the key information and the media key from the key management apparatus 100, encrypts content using the media key, to generate encrypted content, and writes the generated encrypted content and the received key information to the recording medium 500a. In this way, a recording medium 500d on which encrypted content, and key information are written, is produced.

The recording medium 500d is circulated on the market, and a user acquires the recording medium 500d. The user loads the recording medium 500d into the data reproduction apparatus 1703a.

The data reproduction apparatus 1703a has received a plurality of device keys, identification information about the device keys, and ID information from the key management apparatus 100 in advance. When the recording medium 500d is loaded into the data reproduction apparatus 1703a, the data reproduction apparatus 1703a reads the key information and the encrypted content from the recording medium 500d, specifies the encrypted media key from the key information, decrypts the specified encrypted media key with use of the device key, and decrypts the encrypted content with use of the obtained media key, to generate content.

The same kind of operations as the key management apparatus 100 shown in the embodiments can be used to control the size of the header information that is recorded on the recording medium, and for the data reproduction apparatuses to specify efficiently the encrypted media key to be decrypted.

(4) The present invention is not limited to being applied to copyright protection of digital content as described in the embodiments, but may be used, for example, for the purpose of conditional access in a membership-based information provision system for providing information to members other than a particular member or members.

(5) In the embodiments an example is described of key information and encrypted content being distributed with use of a recording medium, but instead of the recording medium, a communication medium, of which the Internet is representative, may be used.

(6) The key management apparatus and the key information recording apparatus may be integrated into one apparatus.

(7) The present invention is not limited to the method of assigning device keys described in the embodiment in which a device key is assigned to each node in the n-ary tree in advance, and all the device keys on a path from a leaf to the root are assigned to the user apparatus that corresponds to the leaf.

If is possible to assign a device key in advance, not to all the nodes in the n-ary tree, but to some nodes.

Furthermore, it is possible to assign not all the device keys on the path from the leaf to the root but some of the device keys on the path, to the user apparatus that corresponds to the leaf.

(8) Taking for example the tree structure in FIG. 4, assume that in an initial state in which the device key has not been leaked, an encrypted media key is generated by encrypting the media key with use of the device key A.

Assume now that one of the user apparatuses 1 to 16 is hacked illegally by a third party, the device key A is exposed, and a clone device is manufactured that has the device key A only. Since the clone device has only the device key A, it is not possible to specify which of the user apparatuses 1 to 16 has been hacked. Furthermore, since the clone device has the device key A, it is able to obtain the correct media key.

In this situation it is necessary to revoke only the device key A and to encrypt the media key using a device key that can cover all the devices, in other words that is common to all devices. The reason here for using a device key that covers all the devices is that it is not possible to judge which of the devices has been hacked.

To deal with this, the media key is encrypted respectively with use of device key B and device key C, to generate two encrypted device keys.

Next, if key B is exposed, device key B is revoked, and the media key is encrypted respectively with use of device key C, device key D, and device key E, to generate three encrypted media keys.

If this is repeated a number of times equal to the number of layers in the tree, it will be possible in the end to specify which device has been hacked.

In order to deal with the described situation, an NRP {100} is attached to the node corresponding to device key A when only device key A is revoked. In the case of the tree structure in FIG. 4, the NRP {100} is attached to the root.

The head bit “1” of the NRP {100} shows that the node is revoked, and the bit string “00” after the head bit “1” shows that the two directly subordinate nodes of the node are not revoked.

In other words, in the case of the tree structure in FIG. 4, if the NRP {100} is attached to the root, this means that there are two encrypted media keys that have been generated by encrypting the media key with use of device key B and device key C respectively. In this way, it can be said that the head bit “1” of the NRP means that there are two encrypted media keys below the node.

On the other hand, as described in the second embodiment, when the NRP is {111}, the head bit “1” shows that there are no NRPs below the node.

The following describes this in more detail.

### Key Management Apparatus 100

Here it is assumed that the key management apparatus 100 generates the tree structure T100 shown in FIG. 4, and assigns a device key to each node, and a user apparatus to each leaf, as shown in FIG. 4.

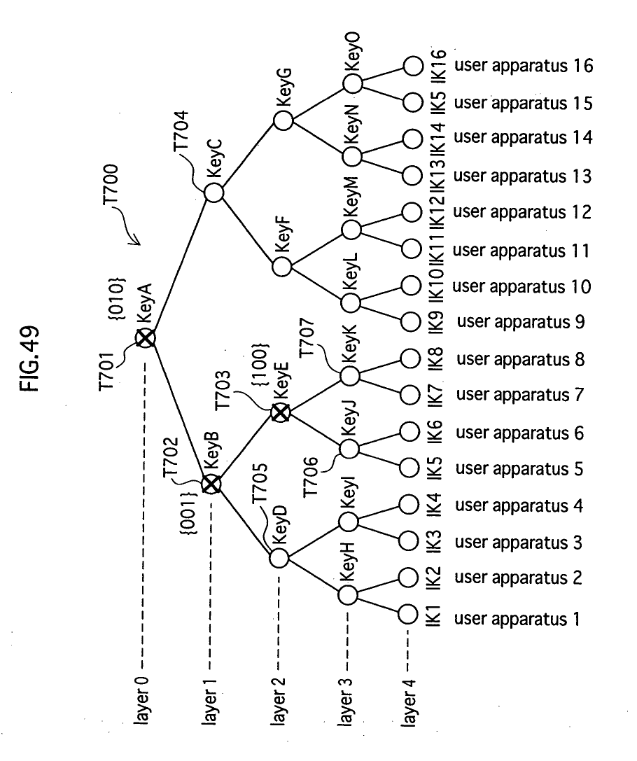

After this, as shown in FIG. 49, device keys KeyA, KeyB and KeyE assigned to nodes T701, T702 and T703 respectively are leaked as described earlier. The key management apparatus 100 revokes the device keys KeyA, KeyB and KeyE, generates header information and key information, and writes the generated header information and key information to the recording medium via the key information recording apparatus 200.

### (a) Revocation of Device Keys KeyA, KeyB and KeyE

The key management apparatus attaches revocation flags “1” to the pieces of node information that respectively include the device keys KeyA, KeyB and KeyE.

### (b) Generation of Header Information

The key management apparatus 100 generates, with use of the tree structure table that includes node information to which a revocation flag is attached, an NRP {010} to attach to the root T701, and writes the generated NRP {010} to the recording medium via the key information recording apparatus 200 as part of the header information. Here, the head bit “0” of the NRP shows that one of the directly subordinate nodes of the root T701 is revoked and the other subordinate nodes is not revoked. Furthermore, as described in the embodiment, the lower two bits “10” show that of the two directly subordinate nodes of the root T701, the left node T702 is revoked and the right node T704 is not revoked.

Next, the key management apparatus 100 generates an NRP {001} to attach to the node T702, and writes the generated NRP {001} to the recording medium via the key information recording apparatus 200 as part of the header information. Here, the head bit “0” of the NRP shows that one of the directly subordinate nodes of the node T702 is revoked and the other directly subordinate nodes is not revoked. Furthermore, as described in the embodiment, the lower two bits “01” show that of the two directly subordinate nodes of the root T702, the left node T705 is not revoked and the right node T703 is revoked.

Next, the key management apparatus 100 generates an NRP {100} to attach to the node T703, and writes the generated NRP {100} to the recording medium via the key information recording apparatus 200 as part of the header information. The NRP {100}, as described above, shows that neither of the two directly subordinate nodes T706 and T707 of the node T703 are revoked, and that the nodes T706 and T707 have respective encrypted media keys.

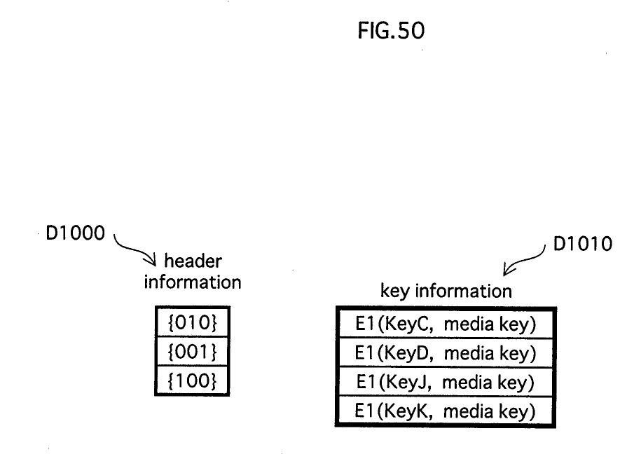

In this way the header information D100 shown in FIG. 50 is written to the recording medium. As shown in FIG. 50, the header information D1000 is composed of NRPs {010}, {001} and {100} in the stated order.

### (c) Generation of Key Information

Next, the key management apparatus 100 encrypts the media key with use of some of the non-revoked device keys, to generate encrypted media keys, and writes key information that includes the generated encrypted media keys, and header information that includes NRPs to the recording medium via the key information recording apparatus 200. The key information is generated in the following way.

First, the key management apparatus 100 encrypts the media key with use of the device key assigned to the node on the highest layer, to generate an encrypted media key. Here, as shown in FIG. 49, the device key on the highest layer amongst the non-revoked device keys is the device key KeyC assigned to the node T704. Therefore, the key management apparatus 100 encrypts the media key with use of the device key KeyC, to generate an encrypted media key E1(KeyC, media key), and writes the generated encrypted media key E1(KeyC, media key) the recording medium via the key information recording apparatus 200.

Next, the key management apparatus 100 encrypts the media key with use of the device key assigned to the node on the highest layer excluding the node T704 to which the device key KeyC is assigned and all the subordinate nodes of the node T704, to generate an encrypted media key. Here, since the applicable node is the node T705, the key management apparatus 100 encrypts the media key with use of the device key KeyD assigned to the node T705, to generate an encrypted media key E1(KeyD, media key), and writes the generated encrypted media key E1(KeyD, media key) the recording medium via the key information recording apparatus 200.

Next, the key management apparatus 100 encrypts the media key with use of the device key assigned to the node on the highest layer excluding the node T704 to which the device key KeyC is assigned and the node T705 to which the device key KeyD and all the respective subordinate nodes of the nodes T704 and T705, to generate an encrypted media key. Here, since the applicable node is the node T706, the key management apparatus 100 encrypts the media key with use of the device key KeyJ assigned to the node T706, to generate an encrypted media key E1(KeyJ, media key), and writes the generated encrypted media key E1(KeyJ, media key) the recording medium via the key information recording apparatus 200.

Next, the key management apparatus 100 encrypts the media key in the same way as above with use of the device key K, to generate to generate an encrypted media key E1(KeyK, media key), and writes the generated encrypted media key E1(KeyK, media key) the recording medium via the key information recording apparatus 200.

In this way key information D1010 shown in FIG. 50 is written to the recording medium. As shown in FIG. 50, the key information D1010 is composed of the encrypted media keys E1(KeyC, media key), E1(KeyD, media key), E1(KeyJ, media key) and E1(KeyK, media key) in the stated order.

### Recording Apparatus 300a

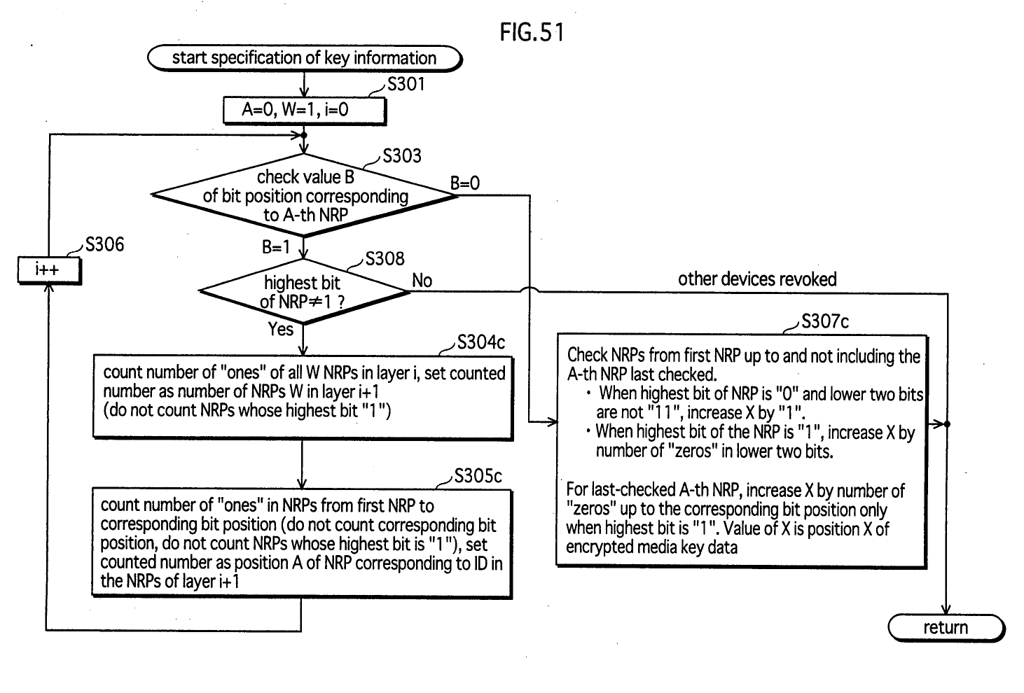

The flowchart in FIG. 51 is used to described operations by the specification unit 303 of the recording apparatus 300a for specifying one encrypted media key from the header information and the key information stored on the recording medium as described above.

The specification unit 303 unit has a variable X showing the position of the encrypted media key, a variable A showing the position of the NRP relating to the user apparatus itself, a variable W showing the number of NRPs in a particular layer, and a variable i showing the number of the layer that is the target of processing.

The specification unit 303 sets variable A=0, variable W=1, and variable i=0 as initial values (step S301).

Next the specification unit 303 checks whether a value B that is in the bit position corresponding to the value of the highest i-th bit of the ID information is “0” or “1” (step S303). Here, as described in the embodiments the corresponding bit pattern is ID information composed based on a rule that the “0” is assigned to left paths in the tree structure and “1” is assigned to right paths. Therefore, a value “0” of the top i-th bit of the ID information corresponds to the left bit of two lower bits of the A-th NRP, and a value “1” of the top i-th bit corresponds to the right bit of two lower bits of the A-th NRP.

Next, when value B=0 (step S303), the specification unit 303 checks the each NRP from the head NRP to the NRP last checked, in the following way. Note that the A-th NRP is not included.

(a) When the highest bit of the NRP is “0” and the lower two bits are not “11”, the specification unit 303 adds “1” to the variable X.

(b) When the highest bit of the NRP is “1”, the specification unit 303 adds the number of “0” included in the lower two bits to the variable X.

For the A-th NRP that was checked last, the specification unit 303 adds the number of “0” up to the corresponding bit to the variable X only when the highest bit of the NRP is “1”. Here, corresponding bit itself is not included. The variable X obtained in this way shows the position of the encrypted media key. Furthermore, the variable i at this point is the device identification information for identifying the device key (step S307c). The specification unit 303 then ends the processing.

On the other hand, when value B=1 (step S303), the specification unit 303 further judges whether the highest bit of the NRP is “1”, and if so (step S308), ends the processing because the user apparatus is revoked.

When the highest bit of the NRP is not “1” (step S308), the specification unit 303 counts the number of “ones” included in the lower bits of all the W NRPs in the layer i, and sets the counted value in the variable W. Note that NRPs whose highest bit is “1” are not counted. The variable W obtained in this way shows the number of NRPs in the next layer i+1 (step S304c).

Next, the specification unit 303 counts the number of “ones” included in the lower two bits of each NRP from the first NRP in layer i up to the corresponding bit position, and sets the counted value in the variable A. Here the corresponding bit position is not counted. Furthermore, NRPs whose highest bit is “1” are not counted. The variable A obtained in this way shows the position amongst the NRPs in the next layer i+1 of the NRP relating to the user apparatus itself (step S305c).

Next, the specification unit 303 calculates variable i=i+1 (step S306), moves to step S303, and repeats the above-described processing.

In this way the key management apparatus is able to write header information and key information to the recording apparatus and the reproduction apparatus is able to specify an encrypted media key, not only in cases in which device keys on a path from a leaf of the to the root in the tree structure are revoked, but also in cases in which device keys assigned to some nodes in the tree structure are revoked.

(9) Taking for example the tree structure in FIG. 4, assume that the tree is in an initial stage in which none of the device keys has been leaked and none of the nodes in the tree structure has been revoked.

In this case, the key management apparatus encrypts the media key with use of the device key KeyA that is in correspondence with the root, to generate an encrypted media key. Next, the key management apparatus generates one special NRP {00} that shows that there are no revoked nodes in the tree structure and that all the nodes are valid (i.e., not revoked). Then the key management apparatus writes the generated encrypted media key and the generated NRP {00} via the key information recording apparatus to the recording medium.

Furthermore, in this case, when the reproduction apparatus reads the NRP from the recording medium, and judges that the only read NRP is {00} and that there are no other NRPs recorded on the recording medium, the reproduction apparatus judges that there are no revoked nodes in the tree structure. Then the reproduction apparatus reads the encrypted media key recorded on the recording medium, and decrypts the read encrypted medium key with use of the device key KeyA that is the device key amongst those stored by the reproduction apparatus that is in correspondence with the root, to generate the media key.

The recording apparatus also operates in the same manner as the reproduction apparatus in this case.

### 7. Sixth Embodiment

The following describes a content distribution system 2000 as another embodiment of the present invention.

### 7.1 Structure of the Content Distribution System 2000

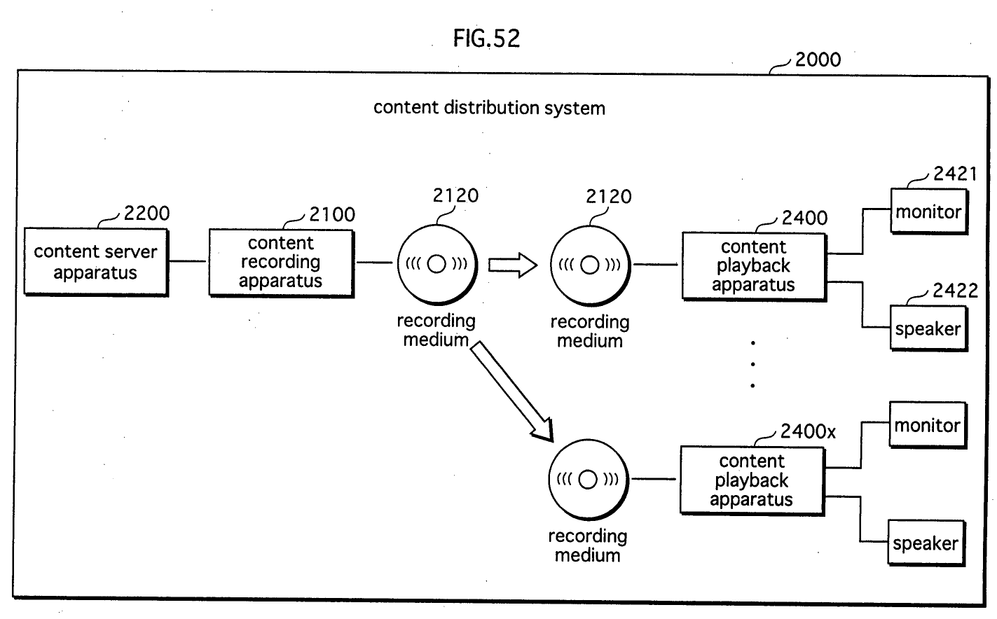

The content distribution system 2000, as shown in FIG. 52, is composed of a content server apparatus 2200, a content recording apparatus 2100, and content playback apparatuses 2400 to 2400x. Here, the total number of content playback apparatuses is n.

The content server apparatus 2200 and the content recording apparatus 2100 are held by a content provider, and are connected to each other by a LAN. The content server apparatus 2200 stores contents which are digital works such movies and music. The content recording apparatus 2100 obtains content and a content key from the content server apparatus 2200, encrypts the media key based on n device keys to obtain n encrypted media keys, generates S encryption keys based on the media key and S region codes, encrypts the content key using the generated S encryption keys to generate S encrypted content keys, encrypts the content using the content key to generate encrypted content, and writes the n encrypted media keys, the S encrypted content keys, and the encrypted content to the recording medium 2120.

The recording medium 2120 is put on sale, and obtained by a user who purchases the recording medium 2120.

The content playback apparatus 2400 is held by the user, who mounts the recording medium 2120 therein. Next, according to an instruction from the user, the content playback apparatus 2400 selects and reads one encrypted media key from the recording medium 2120, reads the S encrypted content keys and the encrypted content, decrypts the encrypted media key with use of the device key to generate a media key, generates a decryption key based on the generated media key and an internally-stored region code, decrypts the S encrypted content keys using the generated decryption key to generate S content keys, selects one correct content key from among the generated S content keys, and decrypts the encrypted content with use of the selected correct content key to generate content. Next, the content playback apparatus 2400 generates a video signal and an audio signal from the generated content, and outputs the generated audio signal and video signal to a monitor 2421 and a speaker 2422 that are connected to the content playback apparatus 2400.

The other content playback apparatuses operate in the same manner as the content playback apparatus 2400.

### 7.2 Structure of the Content Server Apparatus Content Server Apparatus 2200

The content server apparatus 2200 is a computer system composed of a microprocessor, a ROM, a RAM, a hard disk unit, a display unit, a communication unit, keyboard, a mouse, and so on. A computer program is stored in the RAM or the hard disk unit. The content server apparatus 2200 achieves its functions by the microprocessor operating according to the computer program.

The communication unit is connected to the content recording apparatus 2100 via a LAN, and receives and transmits information to and from the content recording apparatus 2100.

The hard disk unit stores in advance a plurality of contents that are digital works such as movies and music, and also stores a content key in correspondence with each content. Each content key is key information that is used when encrypting the corresponding content.

The content server apparatus 2200, in response to an instruction from the content recording apparatus 2100, reads content and a content key from the hard disk, and transmits the read content and content key to the content recording apparatus 2100 via the LAN.

### 7.3 Structure of the Content Recording Apparatus 2100

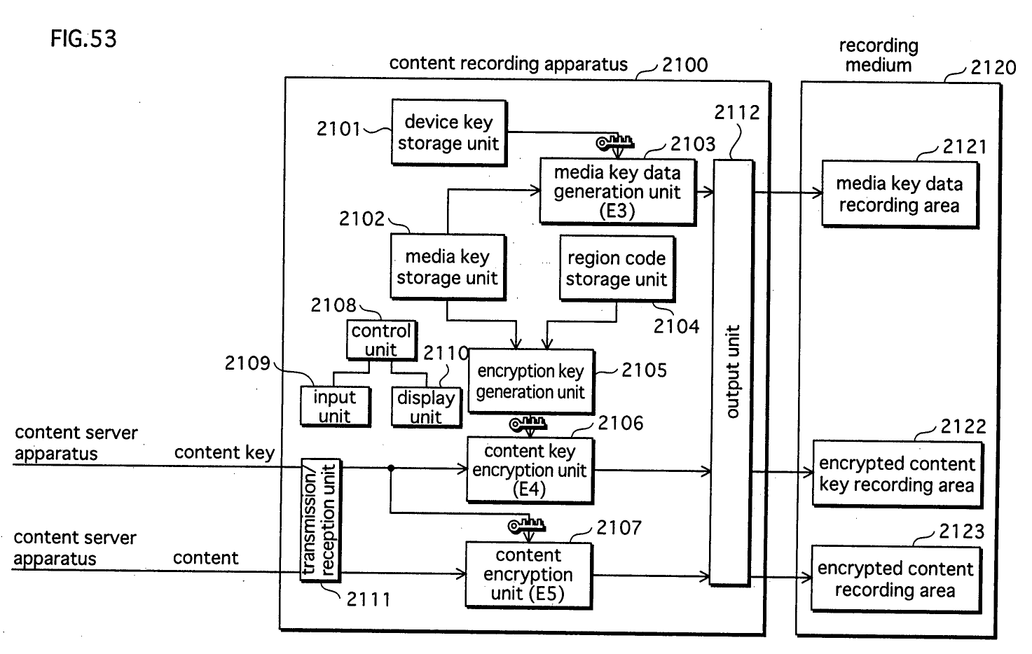

The content recording apparatus 2100, as shown in FIG. 53, is composed of a device key storage unit 2101, a media key storage unit 2102, a media key data generation unit 2103, a region code storage unit 2104, an encryption key generation unit 2105, a content key encryption unit 2106, a content encryption unit 2107, a control unit 2108, an input unit 2109, a display unit 2110, a transmission/reception unit 2111, and an output unit 2112.

Similar to the content server apparatus 2200, the content recording apparatus 2100 is a computer system composed of a microprocessor, a ROM, a RAM, and so on. A computer program is stored in the RAM. The content recording apparatus 2100 achieves part of its functions by the microprocessor operating according to the computer program.

### (1) Device Key Storage Unit 2101, Media Key Storage Unit 2102, and Region Code Storage Unit 2104

The device key storage unit 2101 stores in advance n device keys secretly, specifically device key 1 through to device key n, which correspond respectively to n content playback apparatuses. Each device key is, for example, 64 bits in length.

The media key storage unit 2102 stores in advance unique media keys, each of which is unique to a recording medium, and is, for example, 64 bits in length.

Note that the media keys are not limited to being unique to individual recording media. For example, one media key may be unique to recording media on which a same content is recorded. In other words, the same media key may be set for a plurality of recording media that store the same content. Alternatively, a particular media key may be unique to recording media on which contents whose copyrights are owned by a same party are recorded. Furthermore, a particular media key may be unique to recording media that are provided by a same provider.

The region code storage unit 2104 stores in advance six region codes. Each region code indicates a code of one region among six regions in the world, as described in Document 1. Specifically, the region codes are 0×0001, 0×0002, through to 0×0006. Here, 0×0001 and the other region codes are in hexadecimal notation.

### (2) Media Key Data Generation Unit 2103

The media key data generation unit 2103 reads n device keys from the device key storage unit 2101, reads the media key from the media key storage unit 2102, and encrypts the read media key by applying an encryption algorithm E3 with use of each of the read n device keys, respectively, to generate n encrypted media keys

E3 (device key1, media key),

E3 (device key2, media key),

through to

E3 (device keyn, media key).

Here, the encryption algorithm is, for example, DES.

Next, the media key data generation unit 2103 writes the generated n encrypted media keys to a media key data recording area 2121 (described later) of the recording medium 2120, via the output unit 2112. Here, then encrypted media keys are written in an order corresponding to the device keys 1, 2 through to n.

### (3) Encryption Key Generation Unit 2105

The encryption key generation unit 2105 reads the media key from the media key storage unit 2102, and, according to an instruction from an operator of the content recording apparatus 2100, selects, via the input unit 2109 and the control unit 2108, S region codes of regions in which playback of the content is permitted, from among the region codes stored in the region code storage unit 2104. Here, 1≦S≦6.

Next, for each of the selected region codes, the encryption key generation unit 2105 concatenates the read media key and the region code in the stated order, to generate concatenated data, and applies a one-way function, which is a hash function such as SHA-1, to the generated concatenated data to obtain a 160-bit output value. Here, if, for example, the encryption algorithm is DES, the highest 56 bits of the output value are used as the encryption key. In this way, S encryption keys K1, K2, through to KS are generated.

Next, the encryption key generation unit 2105 outputs the S generated encryption keys K1, K2, through to KS to the content key encryption unit 2106.

Taking for example a case in which permission for playing back content is restricted to content playback apparatuses that belong to a region indicated by one of the region codes 0×0001 and 0×0005, the encryption key generation unit 2105 selects the two region codes 0×0001 and 0×0005, generates two encryption keys K1 and K5, and outputs the two encryption keys K1 and K5 to the content key encryption unit 2106.

### (4) Content Key Encryption Unit 2106

The content key encryption unit 2106 receives the content key from the content server apparatus 2200 via the transmission/reception unit 2111, receives the S encryption keys K1, K2, through to KS, and concatenates fixed data and the received content key to generate concatenated data. Here, the fixed data is, for example, 0×0000. This fixed data is used during decryption to judge whether or not decrypted data is correct. Next, the content key encryption unit 2106 applies an encryption algorithm E4 to the concatenated data with use of each of the received encryption keys, to generate S encrypted content keys

E4 (K1, fixed data+content key)

E4 (K2, fixed data+content key),

through to

E4 (KS, fixed data+content key).

The content key encryption unit 2106 writes the S generated encrypted content keys to an encrypted content recording area 2122 (describe later) of the recording medium 2120, via the output unit 2112.

Here, “+” is an operator that indicates concatenation.

The encryption algorithm E4 is, for example, DES.

Note that, as one example, the content key encryption unit 2106 receives two encryption keys K1 and K5, generates two encrypted content keys

E4 (K1, fixed data+content key),

E4 (K5, fixed data+content key),

and writes the two generated encrypted content keys.

### (5) Content Encryption Unit 2107

The content encryption unit 2107 receives a content key and content from the content server apparatus 2200 via the transmission/reception unit 2111, applies an encryption algorithm E5 to the received content with use of the received content key to generate encrypted content

E5 (content key, content),

and writes the generated encrypted content to an encrypted content recording area 2123 (described later) of the recording medium 2120, via the output unit 2112.

Here, the encryption algorithm E5 is, for example, DES.

### (6) Control Unit 2108, Input Unit 2109, and Display Unit 2110

The control unit 2108 controls the compositional elements of the content recording apparatus 2100. The input unit 2109 receives instructions and information from the operator of the content recording apparatus 2100, and outputs the received instructions and information to the control unit 2108. The display unit 2110 displays various information, under the control of the control unit 2108.

### (7) Transmission/Reception Unit 2111 and Output Unit 2112

The transmission/reception unit 2111 is connected to the content server apparatus 2200 via a LAN, and, under the control of the control unit 2108, receives content and a content key from the content server apparatus 2200, outputs the received content and content key to the content encryption unit 2107, and outputs the received content key to the content key encryption unit 2106.

The output unit 2112 forms the media key data recording area 2121, the encrypted content key recording area 2122, and the encrypted content recording area 2123 on the recording medium 2120, and writes the n encrypted media keys, the S encrypted content keys and the encrypted content to the respective areas.

### 7.4 Structure of the Recording Medium 2120

The recording medium 2120 is a pre-recorded media such as a DVD-Video. There is no information written on the recording medium 2120 in an initial state.

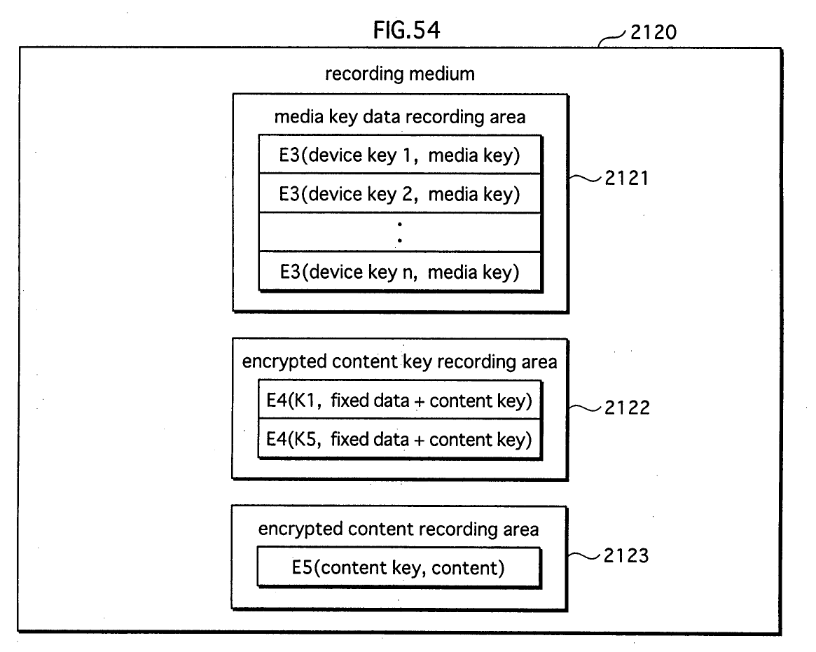

When information has been written to the recording medium 2120 by the content recording apparatus 2100, the recording medium 2120 has the media key data recording area 2121, the encrypted content key recording area 2122, and the encrypted content recording area 2123, as shown in FIG. 54.

FIG. 54 shows a specific example of data recorded on the recording medium 2120. In this example, the total number of content playback apparatuses is n as described earlier, each playback apparatus has one unique device key from among device keys 1 to n, and playback of content is permitted only in playback apparatuses belonging to a region indicated by the region code 0×0001 or 0×0005.

Recorded in the media key data recording area 2121 are n encrypted media keys. Two encrypted content keys are recorded in the encrypted content key recording area 2122, and one encrypted content is recorded in the encrypted content recording area 2123.

### 7.5 Structure of the Content Playback Apparatus 2400

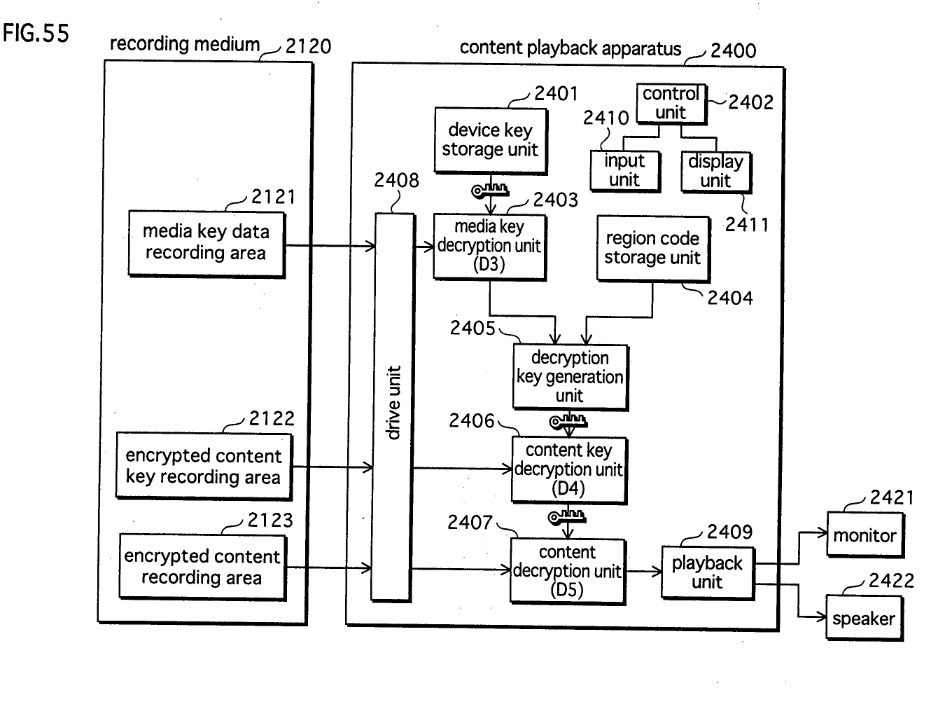

The content playback apparatus 2400, as shown in FIG. 55, is composed of a device key storage unit 2401, a control unit 2402, a media key decryption unit 2403, a region code storage unit 2404, a decryption key generation unit 2405, a content key decryption unit 2406, a content decryption unit 2407, a drive unit 2408, a playback unit 2409, an input unit 2410, and a display unit 2411.

The content playback apparatus 2400 is, specifically, a computer system composed of a microprocessor, a ROM, a RAM, and so on. A computer program is stored in the RAM. The content playback apparatus 2400 achieves its functions by the microprocessor operating according to the computer program.

Note that other content playback apparatuses have the same structure as the content playback apparatus 2400 and are therefore not described here.

### (1) Device Key Storage Unit 2401 and Region Code Storage Unit 2404

The device key storage unit 2401 stores a device key secretly and is key information assigned uniquely to the content playback apparatus 2400.

The region code storage unit 2404 stores one region code in advance. Specifically, the region code is 0×0001. 0×0001 indicates the region in which the content playback apparatus 2400 is sold.

### (2) Media Key Decryption Unit 2403

The media key decryption unit 2403 reads an encrypted media key from the media key data recording area 2121 of the recording medium 2120, via the drive unit 2408. Here, the read encrypted media key is the encrypted media key recorded in a position corresponding to an apparatus number (one of 1, 2, through to n) assigned to the content playback apparatus.

If, for example, the apparatus number assigned to the content playback apparatus is “5”, the media key decryption unit 2403 reads the encrypted media key that is fifth from the top of the n encrypted media keys recorded in the media key data recording area 2121 of the recording medium 2120.

Next, the media key decryption unit 2403 reads the device key from the device key storage unit 2401, applies a decryption algorithm D3 to the read encrypted media key, with use of the read device key to generate a media key, and outputs the generated media key to the decryption key generation unit 2405.

Here, the decryption algorithm D3 is an algorithm for decrypting a ciphertext generated using the encryption algorithm E3, and is, for example, DES.

### (3) Decryption Key Generation Unit 2405

The decryption key generation unit 2405 receives the media key from the media key decryption unit 2403, and reads the region code from the region code storage unit 2404.

Next, the decryption key generation unit 2405 generates one decryption key in the same manner as the encryption key generation unit 2105 with use of the received media key and the read region code, and outputs the generated decryption key to the content key decryption unit 2406.

### (4) Content Key Decryption Unit 2406

The content key decryption unit 2406 receives the decryption key from the decryption key generation unit 2405, reads the S encrypted content keys from the encrypted content key recording area 2122 of the recording medium 2120, via the drive unit 2408, applies an encryption algorithm D4 to the read S encrypted content keys with use of the received decryption keys to generate S pieces concatenated data, and selects the one piece of concatenated data, from among the generated pieces of concatenated data, whose head is 0×0000. Next, the content key decryption unit 2406 deletes 0×0000 from the head of the selected concatenated data to generate a content key, and outputs the generated content key to the content decryption unit 2407.

Here, the decryption algorithm D4 is an algorithm for decrypting a ciphertext generated using the encryption algorithm D3, and is, for example, DES.

Note that the content key decryption unit 2406 reads one encrypted content key from the encrypted content key recording area 2122, decrypts the read encrypted content key with use of the decryption key to generate concatenated data, and judges whether the top of the concatenated data is 0×0000. When the top is 0×0000, the content key decryption unit 2406 deletes the 0×0000 from the top to generate the content key. When the top is not 0×0000, the content key decryption unit 2406 continues to read and decrypt encrypted content keys until it finds one whose top is 0×0000.

### (5) Content Decryption Unit 2407

The content decryption unit 2407 receives the content key from the content key decryption unit 2406, reads the encrypted content from the encrypted content recording area 2123 of the recording medium 2120 via the drive unit 2408, applies a decryption algorithm D5 to the read encrypted content with use of the received content key to generate content, and outputs the generated content to the playback unit 2409.

### (6) Playback Unit 2409

The playback unit 2409 receives the content from the content decryption unit 2407, converts the received content to analog video and audio signals in an internal digital AV processing unit, and outputs the generated video signal and audio signal to the monitor 2421 and speaker 2422, respectively.

### (7) Control Unit 2402, Input Unit 2410, Display Unit 2411, and Drive Unit 2408

The control unit 2402 controls the compositional elements of the content playback apparatus 2400. The input unit 2410 receives instructions and information from the operator of the content playback apparatus 2400, and outputs the received instructions and information to the control unit 2402. The display unit 2411 displays various information under the control of the control unit 2402. The drive unit 2408 reads information from a recording medium.

### 7.6 Operations in the Content Distribution System

The following describes operations in the content distribution system 2000.

### (1) Operations by the Content Recording Apparatus 2100

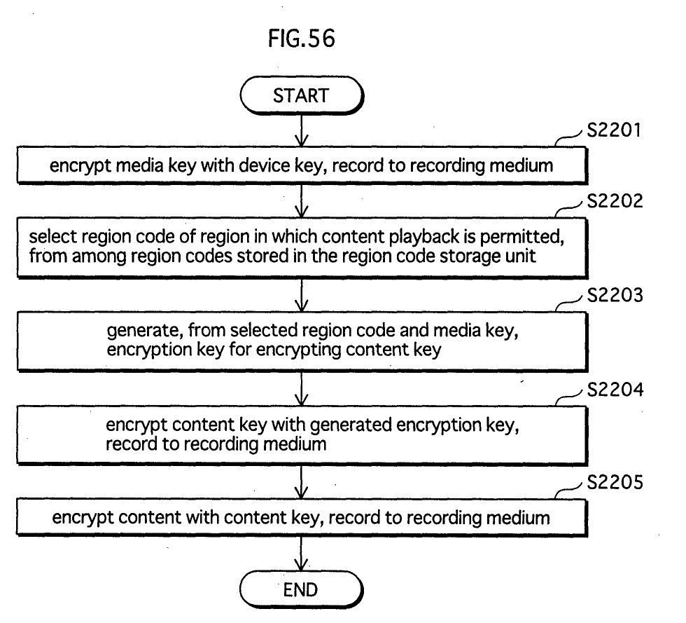

The following describes operations by the content recording apparatus 2100, with use of the flowchart in FIG. 56.

The media key data generation unit 2103 encrypts a media key stored in the media key storage unit 2102, with use of the device key stored in the device key storage unit 2101, to generate an encrypted media key, and records the generated encrypted media key to the media key data recording area 2121 of the recording medium 2120 (step S2201).

Next, the encryption key generation unit 2105 selects at least one region code of a region or regions in which playback of the content is permitted, from among the region codes stored in the region code storage unit 2104 (step S2202), and generates at least one encryption key for encrypting the content, from the selected at least one region code and the media key. Here, the number of encryption keys generated is the same as the number of region codes selected (step S2203).

Next, the content key encryption unit 2106 encrypts the content key with use of the generated at least one encryption key, to generate at least one encrypted-content key, and writes the at least one generated encrypted content key to the encrypted content key recording area 2122 of the recording medium 2120 (step S2204).

Next, the content encryption unit 2107 encrypts the content with use of the content key to generate encrypted content, and records the generated encrypted content to the encrypted content recording area 2123 of the recording medium 2120 (step S2205).

### (2) Operations by the Content Playback Apparatus 2400

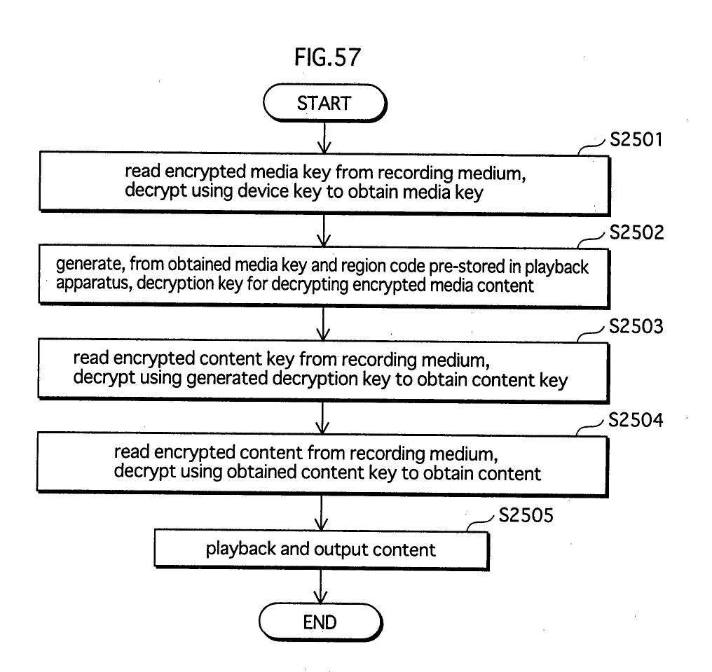

The following describes operations by the content playback apparatus 2400, with use of the flowchart in FIG. 57.

The media key decryption unit 2403 decrypts the device key stored in the device key storage unit 2401, with use of an encrypted media key selected and read from the media key data recording area 2121 of the recording medium 2120, to generate a media key (step S2501).

The decryption key generation unit 2405 generates a decryption key for decrypting the encrypted content key, based on the generated media key and the region code stored in the region code storage unit 2404 (step S2502).

The content key decryption unit 2406 decrypts at least one encrypted content key read from the encrypted content key recording area 2122 of the recording medium 2120, using the generated decryption key, to generate at least one content key, and specifies a correct content key from among the generated content keys (step S2503).

The content decryption unit 2407 decrypts the encrypted content read from the encrypted content recording area 2123 of the recording medium 2120, with use of the generated content key, to generate content (step S2504).

The playback unit 2409 converts the generated content to analog video and audio signals, and outputs the audio signal and the video signal to the monitor 2421 and the speaker 2422, respectively (step S2505).

### 7.7 Conclusion

In the content distribution system 2000 of the sixth embodiment, the content recording apparatus encrypts a content key that is generated using a region code and a media key, and records the generated content key to the recording medium. A content playback apparatus that has a region code showing the region in which the content is permitted to be played back is able to obtain the correct content key for decrypting the encrypted content, by using a decryption key generated from the region code of the content playback apparatus and the media key, if the region code matches that used when recording the encrypted content key on the recording medium.

On the other hand, when the region code used when recording the encrypted content to the recording medium and the region code of the content playback apparatus do not match, the content playback apparatus is unable to obtain the correct content key, and is therefore unable to decrypt the encrypted content.

In this way, by using the region code when encrypting and decrypting content, viewing/listening of the content can be restricted by region.

### 7.8 Modifications

(1) The present invention is not limited to having the structure described in the sixth embodiment in which the content recording apparatus 2100 is connected to the content server apparatus 2200 via a LAN and obtains the content and content key from the content server apparatus 2200.

Instead, the content recording apparatus 2100 may be connected to the content server apparatus 2200 via the Internet, and obtain the content and content key from the content server apparatus 2200 via the Internet.

Alternatively, the content and content key may be broadcast on a digital broadcast wave by the digital broadcast transmission apparatus, and the content recording apparatus 2100 may receive the digital broadcast wave and extract the content and content key therefrom.

A further alternative is for the content recording apparatus 2100 to store the content key and content internally, or to generate a content key internally when necessary. Furthermore, the content recording apparatus 2100 may have a structure of generating content. For example, the content recording apparatus 2100 may have a camera and an encoding unit that encodes moving images, and generate encoded moving images as content.

(2) The region information in the present invention is not limited to being public information as described in the sixth embodiment.

A possible alternative structure is one in which secret information is set in correspondence with region codes, and the content recording apparatus and the content playback apparatus stringently manage the secret information so that it is not leaked. Here, the apparatuses generate encryption and decryption keys from the secret information and the media key.

(3) The content recording apparatus may record, as is, the region code showing the region in which playback of the content is permitted to the recording medium, and the content playback apparatus may first compare the region code on the recording medium with its own region code, and abort further processing if the region codes do not match.

(4) A possible structure is one in which, when specifying a media key that has been encrypted using the device key of the content playback apparatus, from among the encrypted media keys recorded on the recording medium, the content playback apparatus, for example, sets in advance each of the lowest eight bits of the media key as “1”, and the content playback apparatus checks whether the lowest eight bits of the data obtained by decrypting the encrypted media are all “1”, and judges that the encrypted media key has been successfully decrypted if the lowest eight bits are all “1”.

This kind of advance check enables the media key to be obtained reliably, and prevents the speaker connected to the content playback apparatus from being destructed by noise and the like generated due to erroneously decrypted data.

(5) The content key encryption unit 2106 of the content recording apparatus 2100 of the sixth embodiment concatenates the fixed data and the content key. Furthermore, part of the media key is a specific value, as described above in (4). This is in order to confirm, when decrypting the encrypted content key or the encrypted media key, whether the correct original content key or media key has been obtained.

The following structure may be provided for confirming whether the correct original data has been obtained as described.

The decryption key used for decryption may be allocated an ID that identifies the decryption key. The content recording apparatus attaches the ID to a ciphertext to indicate which key was used in encryption, in other words, which key to use for decryption. When decrypting, the content playback apparatus compares the ID of the key held by the playback apparatus with the ID attached to the ciphertext, and decrypts the ciphertext when the IDs match.

(6) In the sixth embodiment, the media key storage unit 2102 of the content recording apparatus 2100 stores in advance media keys unique to recording media, but instead of being stored in advance, the media keys may be generated as necessary.

### 8. Seventh Embodiment

The following describes a content distribution system 3000 as another embodiment of the present invention.

In the sixth embodiment described above, any content playback apparatus that has a device key is able to obtain the media key. Restricting viewing/listening of the content by region is achieved with use of the region code after the media key has been obtained.

In contrast, in the seventh embodiment, even with a device key, a content playback apparatus is unable to obtain the correct media key unless the playback apparatus belongs to a region in which playback of the content is permitted. As described in detail below, this structure enables usage of the content to be limited by region.

### 8.1 Structure of the Content Distribution System 3000

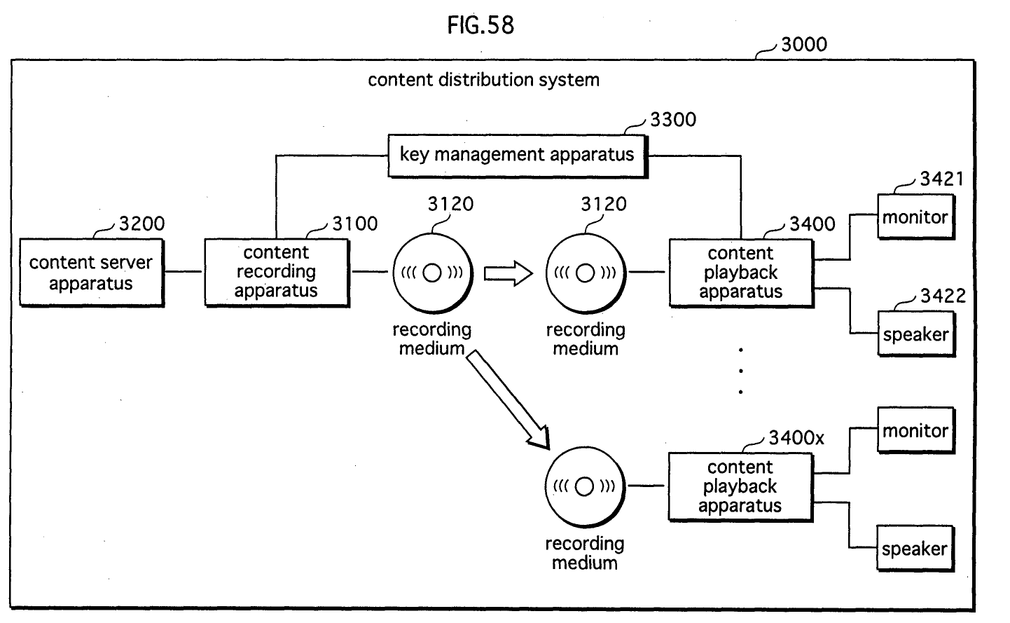

The content distribution system 3000, as shown in FIG. 58, is composed of a key management apparatus 3300, a content server apparatus 3200, a content recording apparatus 3100, and content playback apparatuses 3400 to 3400x. Here, the total number of content playback apparatuses is n.

In the seventh embodiment, the device keys held by each content playback apparatus are managed using a tree structure. The method for managing the keys using the tree structure is, for example, that disclosed in Document 1.

Here, the content server apparatus 3200 has the same structure as the content server apparatus 2200, and is therefore not described here.

### 8.2 Structure of the Key Management Apparatus 3300

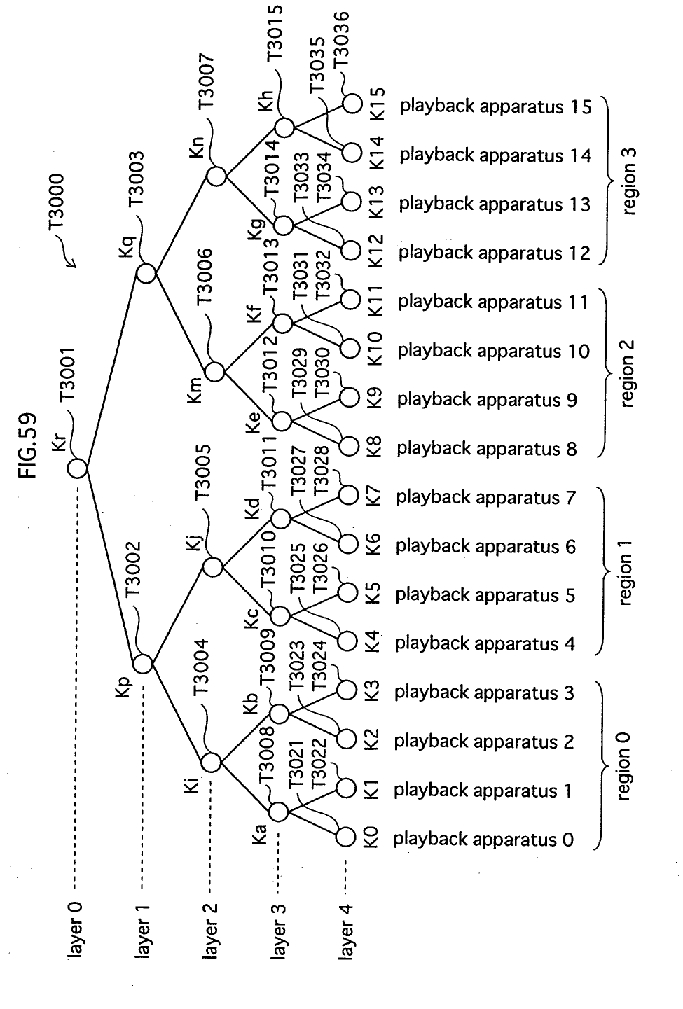

The key management apparatus 3300 has the same structure as the key management apparatus 100, and has a tree structure T3000 shown in FIG. 59. FIG. 59 shows one example of device keys put in correspondence with the nodes in the tree structure, content playback apparatuses put in correspondence with the leaves, and region codes, which indicate regions, put in correspondence with the leaves.

As shown in FIG. 59, the tree structure T3000 is a binary tree that has five layers, the same as the tree structure T100 shown in FIG. 4. Device keys are put in correspondence with the nodes in the tree structure T3000.

Specifically, as shown in FIG. 59, a device key “Kr” is in correspondence with a node (root) T3001 that is on layer 0. Device keys “Kp” and “Kq” are in correspondence with nodes T3002 and T3003, respectively, that are on layer 1. Device keys “Ki”, “Kj”, “Km” and “Kn” are in correspondence with nodes T3004 to T3007, respectively, that are on layer 2. Device keys “Ka”, “Kb”, “Kc”, “Kd”, “Ke”, “Kf”, “Kg” and “Kh” are in correspondence with nodes T3008 to T3015, respectively, that are on layer 3. Furthermore, device keys “K0” to “K15” are in correspondence with nodes (leaves) T3021 to T3036, respectively, that are on layer 4.

Content playback apparatuses 0 to 15 are in correspondence with leaves T3021 to T3036, respectively. Furthermore, the content playback apparatuses are arranged by the region to which they belong (i.e. the region in which the content playback apparatus can be sold and used). Specifically, content playback apparatuses 0 to 3 belong to region 0, content playback apparatuses 4 to 7 belong to region 1, content playback apparatuses 8 to 11 belong to region 2, and content playback apparatuses 12 to 15 belong to region 3.

In other words, in correspondence with each of the leaves T3021 to T3036 is an apparatus number identifying the corresponding content playback apparatus, and a region code showing a region.

The key management apparatus 3300 transmits, to each content playback apparatus, all the device keys on the path from the corresponding leaf through to the root, in the same manner as the key management apparatus 100, and also transmits the region code of the content playback apparatus together with the device keys.

For example, the key management apparatus 3300 transmits the five device keys “K0”, “Ka”, “Ki”, “Kp” and “Kr”, and the region code 0×0000, which indicates the region 0, to the content playback apparatus 0.

Furthermore, the key management apparatus 3300 transmits the tree structure T3000, all the device keys that are in correspondence with the nodes in the tree structure T3000, the apparatus numbers indicating the content playback apparatuses that are in correspondence with the leaves, and the region codes that are in correspondence with the leaves, to the content recording apparatus 3100.

### 8.3 Structure of the Content Recording Apparatus 3100

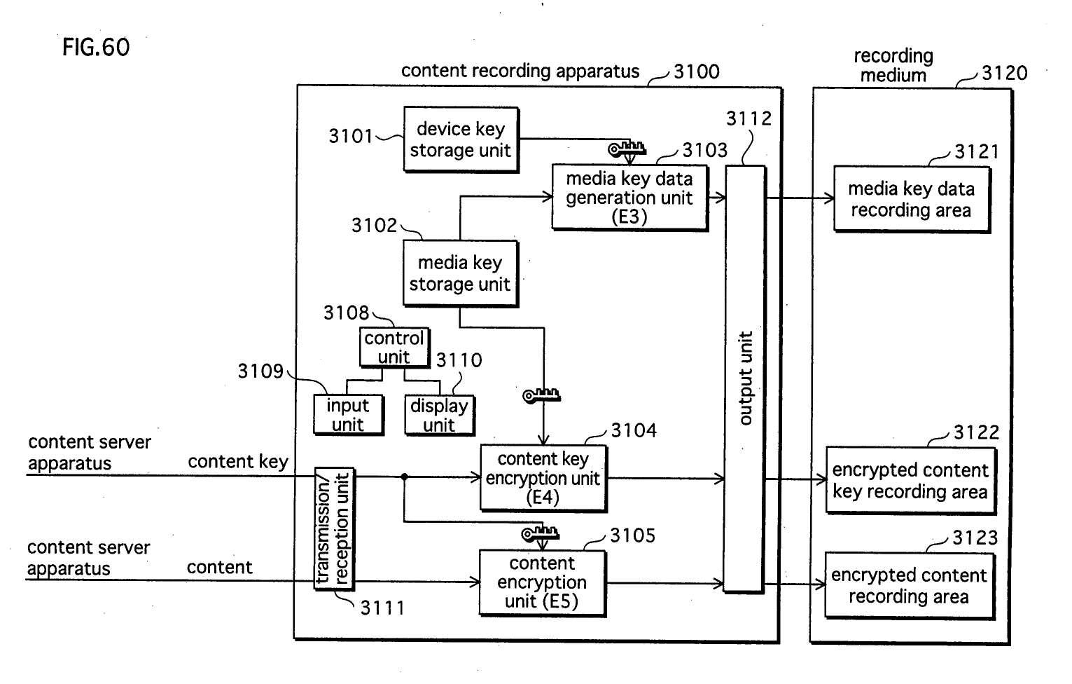

The content recording apparatus 3100, as shown in FIG. 60, is composed of a device key storage unit 3101, a media key storage unit 3102, a media key data generation unit 3103, a content key encryption unit 3104, a content encryption unit 3105, a control unit 3108, an input unit 3109, a display unit 3110, a transmission/reception unit 3111, and an output unit 3112.

The content recording apparatus 3100 is a computer system like the content recording apparatus 2100.

### (1) Device Key Storage Unit 3101

The device key storage unit 3101 has the tree structure T3000, and stores all the device keys of the content playback apparatuses. In addition, the device key storage unit 3101 stores the apparatus numbers of the content playback apparatuses in correspondence with the leaves, and the region codes in correspondence with the leaves. This is information transmitted from the key management apparatus 3300.

Specifically, in the case of the tree structure T3000 shown in FIG. 59, the device key storage unit 3101 stores the device keys K0 to K15 and Ka to Kr.

### (2) Media Key Storage Unit 3102

The media key storage unit 3102 stores in advance unique media keys, each of which is unique to a recording medium. Here, each media key is, for example, 64 bits in length, and the lowest eight bits are all “1”. The lowest eight bits are used for judging whether decryption of the media key is successful.

### (3) Media Key Data Generation Unit 3103

The media key data generation unit 3103 reads the media key from the media key storage unit 3102.

Next, the media key data generation unit 3103 receives, from the operator of the content recording apparatus 3100 via the input unit 3109 and the control unit 3108, a region code indicating the region in which playback of the content is permitted, and selects S device keys from those that are held only by playback devices that belong to the region indicated by the received region code and are not held by content playback devices that belong to other regions. Of these, the device key or keys that are on a highest layer are selected. Here, S≧1.

Next, the media key data generation unit 3103 applies the encryption algorithm E3 to the read media key with use the selected S device keys to generate S encrypted media keys, and records the generated S encrypted media keys to the media key data recording area 3121 of the recording medium 3120.

Referring to the tree structure T3000 in FIG. 59 and taking an example of the region in which playback of the content is permitted being region 0, the device keys assigned only to the content playback apparatuses 0 to 3 in region 0 are “Ki”, “Ka”, “Kb”, “K0”, “K1”, “K2” and “K3”. Among these device keys, the device key on the highest layer is “Ki”. Consequently, the media key data generation unit 3103 selects the device key “Ki”, and generates one encrypted media key E3(Ki, media key).

Taking as a further example of playback of the content being permitted in region 1, region 2 and region 3, the device keys assigned only to the content playback apparatuses 4 to 7 that belong to region 1 are “Kj”, “Kc”, “Kd”, “K4”, “K5”, “K6” and “K7”, and the device key among these device keys that is on the highest layer is “Kj”. The device keys assigned only to the content playback apparatuses 8 to 15 that belong to region 2 and region 3 are “Kq”, “Km”, “Kn”, “Ke”, “Kf”, “Kg”, “Kh”, and “K8” to “K15”, and the device key among these device keys that is on the highest layer is “Kq”. Consequently, the media key data generation unit 3103 selects the device keys “Kj” and “Kq”, and generates two encrypted media keys E3(Kj, media key) and E3 (Kq, media key).

As yet a further example, when playback of the content is permitted in region 0, region 1, region 2 and region 3, in other words all the regions, the media key data generation unit 3103 selects the device key “Kr”, and generates one encrypted media key E3(Kr, media key).

### (4) Content Key Encryption Unit 3104

The content key encryption unit 3104 reads the media key from the media key storage unit 3102, obtains the content key from the content server apparatus 3200, applies the encryption algorithm E4 to the obtained content key with use of the read media key to generate an encrypted content key E4(media key, content key), and records the generated encrypted content key to the encrypted content key recording area 3122 of the recording medium 3120.

### (5) Content Encryption Unit 3105

The content encryption unit 3105 obtains content and the content key from the content server apparatus 3200, applies the encryption algorithm E5 to the obtained content, with use of the obtained content key to generate encrypted content E5 (content key, content), and records the generated encrypted content to the encrypted content recording area 3123 of the recording medium 3120.

### (6) Other Structure

The control unit 3108, the input unit 3109, the display unit 3110, the transmission/reception unit 3111 and the output unit 3112 are the same as the control unit 2108, the input unit 2109, the display unit 2110, the transmission/reception unit 2111 and the output unit 2112 of the content recording apparatus 2100, and are therefore not described here.

### 8.4 Structure of the Recording Medium 3120

The recording medium 3120 is a pre-recorded medium such as a DVD-Video, similar to the recording medium 2120. There is no information written on the recording medium 3120 in an initial state.

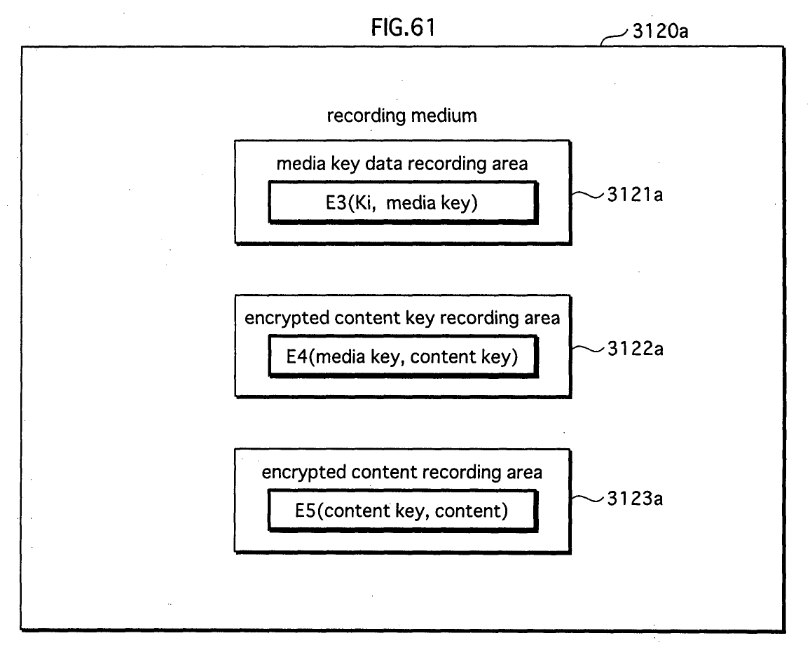

FIG. 61 shows the information written to the recording medium 3120a by the 3100, in the example of the region in which the content is permitted to be played back being region 0 in the tree structure T3000 shown in FIG. 59. The recording medium 3120a has a media key data recording area 3121a, an encrypted content key recording area 3122a, and an encrypted content recording area 3123a. One encrypted media key E3(Ki, media key) is recorded in the media key data recording area 3121a, and the encrypted content key E4(media key, content key) and the encrypted content E5(content key, content) are recorded in the encrypted content key recording area 3122a and the encrypted content recording area 3123a, respectively.

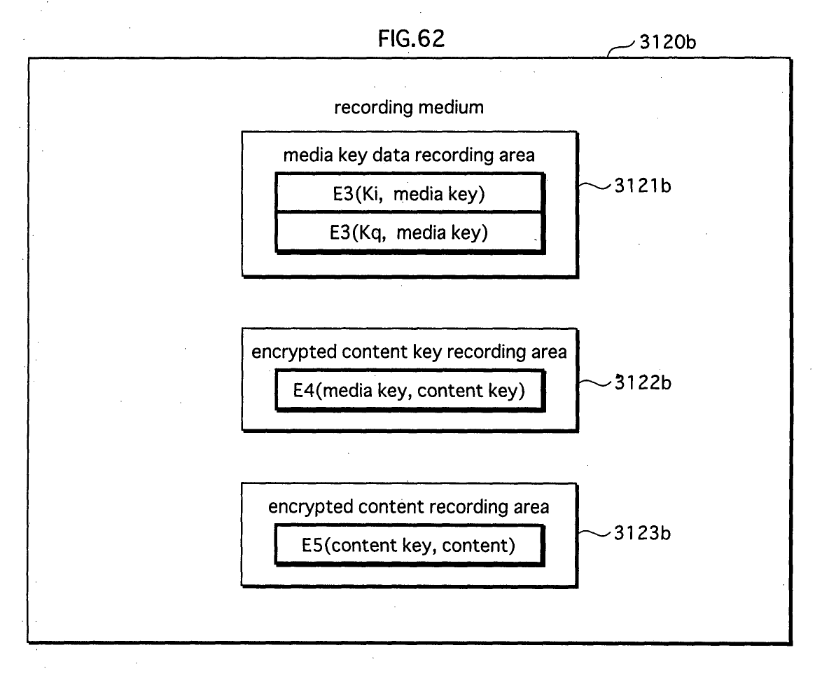

FIG. 62 shows the information written to a recording medium 3120b by the content recording apparatus 3100 in the example of the regions in which the content is permitted to be played back being region 1, region 2 and region 3. The recording medium 3120b has a media key data recording area 3121b, an encrypted content key recording area 3122b and an encrypted content recording area 3123b. Two encrypted media keys E3(Kj, media key) and E3(Kq, media key) are recorded in the media key data recording area 312b, and the encrypted content key E4(media key, content key) and the encrypted content E5(content key, content) are recording in the encrypted content key recording area 3122b and the encrypted content recording area 3123b, respectively.

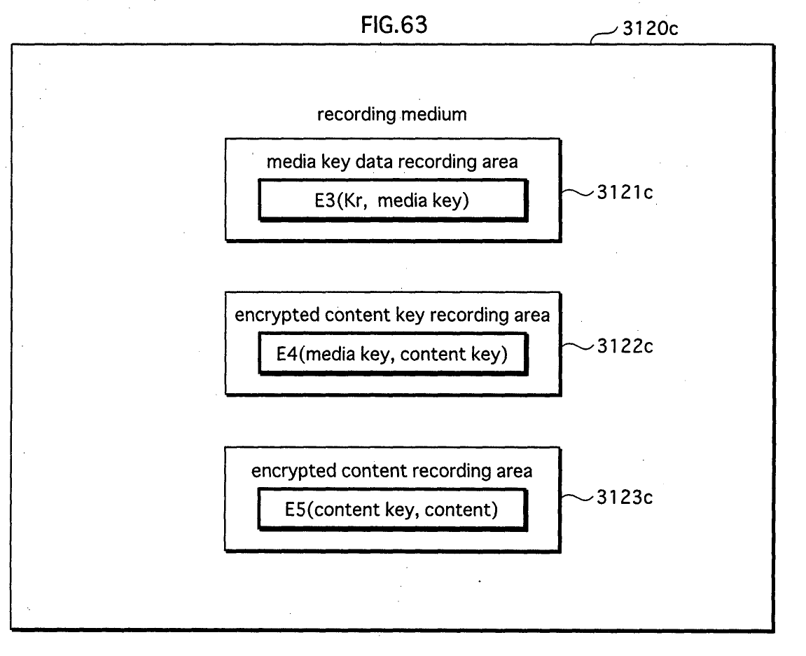

FIG. 63 shows the information written to a recording medium 3120c by the content recording apparatus 3100 in the example of the regions in which the content is permitted to be played back being region 0, region 1, region 2 and region 3, in other words, all regions. The recording medium 3120c has a media key data recording area 3121c, an encrypted content key recording area 3122c, and an encrypted content recording area 3123c. One encrypted media key E3(Kr, media key) is recorded in the media key data recording area 3121c, and the encrypted content key E4(media key, content key) and the encrypted content E5(content key, content) are recorded in the encrypted content key recording area 3122c and the encrypted content recording area 3123c, respectively.

### 8.5 Structure of the Content Playback Apparatus 3400

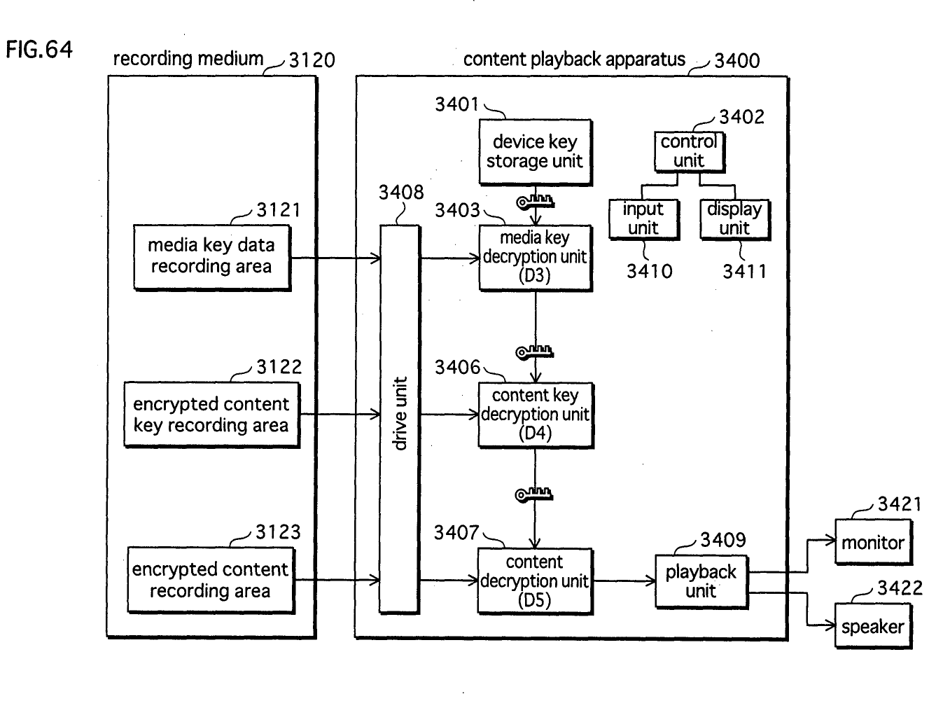

The content playback apparatus 3400, as shown in FIG. 64, is composed of a device key storage unit 3401, a control unit 3402, a media key decryption unit 3403, a content key decryption unit 3406, a content decryption unit 3407, a drive unit 3408, a playback unit 3409, and an input unit 3410, and a display unit 3411. A monitor 3421 and a speaker 3422 are connected to the input unit 3410.

The content playback apparatus 3400 is a computer similar to the content playback apparatus 2400.

Note that other content playback apparatuses have the same structure as the content playback apparatus 3400 and are therefore not described here.

### (1) Device Key Storage Unit 3401

The device key storage unit 3401 stores device keys secretly. Here, the device key storage unit 3401 stores all device keys on a path from root T3001 to the leaf with which the content playback apparatus 3400 is in correspondence in the tree structure T3000 shown in FIG. 59.

### (2) Media Key Decryption Unit 3403

The media key decryption unit 3403 reads all the device keys from the device key storage unit 3401, and reads, via the drive unit 3408, all encrypted media keys from the media key data recording area 3121 of the recording medium 3120.

Next, the media key decryption unit 3403 applies the decryption algorithm D3 to each of the read encrypted media keys with use of each of the device keys, to generate pieces of decrypted data, and judges whether or not each of the pieces of generated decrypted data is the media key. The media key decryption unit 3403 performs this judgment by checking whether all of the lowest eight bits of the decrypted data are “1”, and judges that decryption of the media key is successful and that the decrypted data is the media key if all of the lowest eight bits are “1”. If not all of the lowest eight bits are “1”, the media key decryption unit 3403 judges decryption of the encrypted media key to have failed.

When the decrypted data is judged to be the media key, the media key decryption unit 3403 then outputs the generated decrypted data to the content key decryption unit 3406 as the media key.

Subsequent processing is aborted when the media key decryption unit 3403 judges that a media key does not exist.

### (3) Content Key Decryption Unit 3406

The content key decryption unit 3406 receives the media key from the media key decryption unit 3403, reads the encrypted content key from the encrypted content key recording area 3122 of the recording medium 3120 via the drive unit 3408, applies the decryption algorithm D4 to the read encrypted content key with use of the received media key, to generate a content key, and outputs the generated content key to the content decryption unit 3407.

### (4) Content Decryption Unit 3407

The content decryption unit 3407 receives the content key from the content key decryption unit 3406, reads the encrypted content from the encrypted content recording area 3123 of the recording medium 3120 via the drive unit 3408, applies the decryption algorithm D5 to the read encrypted content with use of the received content key, to generate content, and outputs the generated content to the playback unit 3409.

### (5) Other Compositional Elements

The playback unit 3409, the control unit 3402, the input unit 3410, the display unit 3411 and the drive unit 3408 have the same structure as the playback unit 2409, the control unit 2402, the input unit 2410, the display unit 2411 and the drive unit 2408, respectively, of the content playback apparatus 2400, and are therefore not described.

### 8.6 Operations in the Content Distribution System 3000

### (1) Operations by the Content Recording Apparatus 3100

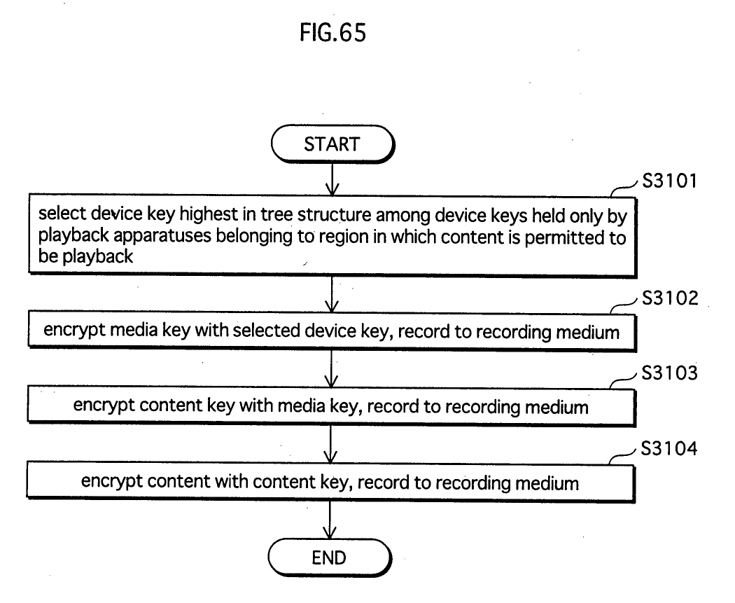

The following describes operations by the content recording apparatus 3100, with use of the flowchart shown in FIG. 65.

The media key data generation unit 3103 selects, from among device keys that are stored in the device key storage unit 3101 and that are held only by content playback apparatuses belonging to the region in which playback of the content is permitted, at least one device key that is on a highest layer in the tree structure (step S3101). Next, the media key data generation unit 3103a encrypts the media key stored in the media key storage unit 3102 with use of the at least one device key, to generate at least one encrypted media key, and records the generated at least one media key to the media key data recording area 3121 of the recording medium 3120 (step S3102).

Next, the content key encryption unit 3104 encrypts the obtained content key, using the media key, to generate an encrypted content key, and records the generated encrypted content key to the encrypted content key recording area 3122 of the recording medium 3120 (step S3103).

The content encryption unit 3105 then encrypts the obtained content with use of the obtained content key, to generate encrypted content, and records the encrypted content to the encrypted content recording area 3123 of the recording medium 3120 (step S3104).

### (2) Operations by the Content Playback Apparatus 3400

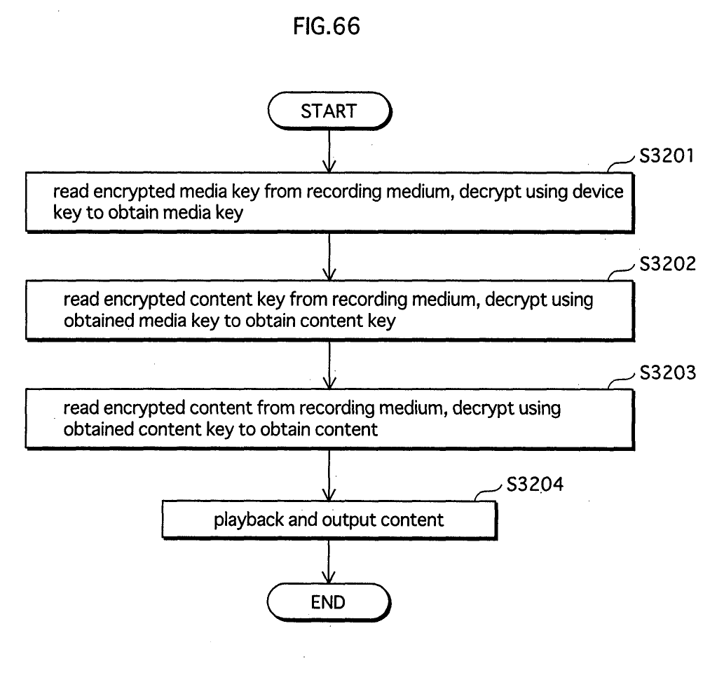

The following describes operations by the content playback apparatus 3400, with use of the flowchart shown in FIG. 66.

The media key decryption unit 3403 decrypts the encrypted media key read from the media key data recording area 3121 of the recording medium 3120 with use of the device key stored in the device key storage unit 3401, to obtain a media key (step S3201).

The content key decryption unit 3406 decrypts the encrypted content key read from the encrypted content key recording area 3122 of the recording medium 3120 with use of the obtained media key, to generate a content key (step S3202).

The content decryption unit 3407 decrypts the encrypted content read from the encrypted content recording area 3123 of the recording medium 3120 with use of the generated content key, to generate content (step S3203).

The playback unit 3409 converts the generated content to analog video and audio signals, and outputs the video signal and the audio signal to the monitor 3421 and the 3422, respectively (step S3204).

### 8.7 Conclusion

In the present invention, a content playback apparatus that belongs to a region in which playback of content is permitted is able to obtain the correct content key for decrypting the encrypted content, by using the device key of the content playback apparatus. On the other hand, a content playback apparatus that belongs to a region in which playback of the content is not permitted is unable to obtain the correct content key, even using the device key of the content playback apparatus, and therefore cannot decrypt the encrypted content correctly.

In this way, only a content playback apparatus that belongs to the region in which playback of the content is permitted is able to obtain the content key necessary for decrypting the encrypted content. Therefore, viewing/listening of the content can be restricted by region.

### 8.8 Modifications

(1) A possible structure is one in which the content recording apparatus 3100 is connected to the content server apparatus 3200 via the Internet, and the content recording apparatus 3100 obtains the content and the content key from the content server apparatus 3200 via the Internet.

Alternatively, the content and content key may be broadcast on a digital broadcast wave by the digital broadcast transmission apparatus, and the content recording apparatus 3100 may receive the digital broadcast wave and extract the content and content key.

A further alternative is for the content recording apparatus 3100 to store the content key and content internally, or to generate a content key internally when necessary.

(2) When playback is permitted in all regions, a recording medium on which content whose playback is not restricted by region is recorded can be realized by using the device key of the root in the case of one tree structure, and by using the device key of each root in the case of a plurality of tree structures.

(3) The present invention is not limited to the example of one tree structure described in the seventh embodiment.

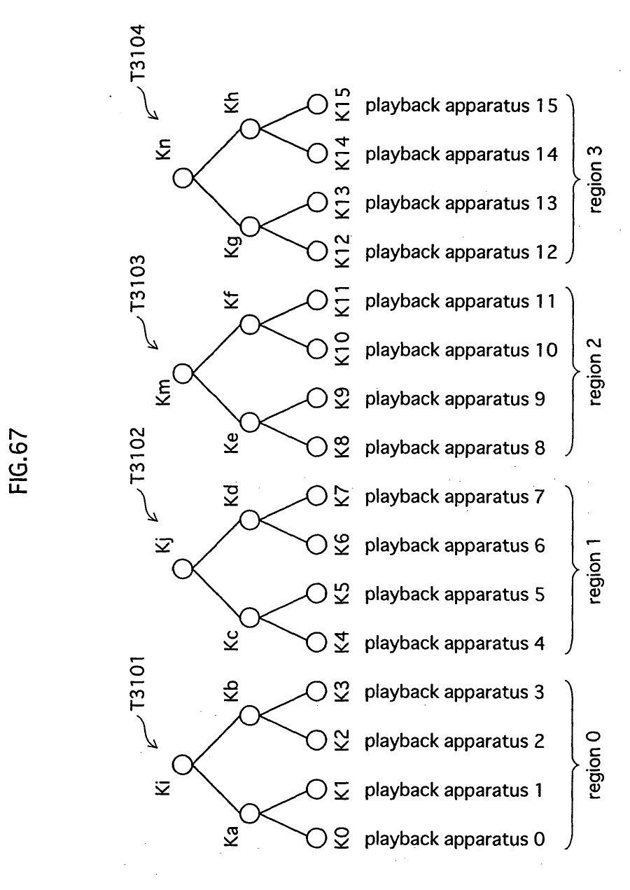

An alternative structure is one in which each region has an independent tree structure, such as shown in FIG. 67. In FIG. 67, tree structures T3101, T3102, T3103 and T3104 correspond respectively to region 0, region 1, region 2, region 3, and the device keys assigned to the routes of the tree structures T3101, T3102, T3103 and T3104 are “Ki”, “Kj”, “Km” and “Kn”, respectively.

In this case, when playback of the content is permitted in all regions, four device keys “Ki”, “Kj”, “Km” and “Kn” are selected, and the media key encrypted with each of the selected device keys, respectively.

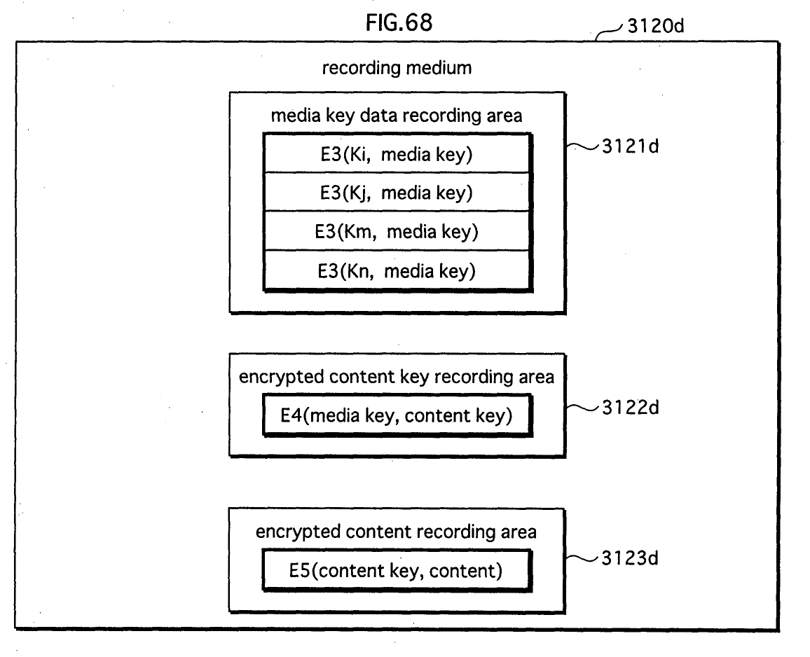

FIG. 68 shows an example of a recording medium 3120d generated in this way. As shown in FIG. 68, the recording medium 3120d has a media key data recording area 3121d, an encrypted content key recording area 3122d and an encrypted content recording area 3123d. Four encrypted media keys E3(Ki, media key), E3(Kj, media key), E3(Km, media key) and E3(Kn, media key) are recorded in the media key data recording area 3121d. An encrypted content key E4(media key, content key) is recorded in the encrypted content key recording area 3122d, and encrypted content (content key, content) is recorded in the encrypted content recording area 3123d.

(4) When a plurality of tree structures are used, it is not necessary for all the tree structures to have the same number of layers, and the number of layers of the tree structures may vary between regions. Furthermore, it is not necessary for the tree structures to be binary trees. Instead, the trees may be 3-ary trees, or the different trees may have different structures.

(5) A possible structure is one in which the content recording apparatus records the region code indicating the region in which playback of the content is permitted to the recording medium, the content playback apparatus stores a region code internally, first compares the region code on the recording medium with its own region code, and aborts subsequent processing when the region codes do not match.

A further possible structure is one in which the lowest eight bits of the media key are all set in advance as “1”, as described earlier, and the playback apparatus checks the eight bits and judges whether or not decryption is successful. This kind of advance check enables the correct media key to be confirmed, and prevents the speaker connected to the content playback apparatus from being destructed by noise and the like generated due to erroneously decrypted data.

(6) The examples used in the sixth and seventh embodiments describe the content recording apparatus managing the device keys of the content playback apparatuses, and the recording medium being a pre-recorded media such as a DVD-Video. However, the present invention is not limited such structure.

An example of an alternative structure is one in which a device key or a region code is given to the content recording apparatus in the same way as the content playback apparatus, and the recording medium is a recordable medium such as a DVD-RAM. The recording apparatus belongs, for example, to region 0, and is able to record content correctly (compatible with other apparatuses) only to recording media that are for region 0. Similarly, only playback apparatuses that belong to region 0 are able to play back the recorded content. This structure enables usage, recording and viewing/listening of the recording media to be limited by region.

(7) The present invention is not limited to the structure described in the sixth and seventh embodiments in which the content playback apparatus has internal decryption units.

An example of an alternate structure is one in which the decryption units are included in an IC card, and only a content playback apparatus in which the IC card is inserted is able to generate various types of data in the IC card, or decrypt and obtain the content.

A structure that uses this kind of IC card reduces the risk, for example, of the content key being stolen through the bus. Note that here it is not necessary for all processing units to be provided in the IC card. It is sufficient that at least one processing unit is provided in the IC card. A further possible structure is one in which at least one of the processing units of the content recording apparatus is provided in an IC card.

(8) The present invention is not limited to the example of the structure described in the sixth and seventh embodiments in which the content is encrypted with the content key.

An possible alternative structure in the sixth embodiment is one in which the content is encrypted with an encryption key generated from the media key and the region code. In the seventh embodiment, the content may be encrypted with the media key.

Furthermore, levels of encryption may be increased by providing a second content key, and encrypting the second content key with the content key, and encrypting the content with the second content key.

(9) Although the examples in the sixth and seventh embodiments are of using the present invention for protecting copyrights of digital content, the present invention is not limited to this use.

The present invention may, for example, be used in a membership-based information provision system to restrict information to being provided to members in a particular region, in other words for conditional access.

(10) The key information and encrypted content are not limited to being distributed recorded on a recording medium as described in the sixth and seventh embodiments.

Instead of a recording medium, the key information and encrypted data may, for example, be transmitted over a communication medium of the which the Internet is representative.

In this case, the content distribution system is composed of the content server apparatus 2200, six web server apparatuses, and n content playback apparatuses. The six web server apparatuses are connected to the content server apparatus 2200 via special-purpose lines. Here, the content server apparatus 2200 is the same as the content server apparatus 2200 of the content distribution system 2000. The n content playback apparatuses may be connected to the six web server apparatuses via the Internet.

Each of the web servers apparatuses corresponds to one of the six regions into which the world is divided, and stores internally a region code indicating the corresponding region.

Each of the n content playback apparatuses corresponds to one of the six regions and stores the region code of the corresponding region internally. This is the same as the content playback apparatus 2400 in the content distribution system 2000.

Each web server apparatus receives content and a content key form the content server apparatus 2200 of the content distribution system 2000, and generates n media keys, one encrypted content key and encrypted content, in a similar manner to the content recording apparatus 2100. Here, the difference between the web server apparatuses and the content recording apparatus 2100 is that the web server apparatuses generate the encrypted content key using an internally stored region code. The web server apparatus stores the generated n encrypted media keys, one encrypt content key, and the encrypted content internally, and transmits the n encrypted media keys, the encrypt content key, the encrypted content to a content playback apparatus in response to a request from the content playback apparatus, via the Internet.

Here, the media key is key information uniquely assigned to a particular content each time the content is provided. Alternatively, each content may have a unique media key. In other words, the same media key may be set for the same content. Furthermore, the media key may be unique to a same copyright holder, or to a same provider of content.

Each content playback apparatus transmits a request to one of the web server apparatuses, and receives the n encrypted media keys, the encrypted content key and the encrypted content, from the web server apparatus. The content playback apparatus then decrypts and plays back the content in the same way as the content playback apparatus 2400 of the content distribution system 2000.

Note that although each web server apparatus corresponds to one region in the above, individual web server apparatuses may correspond to a plurality of regions. In such a case, the web server apparatus internally stores a plurality of region codes that indicate the respective corresponding regions, and uses the region codes to generate encrypted content keys equal in number to the region codes.

As has been shown, in the content distribution system 2000, playback of content can be restricted by region when content is distributed via a network instead of being distributed stored on a recording medium.

The above-described structure can also be applied to the content distribution system 3000.

Note that it is not necessary for the web servers to be present in the corresponding regions.

(11) The content recoding apparatuses described in the sixth and seventh embodiments may generate and then distribute encrypted content in response to a viewing/listening request from a content playback apparatus, and may bill the user in response to the request.

### 9. Other Modifications

Note that although the present embodiment has been described based on the above embodiments, the present invention is not limited thereto. Cases such as the following are also included in the present invention.

(1) Each of the apparatuses described above is a computer system composed of a microprocessor, a ROM, a RAM, a hard disk unit, a display unit, a keyboard, a mouse, and so on. A computer program is stored in the RAM or the hard disk. Each apparatus achieves part or all of its functions by the microprocessor operating according to the computer program.

(2) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, a CD-ROM (compact disc-read only memory), and MO (magneto-optical), a DVD, a DVD-ROM (digital versatile disc-read only memory), a DVD-RAM, a BD (Blu-ray Disc) or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium, or by transferring the program or the digital signal via a network or the like, the program or the digital signal may be executed by another independent computer system.

(3) The present invention may be any combination of the above-described embodiments and modifications.

### 10. Overall Conclusion

As has been clearly described, according to the disclosed first embodiment of the invention, arranging NRPs in level order as header information that is pre-recorded on the recording medium enables key information and efficient specification by players of the encrypted media key to be decrypted.

Furthermore, according to the disclosed second embodiment, by adding one bit, as header information, to the head of NRPs to show whether the descendants of a node are all revoked apparatuses, the header information can be reduced in size in cases in which the revoked apparatuses occur in a particular part of the tree structure.

Furthermore, according to the disclosed third embodiment, the header information can be further reduced in size by judging according to a particular pattern whether all the descendants of a particular node are revoked apparatuses.

Furthermore, according to the disclosed fourth embodiment and fifth embodiment, it is possible to arrange the NRPs in orders other than that shown in the first to the third embodiments.

Furthermore, in the sixth embodiment, by directly using a region code in decrypting encrypted content, or by using secret information set for each region code, a playback apparatus belonging to a region in which playback of the content is not permitted is unable to obtain the content key for decrypting encrypted content. This enables usage of content to be restricted by region.

Furthermore, in the seventh embodiment, by using a method that manages keys using a tree structure, and by dividing the tree structure into regions or having an independent tree structure for each region, a playback apparatus belonging to a region in which playback of the content is not permitted is prevented from obtaining the content key for decrypting encrypted content, even without using region codes or secret information set for each region code. This enables usage of content to be restricted by region.

### 11. Effects of the Invention

As has been described, the present invention is a region restrictive playback system in which playback of content is restricted according to geographic region, including: a provision apparatus that encrypts content, based on first region information that indicates a region, to generate encrypted information, and provides the generated encrypted information; and a playback apparatus that stores, in advance, second region information that indicates a region, obtains the encrypted information, attempts to decrypt the obtained encrypted information, based on the second region information, and, when the encrypted information is decrypted successfully, generates content as a result of decryption, and plays back the generated content.

According to the stated structure, the provision apparatus encrypts content, based on the first region information indicating a region, and provides the resulting encrypted information. The playback apparatus attempts to decrypt the obtained-encrypted information, based on pre-stored second region information, and when decryption is performed successfully, generates content as a result. Therefore, a playback apparatus in which the second region information has been changed illegally, or in which the function of confirmation according to the second region information is circumvented, is unable to decrypt the encrypted information correctly. In this way, such a playback apparatus is unable play back the content correctly. As a result, playback can be restricted by region.

Furthermore, the present invention is a provision apparatus that provides content, playback of the content being restricted according to region, the provision apparatus including: a generation unit operable to encrypt content, based on region information that indicates a region, to generate encrypted information; and a provision unit operable to provide the-generated encrypted information.

According to the stated structure, the provision apparatus encrypts content, based on the region information indicating a region, and provides the resulting encrypted information. Therefore, a playback apparatus in which pre-stored region information has been changed illegally, or in which the function of confirmation according to the region information is circumvented, is unable to decrypt the encrypted information correctly. As a result, playback can be restricted by region.

Here, the provision unit may provide the generated encrypted information by writing the generated encrypted information to a recording medium which is distributed, or by transmitting the generated encrypted information via a network.

According to the stated structure, the provision apparatus is able to provide the encrypted information reliably via a recording medium or via a network.

Here, the generation unit may include: a content storage sub-unit operable to store the content and a content key that corresponds to the content; a reading sub-unit operable to read the content and the content key from the content storage sub-unit; a region code storage sub-unit operable to store, as the region information, a region code that identifies a region; and an encryption sub-unit operable to encrypt the content key, based on the region code, to generate encrypted content key information, and encrypt the content with use of the content key, to generate encrypted content, thereby generating the encrypted information, which is composed of the encrypted content key information and the encrypted content, and the provision unit provides the encrypted information that is composed of the encrypted content key information and the encrypted content.

According to the stated structure, the provision apparatus encrypts the content key, based on region information indicating a region, to generate encrypted content key information, encrypts the content using the content key, to generate encrypted content, and provides the encrypted information that is composed of the encrypted content key information and the encrypted content. Therefore, a playback apparatus in which the pre-stored region code has been changed illegally, or in which the function of confirmation according to the region code is circumvented, is unable to decrypt the encrypted content key information correctly. In this way, such a playback apparatus is unable to obtain the content key and unable to playback the content correctly. As a result, playback can be restricted by region.

Here, the encryption sub-unit may obtain a media key set for one provision of the content, encrypt the obtained media key to generate an encrypted media key, and encrypt the content key with use of the region code and the media key, to generate an encrypted content key, thereby generating the encrypted content key information, which is composed of the encrypted media key and the encrypted content key, and the provision unit may provide the encrypted information that is composed of the encrypted content key information and the encrypted content, the encrypted content key information being composed of the encrypted media key and the encrypted content key.

According to the stated structure, the provision apparatus obtains a media key that is set for one provision of the content, encrypts the media key, to generate an encrypted media key, and encrypts the content key using the region code and the media key, to generate an encrypted content key. Accordingly, the provision apparatus provides the encrypted content key information that is composed of the encrypted media key and the encrypted content key. Therefore, a playback apparatus in which the pre-stored region code has been changed illegally, or in which the function of confirmation according to the region code is circumvented, is unable to decrypt the encrypted content key correctly. In this way, such a playback apparatus is unable to obtain the content key and is unable to play back the content correctly. As a result, playback can be restricted by region.

Here, the encryption sub-unit may generate an encryption key with use of the region code and the media key, and encrypt the content key with use of the generated encryption key.

According to the stated structure, the provision apparatus generates an encryption key using the region code and the media key, and encrypts the content key with use of the generated encryption key. Therefore, a playback apparatus in which the pre-stored region code has been changed illegally, or in which the function of confirmation according to the second region information is circumvented, is unable to generate a decryption key identical to the encryption key. In this way, such a playback apparatus is unable to decrypt the encrypt content key correctly, unable to obtain the content, and unable to play back the content correctly. As a result, playback can be restricted by region.

Here, the encryption sub-unit may generate the encryption key by concatenating the region code and the media key to generate concatenated data, and applying a one-way function to the concatenated data.

According to the stated structure, the provision apparatus generates an encryption key by concatenating the region code and the media key, and applying a one way function to the resulting concatenated data. Therefore, an encryption key is generated that depends on the values of both the region code and the media key. Consequently, a playback apparatus in which the pre-stored region code has been changed illegally, or in which the function of confirmation according to the region information is circumvented, is unable to generate a decryption key identical to the encryption key.

Here, the encryption sub-unit may obtain a device key that is unique to one playback apparatus, and encrypt the media key with use of the obtained device key.

According to the stated structure, the provision apparatus encrypts the media key using a device key that is unique to one playback apparatus. Therefore, only the playback apparatus that has the same device key as that used in encrypting is able to decrypt the encrypted media key to generate a media key.

Here, the encryption sub-unit may further obtain another device key that is unique to another playback apparatus, and encrypt the media key with use of the obtained other device key, to obtain another encrypted media key, and the provision unit may provide the encrypted information that further includes the other encrypted media key.

According to the stated structure, the provision apparatus further encrypts the media key using another device key that is unique to another playback apparatus. Therefore, only the playback apparatus having a device key the same as the device key, and another playback apparatus having another device key the same as the other device key are able to decrypt the encrypted media key to obtain a media key.

Here, the provision unit may provide the encrypted media key and the other encrypted media key arranged in a predetermined order.

According to the stated structure, the provision apparatus provides the encrypted media key and the other encrypted media key arranged in a predetermined order. Therefore, the playback apparatus is able to specify the encrypted media key that it is to use from among the encrypted media key and the other encrypted media key arranged in the predetermined order.

Here, the encryption unit may obtain the media key that includes a fixed character string, and encrypt the obtained media key, to generate the encrypted media key and the other encrypted media key.

According to the stated structure, the provision apparatus encrypts the media key, which includes a fixed character string, to generate the encrypted media key and the other encrypted media key. Therefore, when the playback apparatus is able to decrypt the unique character string, it is able to designate the encrypted media key that it is to use.

Here, the region code storage sub-unit may further store another region code that identifies another region, the encryption sub-unit may further encrypt the content key, based on the other region code, to generate other encrypted content key information, thereby generating the encrypted information, which is composed of the encrypted content key information, the other encrypted content key information and the encrypted content, and the provision unit may provide the encrypted information that is composed of the encrypted content key information, the other encrypted content key information and the encrypted content.

According to the stated structure, the provision apparatus further generates the encrypted information composed of encrypted content key information, other encrypted content key information and encrypted content, by further encrypting the content key based on the other region code, to generate other encrypted content key information. Therefore, different playback apparatuses having the region code and the other region code, respectively, are able to decrypt and playback the encrypted information.

Here, the encryption sub-unit may concatenate a fixed character string and the content key, encrypt the resulting concatenated data, based on the region code and the other region code, respectively, to generate encrypted content key information and other encrypted content key information.

According to the stated structure, the provision apparatus encrypts, based on the region code and the other region code, data resulting from concatenating a fixed character string and the content key, to generate the encrypted content key information and the other encrypted content key information. Therefore, when able to decrypt the unique character string, the playback apparatus can specify the encrypted key information that it is to use.

Here, the reading unit may read the content key that includes a fixed character string, and the encryption unit may encrypt the obtained content.

According to the stated structure, the provision apparatus encrypts the content key that includes a fixed character string. Therefore, when able to decrypt the encrypted content information and generate decrypted data that includes the fixed character string, the playback apparatus can specify the decrypted data as the content key that it is to use.

Here, the generation unit may include: a content storage sub-unit operable to store the content and a content key that corresponds to the content; a reading sub-unit operable to read the content and the content key that corresponds to the content; a region code storage sub-unit operable to store, as the region information, secret information corresponding to a region code that identifies the region; and an encryption sub-unit operable to encrypt the content key, based on the secret information, to generate encrypted content key information, and encrypt the content with use of the content key, to generate encrypted content, thereby generating the encrypted information, which is composed of the encrypted content key information and the encrypted content, and the provision unit may provide the encrypted information that is composed of the encrypted content key information and the encrypted content.

According to the stated structure, the provision apparatus encrypts the content key, based on secret information corresponding to a region code indicating a region, to generate encrypted content key information. Therefore, only a playback apparatus that knows the secret information is able to decrypt the encrypted content key information to generate the content key.

Here, the generation unit may include: a content storage sub-unit operable to store the content and a content key corresponding to the content; a reading sub-unit operable to read the content and the content key; a tree structure storage sub-unit that has a plurality of nodes that compose a tree structure system, each node corresponding to a different device key held by one or more playback apparatuses, and each leaf being in correspondence with a different playback apparatus and a region to which the playback apparatus belongs; a selection sub-unit operable to select, as the region information, from the tree structure system, a device key from among device keys that are held only by playback apparatuses that belong to the region and are not held by playback apparatuses that belong to other regions; and an encryption sub-unit operable to encrypt the content key, based on the selected device key, to generate encrypted content key information, encrypt the content with use of the content key, to generate encrypted content, thereby generating the encrypted information, which is composed of the encrypted content key information and the encrypted content, and the provision unit may provide the encrypted information that is composed of the encrypted content key information and the encrypted content.

According the to stated structure, the provision apparatus selects, as the region information, from the tree structure system, the device key that is on the highest level of the device keys that are held by only by playback apparatuses belonging to the region and not held by playback apparatuses belonging to other regions. The provision apparatus encrypts the content key, based on the selected device key, to generate encrypted content key information. Therefore, a playback apparatus in which pre-stored region information has been changed illegally, or in which the function of confirmation according to the region information is circumvented, is unable to decrypt the encrypted content key correctly. In this way, such a playback apparatus is unable to obtain the content key, and unable to play back the content correctly. As a result, playback can be restricted by region.

Here, the encryption sub-unit may obtain a media key set for one provision of the content, encrypt the obtained media key with use of the selected device key, to generate an encrypted media key, and encrypt the content key with use of the obtained media key, to generate an encrypted content key, thereby generating the encrypted content key information, which is composed of the encrypted media key and the encrypted content key, and the provision unit may provide the encrypted information that is composed of the encrypted content key information and the encrypted content, the encrypted content key information being composed of the encrypted media key and the encrypted content key.

According to the stated structure, the provision apparatus generates the encrypted key information composed of an encrypted media key and an encrypted content key, by encrypting the media key set for one provision of the content, using the selected device key, to generate the encrypted media key, and encrypting the content key, using the media key, to generate the encrypted content key. Therefore, a playback apparatus in which pre-stored region information has been changed illegally, or in which the function of confirmation according to the region information is circumvented, is unable to decrypt the encrypted media key correctly. In this way, such a playback apparatus is unable to decrypt the encrypted content key to obtain the content key, and unable to decrypt the content. As a result, playback can be restricted by region.

Here, the tree structure system may be composed of one tree structure, each node in the tree structure being in correspondence with a different device key held by one or more playback apparatuses, and each leaf in the tree structure being in correspondence with a different playback apparatus and a region to which the playback apparatus belongs, and the selection sub-unit may select the device key from the tree structure.

According to the stated structure, the provision apparatus has a tree structure system that is composed of one tree structure. Therefore the provision apparatus can manage the tree structure system easily.

Here, the tree structure system may include a plurality of tree structures that are equal in number to the regions to which the playback apparatuses belong and that correspond respectively to the regions, each tree structure having a plurality of nodes, each node being in correspondence with a different one of device keys held by one or more playback apparatuses in the corresponding region, and each leaf being in correspondence with a different one of the playback apparatuses that belong to the corresponding region, and the selection sub-unit may select a device key that is in correspondence with a root of the tree structure corresponding to the region.

According to the stated structure, the tree structure system held by the provision apparatus includes a same number of tree structures as regions. Therefore, the provision apparatus can manage the tree structures easily by region.

Here, the provision apparatus may provide, together with the encrypted information, a region code that identifies the region.

According to the stated structure, the provision apparatus further provides a region code. Therefore, the playback apparatus is able to compare the obtained region code with the region code of the playback apparatus.

Here, the generation unit may be constituted by a portable IC card.

According to the stated structure, the generation unit in the provision apparatus is composed of an IC card. Therefore, by inserting an IC card in the provision apparatus when using the provision apparatus and removing the IC card from the provision apparatus after use, the provision unit of the provision apparatus can be prevented from being used by parties who do not have an IC card.

Furthermore, the present invention is a playback apparatus that restricts playback of content according to geographic region, including: a storage unit operable to store, in advance, second region information that indicates a region; an obtaining unit operable to obtain encrypted information generated by encrypting content based on first region information that indicates a region; a decryption unit operable to attempt to decrypt the obtained encrypted information, based on the second region information, and, when the encrypted information is decrypted successfully, generate content as a result of decryption; and a playback unit operable to play back the generated content.

According to the stated structure, the playback apparatus obtains encrypted content generated by encrypting content based on first region information indicating a region, attempts to decrypt the obtained encrypted information based on stored second region information, and when the encrypted information is decrypted successfully, generates content as a result. Therefore, a playback apparatus in which the second region information has been changed, or in which the function of confirmation according to the region information is circumvented, is unable to decrypt the encrypted information correctly. In this way, such a playback apparatus is unable to play back the content correctly. As a result, playback can be restricted by region.

Here, the obtaining unit may obtain the encrypted information by reading the encrypted information from a recording medium, or by receiving the encrypted information via a network.

According to the stated structure, the playback apparatus is able to obtain the encrypted information reliably via a recording medium or via a network.

Here, the storage unit may store, in advance, as the second region information, a second region code that identifies a region, the obtaining unit may obtain the encrypted information that is composed of encrypted content key information and encrypted content, the encrypted content key information having been generated by encrypting a content key based on a first region code that identifies a region, the first region code having been used as the first region information, and the encrypted content having been generated by encrypting content with use of the content key, and the decryption unit may attempt to decrypt the encrypted content key information, based on a second region code that identifies the region, the second region code being used as the second region information, and, when the encrypted content key information is decrypted successfully, generate a content key as a result of decryption, and decrypt the content with use of the generated content key, to generate content.

According to the stated structure, the playback apparatus attempts to decrypt the encrypted content key information, based on the second region code, and when decryption is performed successfully, generates a content key. The playback apparatus then decrypts encrypted content using the generated content key, to generate content. Therefore, a playback apparatus in which the second region information has been changed illegally, or in which the function of confirmation according to the second region information is circumvented, is unable to decrypt the encrypted content key information correctly. In this way, such a playback apparatus is unable to obtained the content key, and unable to play back the content correctly. As a result, playback can be restricted by region.

Here, the obtaining unit may obtain the encrypted information composed of encrypted content key information and encrypted content, the encrypted content key information being composed of an encrypted media key and an encrypted content key, the encrypted media key having been generated by encrypting a media key that has been set for one provision of the content, and the encrypted content key having been generated by encrypting a content key with use of a first region code and the media key, and the decryption unit may decrypt the obtained encrypted media key, to generate a media key, attempt to decrypt the encrypted content key with use of the second region code and the generated media key, and when the encrypted content key is decrypted successfully, generate a content key as a result of decryption.

According to the stated structure, the playback apparatus obtains an encrypted content key that has been generated by encrypting the content key using the first region code and the media key, and attempts to decrypt the encrypted content key using the second region code and the media key. Therefore, a playback apparatus in which the second region information has been changed illegally, or in which the function of confirmation according to the second region information is circumvented, is unable to decrypt the encrypted content key correctly. In this way, such a playback apparatus is unable to obtain the content key, and unable to decrypt the content correctly. As a result, playback can be restricted by region.

Here, the decryption unit may generate a decryption key with use of the second region code and the media key, and use the generated decryption key to attempt to decrypt the encrypted content key.

According to the stated structure, the playback apparatus attempts to decrypt the encrypted content key using the decryption key generated with use of the second region code and the media key. Therefore, a playback apparatus in which the second region code has been changed illegally, or in which the function of confirmation according to the second region code is circumvented, is unable to decrypt the content correctly. In this way, such a playback apparatus is unable to obtain the content key, and unable to decrypt the content. As a result, playback can be restricted by region.

Here, the decryption unit may generate the decryption key by concatenating the second region code and the media key, and applying a one-way function to the resulting concatenated data.

According to the stated structure, the playback apparatus generates the decryption key by applying a one way function to data that results from concatenating the second region code and the media key. Therefore, a playback apparatus in which the second region code has been changed illegally, or in which the function of confirmation according to the region information is circumvented, is unable to generate the decryption key correctly. In this way, such a playback apparatus is unable to obtain the content key, and unable to decrypt the content. As a result, playback can be restricted by region.

Here, the obtaining unit may obtain the encrypted media key that has been generated by encrypting the media key with use of a device key that is unique to the playback apparatus, and the decryption unit may use the device key to attempt to decrypt the encrypted media key, and when the encrypted media key is decrypted successfully, generate a media key as a result of decryption.

According to the stated structure, the playback apparatus obtains the encrypted media key that has been generated by encrypting the media key with use of the device key unique to the playback apparatus, and attempts to decrypt the encrypted media key using the unique device key. Therefore, only the playback apparatus is able to decrypt the encrypted media key.

Here, the obtaining unit may further obtain another encrypted media key that has been generated by encrypting the media key with used of another device key that is unique to another playback apparatus, and the decryption unit may specify one of the encrypted media key and the other encrypted media key as the encrypted media key for use in the playback apparatus, and attempt to decrypt the specified encrypted media key.

According to the stated structure, the playback apparatus specifies the encrypted media key for use by the playback apparatus, from among the encrypted media key and the other encrypted media key which have been generated by encrypting the media key with the unique key of the playback apparatus and another unique key of another apparatus, respectively. Therefore, the playback apparatus generates a media key from the specified media key, generates a content key, and then generates content.

Here, the obtaining unit may obtain the encrypted media key and the other encrypted media key arranged in a predetermined order, and the decryption unit may specify the encrypted media key for use in the playback apparatus by extracting the one of the encrypted media key and the other encrypted media key that is in a specified position in the predetermined order.

According to the stated structure, the playback apparatus obtains the encrypted media key and the other encrypted media key that are arranged in the predetermined order, and is able to specify the encrypted media key for use by the playback apparatus reliably by extracting one encrypted media key that is in a particular position in the order.

Here, the obtaining unit may obtain the encrypted media key and the other encrypted media key that have been generated, respectively, by encrypting the media key that includes a fixed character string, and the decryption unit may attempt to decrypt the encrypted media key and the other encrypted media key, respectively, with use of the device key unique to the playback apparatus, and of the resulting pieces of decrypted data, recognize, as the media key, the piece of decrypted data that includes the fixed character string.

According to the stated structure, the playback apparatus obtains the encrypted media key and the other encrypted media key generated respectively by encrypting the media key that includes a fixed character string, and attempts to decrypt the encrypted media key and the other encrypted media key of the generated pieces of decrypted data, the playback apparatus treats that that includes the fixed character string as the media key. Therefore, the playback apparatus is able to specify the encrypted media key that is to be used by the playback apparatus.

Here, the obtaining unit may further obtain other encrypted content key information that has been generated by encrypting the content key based on another region code that identifies another region, and the decryption unit may further attempt to decrypt the other encrypted content key, based on the second region code, specify decrypted data that has been decrypted successfully from among decrypted data generated by decrypting the encrypted content key and decrypted data generated by decrypting the other encrypted content key, and recognize the specified decrypted data as the content key, thereby generating the content key.

According to the stated structure, the playback apparatus obtains the encrypted content key information and the other encrypted key content information that have been generated by encrypting the content key based on a second region code that identifies the region and another region code that identifies another region, respectively. The playback apparatus then decrypts the encrypted content key information and the other encrypted content key information based on the second region code, and, by designating the piece of content key information that has been decrypted successfully, designates the encrypted content key information for the playback apparatus from among the pieces of encrypted content key information.

Here, the obtaining unit may obtain the encrypted content key information and the other encrypted content key information that have been generated by encrypting, based on the second region code and another region code, respectively, concatenated data obtained by concatenating a fixed character string and the content key, and the decryption unit may delete the fixed character string from the one of the decrypted data generated by decrypting the encrypted content key information and the decrypted data generated by decrypting the other encrypted content key information that includes the fixed character string, thereby generating the content key.

According to the stated structure, the playback apparatus obtains the encrypted content key information and the other encrypted key information that have been generated by encrypting data resulting from concatenating a fixed character string and the content key, based on the second region code and the other region code, respectively. The playback apparatus generates the content key by deleting the fixed character string from the one of the decrypted data generated with the encrypted content key information and the decrypted data generated with the other encrypted content key information that includes the fixed character string. In this way, the playback apparatus can reliably specify the encrypted content key for the playback apparatus from among a plurality of pieces of encrypted content key information.

Here, the obtaining unit may obtain the encrypted content key information and the other encrypted content key information that have been generated by encrypting, based on the second region code and the region code, respectively, the content key that includes a fixed character string, and the decryption unit may recognize, as the content key, the one of decrypted data generated by decrypting the encrypted content key information and decrypted data generated by decrypting the other encrypted content key information that includes the fixed character string.

According to the stated structure, the playback apparatus obtains the encrypted content key information and the other encrypted content key information that have been generated by encrypting the content key that includes a fixed character string, based on the second region code and the other region code, respectively. Of the generated pieces of decrypted data generated by decrypting the encrypted content key information and the other encrypted content key information, the playback apparatus treats that that includes the fixed character string as the content key. In this way, the playback apparatus is able to specify reliably the encrypted content key information that is to be used by the playback apparatus, from among the pieces of encrypted content key information, and able to obtain the content key.

Here, the storage unit may store, in advance, as the second region information, second secret information that corresponds to a second region code that identifies a region, the obtaining unit may obtain the encrypted information that is composed of encrypted content key information and encrypted content, the encrypted content key information having been generated by encrypting a content key, based on first secret information, the first secret information being used as the first region information and corresponding to a first region code that identifies a region, and the encrypted content having been generated by encrypting content with use of the content key, and the decryption unit may attempt to decrypt the encrypted content key information based on the second secret information, and when the encrypted content key information is decrypted successfully, generate a content key as a result of decryption, and decrypt the encrypted content with use of the content key, to generate content.

According to the stated structure, the playback apparatus obtains the encrypted content key information that is a content key that has been encrypted based on first secret information used as first region information, that corresponds to a first region code that identifies a region. The playback apparatus attempts to decrypt the encrypted content key information, based on stored second secret information. Therefore, only a playback apparatus that knows the second secret information is able to decrypt the encrypted content key information and generate a content key.

Here, the storage unit may store, as the second region information, a plurality of device keys that are in correspondence with nodes on a path from one leaf to a root in a tree structure system, the leaf being in correspondence with the playback apparatus, the obtaining unit may obtain the encrypted information that is composed of encrypted content key information and encrypted content, the encrypted content key information having been generated by encrypting a content key based on a device key that is in correspondence with one node in the tree structure system, and the encrypted content having been generated by encrypting content with use of the content key, and the decryption unit may attempt to decrypt, based on the stored device keys, respectively, the encrypted content key information, and when the encrypted content is decrypted successfully, generate content as a result of decryption, and decrypt the encrypted content with use of the generated content key, to generate content.

According to the stated structure, the playback apparatus attempts to decrypt the encrypted content key information, based on each of the plurality of device keys, respectively, as the second region information. Therefore, a playback apparatus in which the second region information has been changed illegally, or in which the function of confirmation according to the second region information is circumvented, is unable to decrypt the encrypted content key information correctly. Therefore, such a playback apparatus is unable to obtain the content key, and unable to decrypt the content. As a result, playback can be restricted by region.

Here, the obtaining unit may obtain the encrypted information that is composed of the encrypted content key information and the encrypted content, the encrypted content key information being composed of an encrypted media key and an encrypted content key, the encrypted media key having been generated by encrypting, with use of the device key, a media key that has been set for one provision of content, and the encrypted content key having been generated by encrypting the content key with use of the media key, and the decryption unit may attempt to decrypt, based on the device keys, respectively, the encrypted media key, and, when the encrypted media key is decrypted successfully, generate a media key as a result of decryption, and decrypt the encrypted content key with use of the generated media key, to generate a content key.

According to the stated structure, the playback apparatus obtains the encrypted media key that has been generated by encrypting, with use of a device key as second region information, a media key set for one provision of content. The playback apparatus attempts to decrypt the encrypted media key based on a plurality of stored device keys, respectively. Therefore, a playback apparatus in which the second region information has been changed illegally, or in which the function of confirmation according to the second region information is circumvented, is unable to decrypt the encrypted content key information correctly. In this way, sucha playback apparatus is unable to obtain a media key, unable to obtain a content key, and therefore unable to obtain content. As a result, playback can be restricted by region.

Here, the tree structure system may be composed of one tree structure, each node in the tree structure being in correspondence with a different device key held by one or more playback apparatuses, and each leaf in the tree structure being in correspondence with a different playback apparatus and a region to which the playback apparatus belongs, the device keys stored by the storage unit may be in correspondence with nodes on a path from one leaf to a root in the tree structure, the leaf being in correspondence with the playback apparatus, and the obtaining unit may obtain the encrypted content key information that has been generated by encrypting a content key, based on a device key that is in correspondence with one node in the tree structure.

According to the stated structure, the playback apparatus uses a device key that is in correspondence with one node in the tree structure system, which is composed of one tree structure. Therefore, a management apparatus that manages the tree structure system is able to do so easily.

Here, the tree structure system may include a plurality of tree structures that are equal in number to the regions to which the playback apparatuses belong and that correspond respectively to the regions, each tree structure having a plurality of nodes, each node being in correspondence with a different one of device keys held by one or more playback apparatuses in the corresponding region, and each leaf being in correspondence with a different one of playback apparatuses that belong to the corresponding region, the device keys stored by the storage unit may be in correspondence with nodes on a path from one leaf to a root in a tree structure that corresponds to a region to which the playback apparatus belongs, the leaf being in correspondence with the playback apparatus, and the obtaining unit may obtain the encrypted content key information that has been generated by encrypting a content key, based on a device key that is in correspondence with one node in the tree structure.

According to the stated structure, the playback apparatus uses a device key that is in correspondence with one node in the tree structure that corresponds to the region, from the tree structure system that includes the same number of tree structure as regions. Therefore, a management apparatus that manages the tree structure system is able to manage the tree structure for each region easily.

Here, the storage unit may store, in advance, as the second region information, a second region code that identifies the region, the obtaining unit may further obtain, together with the encrypted information, a third region code that identifies the region, and the decryption unit, before decrypting the encrypted information, may compare the second region code and the third region code, and abort decryption of the encrypted information when the second and third region codes do not match, and attempt decryption of the encrypted information when the second and third region codes match.

According to the stated structure, before decrypting encrypted information, the playback apparatus compares the second region code with an obtained third region code, and when the region codes do not match, aborts decryption of the encrypted information. Therefore, playback can easily be restricted by region, and unnecessary decryption of the encrypted information is avoided when the two region codes do not match.

Here, the decryption unit may be constituted by a portable IC card.

According to the stated structure, the decryption unit of the playback apparatus is a portable IC card. Therefore, by inserting the IC card in the playback apparatus when using the playback apparatus, and removing the IC card from the playback apparatus after use, the decryption unit of the playback apparatus can be prevented from being used by a parties that do not have an IC card.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

### Industrial Applicability

The described digital work protection system and content distribution system can be used for business purposes, in other words, repeatedly and continuously, in an industry in which a content provider provides digital works such as music, movies and novels, to a user.

The present invention is particularly suitable for an industry that provides digitized works by distributing such works in the market stored on a recording media such as DVDs, or by distributing such works over a network.

What is claimed is:

1. A region restrictive playback system in which playback of content is restricted according to geographic region, comprising:
a provision apparatus that encrypts content, based on first region information that indicates a region, to generate encrypted information, and provides the generated encrypted information; and
a playback apparatus that stores, in advance, second region information that indicates a region, obtains the encrypted information, attempts to decrypt the obtained encrypted information, based on the second region information, and, when the encrypted information is decrypted successfully, generates content as a result of decryption, and plays back the generated content.

2. A provision apparatus that provides content, playback of the content being restricted according to region, the provision apparatus comprising:
a generation unit operable to encrypt content, based on region information that indicates a region, to generate encrypted information; and
a provision unit operable to provide the generated encrypted information.

3. The provision apparatus of claim 2, wherein
the provision unit provides the generated encrypted information by writing the generated encrypted information to a recording medium which is distributed, or by transmitting the generated encrypted information via a network.

4. The provision apparatus of claim 3, wherein the generation unit includes:
a content storage sub-unit operable to store the content and a content key that corresponds to the content;
a reading sub-unit operable to read the content and the content key from the content storage sub-unit;
a region code storage sub-unit operable to store, as the region information, a region code that identifies a region; and
an encryption sub-unit operable to encrypt the content key, based on the region code, to generate encrypted content key information, and encrypt the content with use of the content key, to generate encrypted content, thereby generating the encrypted information, which is composed of the encrypted content key information and the encrypted content, and
the provision unit provides the encrypted information that is composed of the encrypted content key information and the encrypted content.

5. The provision apparatus of claim 4, wherein the generation unit further includes:
an obtaining sub-unit operable to obtain the content and the content key from a source external to the provision apparatus, and write the obtained content and the obtained content key to the content storage sub-unit.

6. The provision apparatus of claim 4, wherein the generation unit further includes:
a content generation sub-unit operable to generate the content and the content key, and write the generated content and the generated content key to the content storage sub-unit.

7. The provision apparatus of claim 4, wherein
the encryption sub-unit obtains a media key set for one provision of the content, encrypts the obtained media key to generate an encrypted media key, and encrypts the content key with use of the region code and the media key, to generate an encrypted content key, thereby generating the encrypted content key information, which is composed of the encrypted media key and the encrypted content key, and
the provision unit provides the encrypted information that is composed of the encrypted content key information and the encrypted content, the encrypted content key information being composed of the encrypted media key and the encrypted content key.

8. The provision apparatus of claim 7, wherein
the encryption sub-unit generates an encryption key with use of the region code and the media key, and encrypts the content key with use of the generated encryption key.

9. The provision apparatus of claim 8, wherein
the encryption sub-unit generates the encryption key by concatenating the region code and the media key to generate concatenated data, and applying a one-way function to the concatenated data.

10. The provision apparatus of claim 7, wherein
the encryption sub-unit obtains a device key that is unique to one playback apparatus, and encrypts the media key with use of the obtained device key.

11. The provision apparatus of claim 10, wherein
the encryption sub-unit further obtains another device key that is unique to another playback apparatus, and encrypts the media key with use of the obtained other device key, to obtain another encrypted media key, and
the provision unit provides the encrypted information that further includes the other encrypted media key.

12. The provision apparatus of claim 11, wherein
the provision unit provides the encrypted media key and the other encrypted media key arranged in a predetermined order.

13. The provision apparatus of claim 11, wherein
the encryption unit obtains the media key that includes a fixed character string, and encrypts the obtained media key, to generate the encrypted media key and the other encrypted media key.

14. The provision apparatus of claim 4, wherein
the region code storage sub-unit further stores another region code that identifies another region,
the encryption sub-unit further encrypts the content key, based on the other region code, to generate other encrypted content key information, thereby generating the encrypted information, which is composed of the encrypted content key information, the other encrypted content key information and the encrypted content, and
the provision unit provides the encrypted information that is composed of the encrypted content key information, the other encrypted content key information and the encrypted content.

15. The provision apparatus of claim 14, wherein
the encryption sub-unit concatenates a fixed character string and the content key, encrypts the resulting concatenated data, based on the region code and the other region code, respectively, to generate encrypted content key information and other encrypted content key information.

16. The provision apparatus of claim 14, wherein
the reading unit reads the content key that includes a fixed character string, and
the encryption unit encrypts the obtained content.

17. The provision apparatus of claim 3, wherein
the generation unit includes:
a content storage sub-unit operable to store the content and a content key that corresponds to the content;
a reading sub-unit operable to read the content and the content key that corresponds to the content;
a region code storage sub-unit operable to store, as the region information, secret information corresponding to a region code that identifies the region; and
an encryption sub-unit operable to encrypt the content key, based on the secret information, to generate encrypted content key information, and encrypt the content with use of the content key, to generate encrypted content, thereby generating the encrypted information, which is composed of the encrypted content key information and the encrypted content, and
the provision unit provides the encrypted information that is composed of the encrypted content key information and the encrypted content.

18. The provision apparatus of claim 17, wherein the generation unit further includes:
an obtaining sub-unit operable to obtain the content and the content key from a source external to the provision apparatus, and write the obtained content and the obtained content key to the content storage sub-unit.

19. The provision apparatus of claim 17, wherein the generation unit further includes:
a content generation sub-unit operable to generate the content and the content key, and write the generated content and the generated content key to the content storage sub-unit.

20. The provision apparatus of claim 3, wherein
the generation unit includes:
a content storage sub-unit operable to store the content and a content key corresponding to the content;
a reading sub-unit operable to read the content and the content key;
a tree structure storage sub-unit that has a plurality of nodes that compose a tree structure system, each node corresponding to a different device key held by one or more playback apparatuses, and each leaf being in correspondence with a different playback apparatus and a region to which the playback apparatus belongs;
a selection sub-unit operable to select, as the region information, from the tree structure system, a device key from among device keys that are held only by playback apparatuses that belong to the region and are not held by playback apparatuses that belong to other regions; and
an encryption sub-unit operable to encrypt the content key, based on the selected device key, to generate encrypted content key information, encrypt the content with use of the content key, to generate encrypted content, thereby generating the encrypted information, which is composed of the encrypted content key information and the encrypted content, and
the provision unit provides the encrypted information that is composed of the encrypted content key information and the encrypted content.

21. The provision apparatus of claim 20, wherein the generation unit further includes:
an obtaining sub-unit operable to obtain the content and the content key from a source external to the provision apparatus, and write the obtained content and the obtained content key to the content storage sub-unit.

22. The provision apparatus of claim 20, wherein the generation unit further includes:
a content generation sub-unit operable to generate the content and the content key, and write the generated content and the generated content key to the content storage sub-unit.

23. The provision apparatus of claim 20, wherein
the encryption sub-unit obtains a media key set for one provision of the content, encrypts the obtained media key with use of the selected device key, to generate an encrypted media key, and encrypts the content key with use of the obtained media key, to generate an encrypted content key, thereby generating the encrypted content key information, which is composed of the encrypted media key and the encrypted content key, and
the provision unit provides the encrypted information that is composed of the encrypted content key information and the encrypted content, the encrypted content key information being composed of the encrypted media key and the encrypted content key.

24. The provision apparatus of claim 23, wherein
the tree structure system is composed of one tree structure, each node in the tree structure being in correspondence with a different device key held by one or more playback apparatuses, and each leaf in the tree structure being in correspondence with a different playback apparatus and a region to which the playback apparatus belongs, and
the selection sub-unit selects the device key from the tree structure.

25. The provision apparatus of claim 23, wherein
the tree structure system includes a plurality of tree structures that are equal in number to the regions to which the playback apparatuses belong and that correspond respectively to the regions, each tree structure having a plurality of nodes, each node being in correspondence with a different one of device keys held by one or more playback apparatuses in the corresponding region, and each leaf being in correspondence with a different one of the playback apparatuses that belong to the corresponding region, and
the selection sub-unit selects a device key that is in correspondence with a root of the tree structure corresponding to the region.

26. The provision apparatus of claim 3, wherein
the provision apparatus provides, together with the encrypted information, a region code that identifies the region.

27. The provision apparatus of claim 3, wherein
the generation unit is constituted by a portable IC card.

28. A playback apparatus that restricts playback of content according to geographic region, comprising:
a storage unit operable to store, in advance, second region information that indicates a region;
an obtaining unit operable to obtain encrypted information generated by encrypting content based on first region information that indicates a region;
a decryption unit operable to attempt to decrypt the obtained encrypted information, based on the second region information, and, when the encrypted information is decrypted successfully, generate content as a result of decryption; and
a playback unit operable to play back the generated content.

29. The playback apparatus of claim 28, wherein
the obtaining unit obtains the encrypted information by reading the encrypted information from a recording medium, or by receiving the encrypted information via a network.

30. The playback apparatus of claim 29, wherein
the storage unit stores, in advance, as the second region information, a second region code that identifies a region,
the obtaining unit obtains the encrypted information that is composed of encrypted content key information and encrypted content, the encrypted content key information having been generated by encrypting a content key based on a first region code that identifies a region, the first region code having been used as the first region information, and the encrypted content having been generated by encrypting content with use of the content key, and
the decryption unit attempts to decrypt the encrypted content key information, based on a second region code that identifies the region, the second region code being used as the second region information, and, when the encrypted content key information is decrypted successfully, generates a content key as a result of decryption, and decrypts the content with use of the generated content key, to generate content.

31. The playback apparatus of claim 30, wherein
the obtaining unit obtains the encrypted information composed of encrypted content key information and encrypted content, the encrypted content key information being composed of an encrypted media key and an encrypted content key, the encrypted media key having been generated by encrypting a media key that has been set for one provision of the content, and the encrypted content key having been generated by encrypting a content key with use of a first region code and the media key, and
the decryption unit decrypts the obtained encrypted media key, to generate a media key, attempts to decrypt the encrypted content key with use of the second region code and the generated media key, and when the encrypted content key is decrypted successfully, generates a content key as a result of decryption.

32. The playback apparatus of claim 31, wherein
the decryption unit generates a decryption key with use of the second region code and the media key, and uses the generated decryption key to attempt to decrypt the encrypted content key.

33. The playback apparatus of claim 32, wherein
the decryption unit generates the decryption key by concatenating the second region code and the media key, and applying a one-way function to the resulting concatenated data.

34. The playback apparatus of claim 31, wherein
the obtaining unit obtains the encrypted media key that has been generated by encrypting the media key with use of a device key that is unique to the playback apparatus, and
the decryption unit uses the device key to attempt to decrypt the encrypted media key, and when the encrypted media key is decrypted successfully, generates a media key as a result of decryption.

35. The playback apparatus of claim 34, wherein
the obtaining unit further obtains another encrypted media key that has been generated by encrypting the media key with used of another device key that is unique to another playback apparatus, and
the decryption unit specifies one of the encrypted media key and the other encrypted media key as the encrypted media key for use in the playback apparatus, and attempts to decrypt the specified encrypted media key.

36. The playback apparatus of claim 35, wherein
the obtaining unit obtains the encrypted media key and the other encrypted media key arranged in a predetermined order, and
the decryption unit specifies the encrypted media key for use in the playback apparatus by extracting the one of the encrypted media key and the other encrypted media key that is in a specified position in the predetermined order.

37. The playback apparatus of claim 35, wherein
the obtaining unit obtains the encrypted media key and the other encrypted media key that have been generated, respectively, by encrypting the media key that includes a fixed character string, and
the decryption unit attempts to decrypt the encrypted media key and the other encrypted media key, respectively, with use of the device key unique to the playback apparatus, and of the resulting pieces of decrypted data, recognizes, as the media key, the piece of decrypted data that includes the fixed character string.

38. The playback apparatus of claim 30, wherein
the obtaining unit further obtains other encrypted content key information that has been generated by encrypting the content key based on another region code that identifies another region, and
the decryption unit further attempts to decrypt the other encrypted content key, based on the second region code, specifies decrypted data that has been decrypted successfully from among decrypted data generated by decrypting the encrypted content key and decrypted data generated by decrypting the other encrypted content key, and recognizes the specified decrypted data as the content key, thereby generating the content key.

39. The playback apparatus of claim 38, wherein
the obtaining unit obtains the encrypted content key information and the other encrypted content key information that have been generated by encrypting, based on the second region code and another region code, respectively, concatenated data obtained by concatenating a fixed character string and the content key, and
the decryption unit deletes the fixed character string from the one of the decrypted data generated by decrypting the encrypted content key information and the decrypted data generated by decrypting the other encrypted content key information that includes the fixed character string, thereby generating the content key.

40. The playback apparatus of claim 38, wherein
the obtaining unit obtains the encrypted content key information and the other encrypted content key information that have been generated by encrypting, based on the second region code and the region code, respectively, the content key that includes a fixed character string, and
the decryption unit recognizes, as the content key, the one of decrypted data generated by decrypting the encrypted content key information and decrypted data generated by decrypting the other encrypted content key information that includes the fixed character string.

41. The playback apparatus of claim 29, wherein
the storage unit stores, in advance, as the second region information, second secret information that corresponds to a second region code that identifies a region,
the obtaining unit obtains the encrypted information that is composed of encrypted content key information and encrypted content, the encrypted content key information having been generated by encrypting a content key, based on first secret information, the first secret information being used as the first region information and corresponding to a first region code that identifies a region, and the encrypted content having been generated by encrypting content with use of the content key, and
the decryption unit attempts to decrypt the encrypted content key information based on the second secret information, and when the encrypted content key information is decrypted successfully, generates a content key as a result of decryption, and decrypts the encrypted content with use of the content key, to generate content.

42. The playback apparatus of claim 29, wherein
the storage unit stores, as the second region information, a plurality of device keys that are in correspondence with nodes on a path from one leaf to a root in a tree structure system, the leaf being in correspondence with the playback apparatus,
the obtaining unit obtains the encrypted information that is composed of encrypted content key information and encrypted content, the encrypted content key information having been generated by encrypting a content key based on a device key that is in correspondence with one node in the tree structure system, and the encrypted content having been generated by encrypting content with use of the content key, and
the decryption unit attempts to decrypt, based on the stored device keys, respectively, the encrypted content key information, and when the encrypted content is decrypted successfully, generates content as a result of decryption, and decrypts the encrypted content with use of the generated content key, to generate content.

43. The playback apparatus of claim 42, wherein
the obtaining unit obtains the encrypted information that is composed of the encrypted content key information and the encrypted content, the encrypted content key information being composed of an encrypted media key and an encrypted content key, the encrypted media key having been generated by encrypting, with use of the device key, a media key that has been set for one provision of content, and the encrypted content key having been generated by encrypting the content key with use of the media key, and
the decryption unit attempts to decrypt, based on the device keys, respectively, the encrypted media key, and, when the encrypted media key is decrypted successfully, generates a media key as a result of decryption, and decrypts the encrypted content key with use of the generated media key, to generate a content key.

44. The playback apparatus of claim 43, wherein
the tree structure system is composed of one tree structure, each node in the tree structure being in correspondence with a different device key held by one or more playback apparatuses, and each leaf in the tree structure being in correspondence with a different playback apparatus and a region to which the playback apparatus belongs,
the device keys stored by the storage unit are in correspondence with nodes on a path from one leaf to a root in the tree structure, the leaf being in correspondence with the playback apparatus, and
the obtaining unit obtains the encrypted content key information that has been generated by encrypting a content key, based on a device key that is in correspondence with one node in the tree structure.

45. The playback apparatus of claim 43, wherein
the tree structure system includes a plurality of tree structures that are equal in number to the regions to which the playback apparatuses belong and that correspond respectively to the regions, each tree structure having a plurality of nodes, each node being in correspondence with a different one of device keys held by one or more playback apparatuses in the corresponding region, and each leaf being in correspondence with a different one of playback apparatuses that belong to the corresponding region,
the device keys stored by the storage unit are in correspondence with nodes on a path from one leaf to a root in a tree structure that corresponds to a region to which the playback apparatus belongs, the leaf being in correspondence with the playback apparatus, and
the obtaining unit obtains the encrypted content key information that has been generated by encrypting a content key, based on a device key that is in correspondence with one node in the tree structure.

46. The playback apparatus of claim 29, wherein
the storage unit stores, in advance, as the second region information, a second region code that identifies the region,
the obtaining unit further obtains, together with the encrypted information, a third region code that identifies the region, and
the decryption unit, before decrypting the encrypted information, compares the second region code and the third region code, and aborts decryption of the encrypted information when the second and third region codes do not match, and attempts decryption of the encrypted information when the second and third region codes match.

47. The playback apparatus of claim 29, wherein
the decryption unit is constituted by a portable IC card.

48. A computer-readable recording medium that stores encrypted information that has been generated by encrypting content, based on region information indicating a geographical region.

49. The recording medium of claim 48, wherein
the encrypted information is composed of encrypted content key information and encrypted content, the encrypted content key information having been generated by encrypting a content key, based on a region code, the region code identifying a region and being used as the region information, and the encrypted content having been generated by encrypting the content with use of the content key.

50. The recording medium of claim 48, wherein
the encrypted information is composed of encrypted content key information and encrypted content, the encrypted content key information having been generated by encrypting a content key, based on a device key, the device key being used as the region information, and the encrypted content having been generated by encrypting the content with use of the content key,
the device key selected as the region information is selected from among device keys that are held only by playback apparatuses that belong to a region and not held by playback apparatuses that belong to another region, and
the tree structure system includes a plurality of tree structures that are equal in number to the regions and that correspond respectively to the regions, each tree structure having a plurality of nodes, each node being in correspondence with a different one of device keys held by one or more playback apparatuses in the corresponding region, and each leaf being in correspondence with a different one of the playback apparatuses that belong to the corresponding region.

51. A provision method used in a provision apparatus for providing content whose playback is restricted according to geographical region, comprising:
a generation of encrypting content, based on region information that indicates a region, to generate encrypted information; and
a provision step of providing the generated encrypted information.

52. A provision program used in a provision apparatus for providing content, playback of the content being restricted according to geographical region, comprising:
a generation of encrypting content, based on region information that indicates a region, to generate encrypted information; and
a provision step of providing the generated encrypted information.

53. The provision program of claim 52, recorded on a computer-readable recording medium.

54. A playback method used in a playback apparatus that restricts playback of content according to geographical region, wherein the playback apparatus includes a storage unit operable to store, in advance, second region information that indicates a region, the playback method comprising:
an obtaining step of obtaining encrypted information generated by encrypting content based on first region information that indicates a region;
a decryption step of attempting to decrypt the obtained encrypted information, based on the second region information, and, when the encrypted information is decrypted successfully, generate content as a result of decryption; and
a playback step of playing back the generated content.

55. A playback program used in a playback apparatus-that restricts playback of content according to geographical region, wherein the playback apparatus includes a storage unit operable to store, in advance, second region information that indicates a region, the playback program comprising:
an obtaining step of obtaining encrypted information generated by encrypting content based on first region information that indicates a region;
a decryption step of attempting to decrypt the obtained encrypted information, based on the second region information, and, when the encrypted information is decrypted successfully, generate content as a result of decryption; and
a playback step of playing back the generated content.

56. The playback program of claim 55, recorded on a computer-readable recording medium.
